(19) United States
(12) Patent Application Publication
(10) Pub. No.: US 2015/0294581 A1
(43) Pub. Date: Oct. 15, 2015

(54) NEUROPERFORMANCE

(71) Applicant: ASPEN PERFORMANCE TECHNOLOGIES, Tel Aviv (IL)

(72) Inventors: Jose Roberto KULLOK, Efrat (IL); Saul KULLOK, Efrat (IL)

(21) Appl. No.: 14/468,975

(22) Filed: Aug. 26, 2014

Related U.S. Application Data
(63) Continuation-in-part of application No. 14/251,116, filed on Apr. 11, 2014.
Application No. 14/251,116 is a continuation-in-part of application No. 14/251,163, filed on Apr. 11, 2014.
Application No. 14/251,163 is a continuation-in-part of application No. 14/251,007, filed on Apr. 11, 2014.
Application No. 14/251,007 is a continuation-in-part of application No. 14/251,034, filed on Apr. 11, 2014.
Application No. 14/251,034 is a continuation-in-part of application No. 14/251,041, filed on Apr. 11, 2014.

(51) Int. Cl. G09B 7/02

(52) U.S. Cl. CPC G09B 7/02

(57) ABSTRACT

Methods of promoting fluid intelligence abilities in a subject including the steps of: selecting a complete serial order of different open-bigram terms with the same spatial and time perceptual related attributes, providing the subject, from the selected complete serial order, with a randomized open-bigrams sequence having a plurality of repeated open-bigram terms, a plurality of open-bigram terms out of serial order, and a plurality of missing open-bigram terms; prompting the subject to serially sensorially discriminate and sensory motor remove the repeated open-bigram terms; prompting the subject to sensory motor reorganize the out of serial order open-bigram terms; prompting the subject to sensory motor insert the missing open-bigram terms; and displaying the correctly sensory motor inserted open-bigram terms with at least one different spatial or time perceptual related attribute to highlight the correct open-bigram terms answer.

This is a Continuation-In-Part of U.S. patent application Ser. No. 14/251,116, U.S. patent application Ser. No. 14/251,163, U.S. patent application Ser. No. 14/251,007, U.S. patent application Ser. No. 14/251,034, and U.S. patent application Ser. No. 14/251,041, all filed on Apr. 11, 2014, the disclosure of each which is hereby incorporated by reference.

### FIELD

The present disclosure relates to a system, method, software, and tools employing a novel disruptive non-pharmacological technology that prompts correlation of a subject's sensory-motor-perceptual-cognitive activities with novel constrained sequential statistical and combinatorial properties of alphanumerical series of symbols (e.g., in alphabetical series, letter sequences and series of numbers). These statistical and combinatorial properties determine alphanumeric sequential relationships by establishing novel interrelations, correlations and cross-correlations among the sequence terms. The new interrelations, correlations and cross-correlations among the sequence terms prompted by this novel non-pharmacological technology sustain and promote neural plasticity in general and neural-linguistic plasticity in particular. This technology is carried out through new strategies implemented by exercises particularly designed to amplify these novel sequential alphanumeric interrelations, correlations and cross-correlations. More importantly, this non-pharmacological technology entwines and grounds sensory-motor-perceptual-cognitive activity to statistical and combinatorial information constraining serial orders of alphanumeric symbols sequences. As a result, the problem solving of the disclosed body of alphanumeric series exercises is hardly cognitively taxing and is mainly conducted via fluid intelligence abilities (e.g., inductive-deductive reasoning, novel problem solving, and spatial orienting).

A primary goal of the non-pharmacological technology disclosed herein is maintaining stable cognitive abilities, delaying, and/or preventing cognitive decline in a subject experiencing normal aging. Likewise, this goal includes restraining working and episodic memory and cognitive impairments in a subject experiencing mild cognitive decline associated, e.g., with mild cognitive impairment (MCI) or pre-dementia and delaying the progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology is beneficial as a training cognitive intervention designated to improve the instrumental performance of an elderly person in daily demanding functioning tasks by enabling some transfer from fluid cognitive trained abilities to everyday functioning. Further, this non-pharmacological technology is also beneficial as a brain fitness training/cognitive learning enhancer tool for the normal aging population, a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential, combinatorial and statistical properties of the serial orders of its symbols (e.g., in the letters series of a language alphabet and in a series of numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-linguistic plasticity, thus preventing or decelerating the chemical break-down initiation of the biological neural machine as it grows old.

The present non-pharmacological technology accomplishes this by principally focusing on the root base component of language, its alphabet, organizing its constituent parts, namely its letters and letter sequences (chunks) in novel ways to create rich and increasingly new complex non-semantic (serial non-word chunks) networking. This technology explicitly reveals the most basic minimal semantic textual structures in a given language (e.g., English) and creates a novel alphanumeric platform by which these minimal semantic textual structures can be exercised within the given language alphabet. The present non-pharmacological technology also accomplishes this by focusing on the natural numbers numerical series, organizing its constituent parts, namely its single number digits and number sets (numerical chunks) in novel serial ways to create rich and increasingly new number serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition). Furthermore, the present non-pharmacological technology also derives its effectiveness by promoting efficient processing speed of phonological and visual pattern information among alphabetical serial structures (e.g., letters and letter patterns and their statistical and combinatorial properties, including non-word letter patterns), thereby promoting neuronal plasticity in general across several distant brain regions and hemispheric related language neural plasticity in particular.

The advantage of the non-pharmacological cognitive intervention technology disclosed herein is that it is effective, safe, and user-friendly, demands low arousal thus low attentional effort, is non-invasive, has no side effects, is non-addictive, scalable, and addresses large target markets where currently either no solution is available or where the solutions are partial at best.

### BRIEF DESCRIPTION OF DRAWINGS

FIG. 1 is a flow chart setting forth the method that the present exercises use in promoting fluid intelligence abilities in a subject through reasoning strategies directed towards problem solving by the serial sensorial discrimination, sensory motor selection, and gradual reorganization of different open-bigram terms into a completed non-randomized open-bigrams sequence that comprises a complete direct or inverse alphabetical serial order of different open-bigram terms.

FIGS. 2A-2C depict a number of non-limiting examples of the exercises for serial sensorial discrimination, sensory motor selection, and gradual reorganization of different open-bigram terms from a randomized serial order of different open-bigram terms into a completed non-randomized serial order of different open-bigram terms. FIG. 2A shows a randomized serial order of different open-bigram terms and prompts the subject to serially sensorially discriminate, sensory motor select, and reorganize the randomized open-bigrams sequence. FIG. 2B shows the correct serially sensorially discriminated, sensory motor selected, and reorganized different open-bigram terms AB and IJ. FIG. 2C shows the correct serial sensorial discriminations, sensory motor selections, and reorganization of different open-bigram terms CD and EF in the randomized open-bigram sequence by sensory motor swapping the ordinal positions of the different open-bigram terms.

FIG. 3A-3C comprise a flow chart setting forth the method that the present exercises use in promoting fluid intelligence abilities in a subject through reasoning strategies directed towards problem solving by the serial sensorial discrimination, sensory motor selection, removal, ordinal reorganization, and insertion of open-bigram terms to attain a complete non-randomized serial order of different open-bigram terms.

FIGS. 4A-4F depict a non-limiting example of the exercises in Example 2 for serial sensorial discrimination, sensory motor selection, removal, reorganization, and insertion of open-bigram terms. FIG. 4A presents a randomized open-bigrams sequence with repeated open-bigram terms, open-bigram terms occupying wrong ordinal positions in relation to their respective ordinal positions in a complete direct alphabetical open-bigram set array or a complete inverse alphabetical open-bigram set array, and missing open-bigram terms. The subject is prompted to serially sensorially discriminate all of the repeated open-bigram terms from the randomized open-bigrams sequence in order to sensory motor remove them and reorganize them in a direct alphabetical order in the given box. FIG. 4B shows the results of the subject successfully completing this first step.

FIG. 4C shows the remaining different open-bigram terms in the randomized open-bigrams sequence and prompts the subject to serially sensorially discriminate, sensory motor select, and organize them into an incomplete direct alphabetical open-bigrams sequence in the given box in the second step. FIG. 4D shows the remaining different open-bigram terms in their correct direct alphabetical order in the box. In FIG. 4E, the subject is prompted to complete the direct alphabetical open-bigrams sequence by sensory motor inserting the missing different open-bigram terms provided in the box in the third step. The final result is shown in FIG. 4F, where the correct sensory motor inserted missing different open-bigram terms are shown with changed spatial and time perceptual related attributes.

### DETAILED DESCRIPTION

### Introduction

It is generally assumed that individual letters and the mechanism responsible for coding the positions of these letters in a string are the key elements for orthographic processing and determining the nature of the orthographic code. To expand the understanding of the mechanisms that interact, inhibit and modulate orthographic processing, there should also be an acknowledgement of the ubiquitous influence of phonology in reading comprehension. There is a growing consensus that reading involves multiple processing routes, namely the lexical and sub-lexical routes. In the lexical route, a string directly accesses lexical representations. When a visual image first arrives at a subject's cortex, it is in the form of a retinotopic encoding. If the visual stimulus is a letter string, an encoding of the constituent letter identities and positions takes place to provide a suitable representation for lexical access. In the sub-lexical route, a string is transformed into a phonological representation, which then contacts lexical representations.

Indeed, there is growing consensus that orthographic processing must connect with phonological processing quite early on during the process of visual word recognition, and that phonological representations constrain orthographic processing (Frost, R. (1998) Toward a strong phonological theory of visual word recognition: True issues and false trails, Psychological Bulletin, 123, 71_{—}99; Van Orden, G. C. (1987) A ROWS is a ROSE: Spelling, sound, and reading, Memory and Cognition, 15(3), 181-1987; and Ziegler, J. C., & Jacobs, A. M. (1995), Phonological information provides early sources of constraint in the processing of letter strings, Journal of Memory and Language, 34, 567-593).

Another major step forward in orthographic processing research concerning visual word recognition has taken into consideration the anatomical constraints of the brain to its function. Hunter and Brysbaert describe this anatomical constraint in terms of interhemispheric transfer cost (Hunter, Z. R., & Brysbaert, M. (2008), Theoretical analysis of interhemispheric transfer costs in visual word recognition, Language and Cognitive Processes, 23, 165-182). The assumption is that information falling to the right and left of fixation, even within the fovea, is sent to area V1 in the contralateral hemisphere. This implies that information to the left of fixation (LVF), which is processed initially by the right hemisphere of the brain, must be redirected to the left hemisphere (collosal transfer) in order for word recognition to proceed intact.

Still, another general constraint to orthographic processing is the fact that written words are perceived as visual objects before attaining the status of linguistic objects. Research has revealed that there seems to be a pre-emption of visual object processing mechanisms during the process of learning to read (McCandliss, B., Cohen, L., & Dehaene, S. (2003), The visual word form area: Expertise for reading in the fusiform gyrus, Trends in Cognitive Sciences, 13, 293-299). For example, the alphabetic array proposed by Grainger and van Heuven is one such mechanism, described as a specialized system developed specifically for the processing of strings of alphanumeric stimuli (but not for symbols) (Grainger, J., & van Heuven, W. (2003), Modeling letter position coding in printed word perception, In P. Bonin (Ed.), The mental lexicon (pp. 1-23), New York: Nova Science).

### Transposed Letter (TL) Priming

The effects of letter order on visual word recognition have a long research history. Early on during word recognition, letter positions are not accurately coded. Evidence of this comes from transposed-letter (TL) priming effects, in which letter strings generated by transposing two adjacent letters (e.g., “jugde” instead of “judge”) produce large priming effects, more than the priming effect with the letters replaced by different letters in the corresponding position (e.g., “junpe” instead of “judge”). Yet, the clearest evidence for TL priming effects was obtained from experiments using non-word anagrams formed by transposing two letters in a real word (e.g., “mohter” instead of “mother”) and comparing performance with matched non-anagram non-words (Andrews, S. (1996), Lexical retrieval and selection processes: Effects of transposed letter confusability, Journal of Memory and Language, 35, 775-800; Bruner, J. S., & O'Dowd, D. (1958), A note on the informativeness of parts of words, Language and Speech, 1, 98-101; Chambers, S. M. (1979), Letter and order information in lexical access, Journal of Verbal Learning and Behavior, 18, 225-241; O'Connor, R. E., & Forster, K. I. (1981), Criterion bias and search sequence bias in word recognition, Memory and Cognition, 9, 78-92; and Perea, M., Rosa, E., & Gomez, C. (2005), The frequency effect for pseudowords in the lexical decision task, Perception and Psychophysics, 67, 301-314). These experiments show that TL non-word anagrams are more often misperceived as a real word or misclassified as a real word in a lexical decision task than the non-anagram controls.

Other experiments that focused on the role of letter order in the perceptual matching task in which subjects had to classify two strings of letters as being either the same or different exhibited a diversity of responses depending on the number of shared letters and the degree to which the shared letters match in ordinal position (Krueger, L. E. (1978), A theory of perceptual matching, Psychological Review, 85, 278-304; Proctor, R. W., & Healy, A. F. (1985), Order-relevant and order-irrelevant decision rules in multiletter matching, Journal of Experimental Psychology: Learning, Memory, and Cognition, 11, 519-537; and Ratcliff, R. (1981), A theory of order relations in perceptual matching, Psychological Review, 88, 552-572). Observed priming effects were ruled by the number of letters shared across prime and target and the degree of positional match. Still, Schoonbaert and Grainger found that the size of TL-priming effects might depend on word length, with larger priming effects for 7-letter words as compared with 5-letter words (Schoonbaert, S., & Grainger, J. (2004), Letter position coding in printed word perception: Effects of repeated and transposed letters, Language and Cognitive Processes, 19, 333-367). More so, Guerrera and Foster found robust TL-priming effects in 8-letter words with rather extreme TL operations involving three transpositions e.g., 13254768-12345678 (Guerrera, C., & Forster, K. I. (2008), Masked form priming with extreme transposition, Language and Cognitive Processes, 23, 117-142). In short, target word length and/or target neighborhood density strongly determines the size of TL-priming effects.

Of equal importance, TL priming effects can also be obtained with the transposition of non-adjacent letters. The robust effects of non-adjacent TL primes were reported by Perea and Lupker with 6-10 letter long Spanish words (Perea, M., & Lupker, S. J. (2004), Can CANISO activate CASINO? Transposed-letter similarity effects with nonadjacent letter positions, Journal of Memory and Language, 51(2), 231-246). Same TL primes effects were reported in English words by Lupker, Perea, and Davis (Lupker, S. J., Perea, M., & Davis, C. J. (2008), Transposed-letter effects: Consonants, vowels, and letter frequency, Language and Cognitive Processes, 23, (1), 93-116). Additionally, Guerrera and Foster have shown that priming effects can be obtained when primes include multiple adjacent transpositions e.g., 12436587-12345678 (Guerrera, C., & Forster, K. I. (2008), Masked form priming with extreme transposition, Language and Cognitive Processes, 23, 117-142).

Past research regarding a possible influence of letter position (inner versus outer letters) in TL priming has shown that non-words formed by transposing two inner letters are harder to respond to in a lexical decision task than non-words formed by transposing the two first or the two last letters (Chambers, S. M. (1979), Letter and order information in lexical access, Journal of Verbal Learning and Behavior, 18, 225-241). Still, Schoonbaert and Grainger provided evidence that TL primes involving an outer letter (the first or the last letter of a word) are less effective than TL primes involving two inner letters (Schoonbaert, S., & Grainger, J. (2004), Letter position coding in printed word perception: Effects of repeated and transposed letters, Language and Cognitive Processes, 19, 333-367). Guerrera and Foster also suggested a special role of a word's outer letters (Guerrera, C., & Forster, K. I. (2008), Masked form priming with extreme transposition, Language and Cognitive Processes, 23, 117-142; and Jordan, T. R., Thomas, S. M., Patching, G. R., & Scott-Brown, K. C. (2003), Assessing the importance of letter pairs in initial, exterior, and interior positions in reading, Journal of Experimental Psychology: Learning, Memory, and Cognition, 29, 883-893).

In all of the above-mentioned studies, the TL priming contained all of the target's letters. When primes do not contain the entire target's letters, TL priming effects diminish substantially and tend to vanish (Humphreys, G. W., Evett, L. J., & Quinlan, P. T. (1990), Orthographic processing in visual word identification, Cognitive Psychology, 22, 517-560; and Peressotti, F., & Grainger, J. (1999), The role of letter identity and letter position in orthographic priming, Perception and Psychophysics, 61, 691-706).

### Relative-Position (RP) Priming

Relative-position (RP) priming involves a change in length across the prime and target such that shared letters can have the same order without being matched in terms of absolute length-dependent positions. RP priming can be achieved by removing some of the target's letters to form the prime stimulus (subset priming) or by adding letters to the target (superset priming). Primes and targets differing in length are obtained so that absolute position information changes while the relative order of letters is preserved. For example, for a 5-letter target e.g., 12345, a 5-letter substitution prime such as 1dd45 contains letters that have the same absolute position in the prime and the target, while a 4-letter subset prime such as 1245 contains letters that preserve their relative order in the prime and the target but not their precise length-dependent position. Humphreys et al. reported significant priming for primes sharing four out of five of the target's letters in the same relative position (1245) compared to both a TL prime condition (1435) and an outer-letter only condition 1 dd5 (Humphreys, G. W., Evett, L. J., & Quinlan, P. T. (1990), Orthographic processing in visual word identification, Cognitive Psychology, 22, 517-560).

Peressotti and Grainger provided further evidence for the effects of RL priming using the Foster and Davis masked priming technique. They reported that, with 6-letter target words, RP primes (1346) produced a significant priming effect compared with unrelated primes (dddd). Meanwhile, violation of the relative position of letters across the prime and the target e.g., 1436, 6341 cancelled priming effects relative to all different letter primes e.g., dddd (Peressotti, F., & Grainger, J. (1999), The role of letter identity and letter position in orthographic priming, Perception and Psychophysics, 61, 691-706). Grainger et al., reported small advantages for beginning-letter primes e.g., 1234/12345 compared with end-letter primes e.g., 4567/6789 (Grainger, J., Granier, J. P., Farioli, F., Van Assche, E., & van Heuven, W. (2006a), Letter position information and printed word perception: The relative-position priming constraint, Journal of Experimental Psychology: Human Perception and Performance, 32, 865-884). Likewise, an advantage for completely contiguous primes e.g., 1234/12345-34567/56789 is explained in terms of a phonological overlap in the contiguous condition compared with non-contiguous primes e.g., 1357/13457/1469/14569 (Frankish, C., & Turner, E. (2007), SIHGT and SUNOD: The role of orthography and phonology in the perception of transposed letter anagrams, Journal of Memory and Language, 56, 189-211). Further, Schoonbaert and Grainger utilize 7-letter target words containing a non-adjacent repeated letter such as “balance” and form prime stimuli “balnce” or “balace”. They reported priming effects were not influenced by the presence or absence of a letter repetition in the formed prime stimulus. On the other hand, performance to target stimuli independently of prime condition was adversely affected by the presence of a repeated letter, and this was true for both the word and non-word targets (Schoonbaert, S., & Grainger, J. (2004), Letter position coding in printed word perception: Effects of repeated and transposed letters, Language and Cognitive Processes, 19, 333-367).

### Letter Position Serial Encoding: The SERIOL Model

The SERIOL model (Sequential Encoding Regulated by Inputs to Oscillations within Letter units) is a theoretical framework that provides a comprehensive account of string processing in the proficient reader. It offers a computational theory of how a retinotopic representation is converted into an abstract representation of letter order. The model mainly focuses on bottom-up processing, but this is not meant to rule out top-down interactions.

The SERIOL model is comprised of five layers: 1) edges, 2) features, 3) letters, 4) open-bigrams, and 5) words. Each layer is comprised of processing units called nodes, which represent groups of neurons. The first two layers are retinotopic, while the latter three layers are abstract. For the retinotopic layers, the activation level denotes the total amount of neural activity across all nodes devoted to representing a letter within a given layer. A letter's activation level increases with the number of neurons representing that letter and their firing rate. For the abstract layers, the activation denotes the activity level of a representational letter unit in a given layer. In essence, the SERIOL model is the only one that specifies an abstract representation of individual letters. Such a letter unit can represent that letter in any retinal location, wherein timing firing binds positional information in the string to letter identity.

The edge layer models early visual cortical areas V1/V2. The edge layer is retinotopically organized and is split along the vertical meridian corresponding to the two cerebral hemispheres. In these early visual cortical areas, the rate of spatial sampling (acuity) is known to sharply decrease with increasing eccentricity. This is modelled by the assumption that activation level decreases as distance from fixation increases. This pattern is termed the ‘acuity gradient’. In short, the activation pattern at the lowest level of the model, the edge layer, corresponds to visual acuity.

The feature layer models V4. The feature layer is also retinotopically organized and split across the hemispheres. Based on learned hemisphere-specific processing, the acuity gradient of the edge layer is converted to a monotonically decreasing activation gradient (called the locational gradient) in the feature layer. The activation level is highest for the first letter and decreases across the string. Hemisphere-specific processing is necessary because the acuity gradient does not match the locational gradient in the first half of a fixated word (i.e., acuity increases from the first letter to the fixated letter and the locational gradient decreases across the string), whereas the acuity gradient and locational gradient match in the second half of the word (i.e., both decreasing). Strong directional lateral inhibition is required in the hemisphere (for left-to-right languages—Right Hemisphere [RH]) contralateral to the first half of the word (for left-to-right languages—Left Visual Field [LVF]), in order to invert the acuity gradient.

At the letter layer, corresponding to the posterior fusiform gyms, letter units fire serially due to the interaction of the activation gradient with oscillatory letter nodes (see above feature layer). That is, the letter unit encoding the first letter fires, then the unit encoding the second letter fires, etc. This mechanism is based on the general proposal that item order is encoded in successive gamma cycles 60 Hz of a theta cycle 5 Hz (Lisman, J. E., & Idiart, M. A. P. (1995), Storage of 7±2 short-term memories in oscillatory subcycles, Science, 267, 1512-1515). Lisman and Idiart have proposed related mechanisms for precisely controlling spike timing, in which nodes undergo synchronous, sub-threshold oscillations of excitability. The amount of input to these nodes then determines the timing of firing with respect to this oscillatory cycle. That is, each activated letter unit fires in a burst for about 15 ms (one gamma cycle), and bursting repeats every 200 ms (one theta cycle). Activated letter units burst slightly out of phase with each other, such that they fire in a rapid sequence. This firing rapid sequence encoding (seriality) is the key point of abstraction.

In the present SERIOL model, the retinotopic presentation is mapped onto a temporal representation (space is mapped onto time) to create an abstract, invariant representation that provides a location-invariant representation of letter order. This abstract serial encoding provides input to both the lexical and sub-lexical routes. It is assumed that the sub-lexical route parses and translates the sequence of letters into a grapho-phonological encoding (Whitney, C., & Cornelissen, P. (2005), Letter-position encoding and dyslexia, Journal of Research in Reading, 28, 274-301). The resulting representation encodes syllabic structure and records which graphemes generated which phonemes. The remaining layers of the model address processing that is specific to the lexical route.

At the open-bigram layer, corresponding to the left middle fusiform, letter units recognize pairs of letter units that fire in a particular order (Grainger, J., & Whitney, C. (2004), Does the huamn mnid raed wrods as a whole?, Trends in Cognitive Sciences, 8, 58-59). For example, open-bigram unit XY is activated when letter unit X fires before Y, where the letters x and y were not necessarily contiguous in the string. The activation of an open-bigram unit decreases with increasing time between the firing of the constituent letter units. Thus, the activation of open-bigram XY is highest when triggered by contiguous letters, and decreases as the number of intervening letters increases. Priming data indicates that the maximum separation is likely to be two letters (Schoonbaert, S., & Grainger, J. (2004), Letter position coding in printed word perception: Effects of repeated and transposed letters, Language and Cognitive Processes, 19, 333-367). Open-bigram activations depend only on the distance between the constituent letters (Whitney, C. (2004a), Investigations into the neural basis of structured representations, Doctoral Dissertation. University of Maryland).

Still, following the evidence for a special role for external letters, the string is anchored to those endpoints via edge open-bigrams; whereby edge units explicitly encode the first and last letters (Humphreys, G. W., Evett, L. J., & Quinlan, P. T. (1990), Orthographic processing in visual word identification, Cognitive Psychology, 22, 517-560). For example, the encoding of the stimulus CART would be *C (open-bigram *C is activated when letter C is preceded by a space), CA, AR, CR, RT, AT, CT, and T* (open-bigram *T is activated when letter T is followed by a space), where * represents an edge or space. In contrast to other open-bigrams inside the string, an edge open-bigram cannot become partially activated (e.g., by the second or next-to-last letter).

At the word layer, the open-bigram units attach via weighted connections. The input to a word unit is represented by the dot-product of its respective number of open-bigram unit activations and the weighted connections to those open-bigrams units. Stated another way, it is the dot-product of the open-bigram unit's activation vector and the connection of the open-bigrams unit's weight vector. Commonly in neural networks models, the normalization of vector connection weights is assumed such that open-bigrams making up shorter words have higher connections weights than open-bigrams making up longer words. For example, the connection weights from CA, AN, and CN to the word-unit CAN are larger than the connections weights to the word-unit CANON. Hence, the stimulus can/would activate CAN more than CANON.

### Visual Perceptual Patterns

The SERIOL model assumes that the feature layer is comprised of features that are specific to alphanumeric-string serial processing. A stimulus would activate both alphanumeric-specific and general features. Alphanumeric-specific features would be subject to the locational gradient, while general features would reflect acuity. Alphanumeric-specific-features that activate alphanumeric representations would show the effects of string-specific serial processing. In particular, there will be an advantage if the letter or number character is the initial or last character of a string. However, if the symbol is not a letter or a number character, the alphanumeric-specific features will not activate an alphanumeric representation and there will be no alphanumeric-specific effects. Rather, the symbol will be recognized via the general visual features, where the effect of acuity predominates. An initial or last symbol in the string will be at a disadvantage because its acuity is lower than the acuity for the internal symbols in the string.

Two studies have examined visual perceptual patterns for letters versus non-alphanumeric characters in strings of centrally presented stimuli, using a between-subjects design for the different stimulus types (Hammond, E. J., & Green, D. W. (1982), Detecting targets in letter and non-letter arrays, Canadian Journal of Psychology, 36, 67-82). Both studies found an external-character advantage for letters. Specifically, the first and last letter characters were processed more efficiently than the internal letters characters. Mason also showed an external-character advantage for number strings (Mason, M. (1982), Recognition time for letters and non-letters: Effects of serial position, array size, and processing order, Journal of Experimental Psychology: Human Perception and Performance, 8, 724-738). However, both studies found that the advantage was absent for non-alphanumeric characters. The first and last symbol in a string were processed the least well in line with their lower acuity.

Using fixated strings containing both letters and non-alphanumeric characters, Tydgat and Grainger showed that an initial letter character in a string had a visual recognition advantage while an initial symbol (non-alphanumeric character) in the string did not. Thus, symbols that do not normally occur in strings show a different visual perceptual pattern than alphanumeric characters (Tydgat, I., and Grainger, J. (2009), Serial position effects in the identification of letters, digits, and symbols, J. Exp. Psychol. Hum. Percept. Perform. 35, 480-498). As described in more detail by Whitney & Cornelissen, the SERIOL model explains these visual perceptual patterns (Whitney, C., & Cornelissen, P. (2005), Letter-position encoding and dyslexia, Journal of Research in Reading, 28, 274-301; Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., & Cornelissen, P. (2005), Letter-position encoding and dyslexia, Journal of Research in Reading, 28, 274-301).

The external letter character advantage arises as follows. An advantage for the initial letter character in a string comes from the directional inhibition at the (retinotopic) feature level, because the initial letter character is the only letter character that does not receive lateral inhibition. An advantage for the final letter character arises at the (abstract) letter layer level, because the firing of the last letter character in a string is not terminated by a subsequent letter character. This serial positioning processing is specific to alphanumeric strings, thus explaining the lack of external character visual perceptual advantage for non-alphanumeric characters.

### Letter Position Parallel Encoding: The Grainger & Van Heuven Model

According to the Grainger and van Heuven model, parallel mapping of visual feature information at a specific location along the horizontal meridian with respect to eye fixation is mapped onto abstract letter representations that code for the presence of a given letter identity at that particular location (Grainger, J., & van Heuven, W. J. B. (2003), Modeling letter position coding in printed word perception, In P. Bonin (Ed.), Mental lexicon: “Some words to talk about words” (pp. 1-24). New York, N.Y.: Nova Science). In other words, this model proposes an “alphabetic array” retinotopic encoding consisting in a hypothesized bank of letter detectors that perform parallel, independent letter identification (any given letter has a separate representation for each retinal location). Grainger and van Heuven further proposed that these letters detectors are assumed to be invariant to the physical characteristics of letters and that these abstract letter representations are thought to be activated equally well by the same letter written in different case, in a different font, or a different size, but not invariant to position.

The next stage of processing, referred to as the “relative-position map”, is thought to code for the relative (within-stimulus) position of letters identities independently of their shape and their size, and independently of the location of the stimulus word (location invariance). This location-specific coding of letter identities is then transformed into a location invariant pre-lexical orthographic code (the relative-position map) before matching this information with whole-word orthographic representations in long-term memory. In essence, the relative-position map abstracts away from absolute letter position and focuses instead on relationships between letters. Therefore, in this model, the retinotopic alphabetic array is converted in parallel into an abstract open-bigram encoding that brings into play implicit relationships between letters. Specifically, this is achieved by open-bigram units that receive activation from the alphabetic array such that a given letter order D-E that is realized at any possible combinations of location in the retinotopic alphabetic array, activates the corresponding abstract open bigram for that sequence. Still, abstract open bigrams are activated by letter pairs that have up to two intervening letters. The abstract open-bigrams units then connect to word units. A key distinguishing virtue of this specific approach to letter position encoding rests on the assumption/claim that flexible orthographic coding is achieved by coding for ordered combinations of contiguous and non-contiguous letters pairs.

### Relationships Between Letters in a String-Coding Non-Contiguous Letter Combinations

Currently, there is a general consensus that the literate brain executes some form of word-centered, location-independent, orthographic coding such that letter identities are abstractly coded for their position in the word independent of their position on the retina (at least for words that require a single fixation for processing). This consensus also holds true for within-word position coding of letters identities to be flexible and approximate. In other words, letter identities are not rigidly allocated to a specific position. The corroboration for such flexibility and approximate orthographic encoding has been mainly classically obtained by utilizing the masked priming paradigm: for a given number of letters shared by the prime and target, priming effects are not affected by small changes of letter order (flexible and approximate letter position encoding)—transposed letter (TL) priming (Perea, M., and Lupker, S. J. (2004), Can CANISO activate CASINO? Transposed-letter similarity effects with nonadjacent letter positions, J. Mem. Lang. 51, 231-246; and Schoonbaert, S., and Grainger, J. (2004), Letter position coding in printed word perception: effects of repeated and transposed letters, Lang. Cogn. Process. 19, 333-367), and length-dependent letter position-relative-position priming (Peressotti, F., and Grainger, J. (1999), The role of letter identity and letter position in orthographic priming, Percept. Psychophys. 61, 691-706; and Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884).

Yet, the claim for a flexible and approximate orthographic encoding has extended to be also achieved by coding for letter combinations (Whitney, C., and Berndt, R. S. (1999), A new model of letter string encoding: simulating right neglect dyslexia, in Progress in Brain Research, eds J. A. Reggia, E. Ruppin, and D. Glanzman (Amsterdam: Elsevier), 143-163; Whitney, C. (2001), How the brain encodes the order of letters in a printed word: the SERIOL model and selective literature review, Psychon. Bull. Rev. 8, 221-243; Grainger, J., and van Heuven, W. J. B. (2003), Modeling letter position coding in printed word perception, in The Mental Lexicon, ed. P. Bonin (New York: Nova Science Publishers), 1-23; Dehaene, S., Cohen, L., Sigman, M., and Vinckier, F. (2005), The neural code for written words: a proposal, Trends Cogn. Sci. (Regul. Ed.) 9, 335-341). Letter combinations are classically and exclusively demonstrated by the use of contiguous letter combinations in n-gram coding and in particular by the use of non-contiguous letter combinations in n-gram coding. Dehaene has proposed that the coding of non-contiguous letter combinations arises as an artifact because of noisy erratic position retinotopic coding in location-specific letters detectors (Dehaene, S., Cohen, L., Sigman, M., and Vinckier, F. (2005), The neural code for written words: a proposal, Trends Cogn. Sci. (Regul. Ed.) 9, 335-341). In this scheme, the additional flexibility in orthographic encoding arises by accident, but the resulting flexibility is utilized to capture key data patterns.

In contrast, Dandurant has taken a different perspective, proposing that the coding of non-contiguous letter combinations is deliberate, and not the result of inaccurate location-specific letter coding (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In other words, non-contiguous letter combinations are coded because they are beneficial with respect to the overall goal of mapping letters onto meaning, not because the system is intrinsically noisy and therefore imprecise to determine the exact location of letters in a string. Dandurant et al., have examined two kinds of constrains that a reader should take into consideration when optimally processing orthographic information: 1) variations in letter visibility across the different letters of a word during a single fixation and 2) varying amount of information carried by the different letters in the word (e.g., consonants versus vowels letters). More specifically, they have hypothesized that this orthographic processing optimization would involve coding of non-contiguous letters combinations.

The reason for optimal processing of non-contiguous letter combinations can be explained on the following basis: 1) when selecting an ordered subset of letters which are critical to the identification of a word (e.g., the word “fatigue” can be uniquely identified by ordered letters substrings “ftge” and “atge” which result from dropping non-essential letters that bear little information), about half of the letters in the resulting subset are non-contiguous letters; and 2) the most informative pair of letters in a word is a non-contiguous pair of letters combination in 83% of 5-7 letter words (having no letter repetition) in English, and 78% in French and Spanish (the number of words included in the test set were 5838 in French, 8412 in English, and 4750 in Spanish) (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In summary, they concluded that an optimal and rational agent learning to read corpuses of real words should deliberately code for non-contiguous pair of letters (open-bigrams) based on informational content and given letters visibility constrains (e.g., initial, middle and last letters in an string of letters are more visually perceptually visible).

### Different Serial Position Effects in the Identification of Letters, Digits, and Symbols

In languages that use alphabetical orthographies, the very first stage of the reading process involves mapping visual features onto representations of the component letters of the currently fixated word (Grainger, J., Tydgat, I., and Isselé, J. (2010), Crowding affects letters and symbols differently, J. Exp. Psychol. Hum. Percept. Perform. 36, 673-688). Comparison of serial position functions using the target search task for letter stimuli versus symbol stimuli or simple shapes showed that search times for a target letter in a string of letters are represented by an approximate M-shape serial position function, where the shortest reaction times (RTs) were recorded for the first, third and fifth positions of a five-letter string (Estes, W. K., Allmeyer, D. H., & Reder, S. M. (1976), Serial position functions for letter identification at brief and extended exposure durations, Perception & Psychophysics, 19, 1-15). In contrast, a 5-symbol string (e.g., $, %, &) and shape stimuli shows a U-shape function with shortest RTs for targets at the central position on fixation that increase as a function of eccentricity (Hammond, E. J., & Green, D. W. (1982), Detecting targets in letter and non-letter arrays, Canadian Journal of Psychology, 36, 67-82).

A definitive interpretation of the different effect serial position has on letters and symbols is that it reflects the combination of two factors: 1) the drop of acuity from fixation to the periphery, and 2) less crowding on the first and last letter of the string because these letters are flanked by only one other letter (Bouma, H. (1973), Visual interference in the parafoveal recognition of initial and final letters of word, Vision Research, 13, 762-82). Specifically expanding on the second factor, Tydgat and Grainger proposed that crowding effects may be more limited in spatial extent for letter and number stimuli compared with symbol stimuli, such that a single flanking stimulus would suffice to generate almost maximum interference for symbols, but not for letters and numbers (Tydgat, I., and Grainger, J. (2009), Serial position effects in the identification of letters, digits, and symbols, J. Exp. Psychol. Hum. Percept. Perform. 35, 480-498). According to the Tydgat and Grainger interpretation of the different serial position functions for letters and symbols, one should be able to observe differential crowding effects for letters and symbols in terms of a superior performance at the first and last positions for letter stimuli but not for symbols or shapes stimuli. In a number of experiments they tested the hypothesis that a reduction in size of integration fields at the retinotopic layer, specific to stimuli that typically appear in strings (letters and digits), results in less crowding for such stimuli compared with other types of visual stimuli such as symbols and geometric shapes. In other words, the larger the integration field involved in identifying a given target at a given location, the greater the number of features from neighboring stimuli that can interfere in target identification. Stated another way, letter and digit stimuli benefit from a greater release from crowding effects (flanking letters or digits) at the outer positions than do symbol and geometric shape stimuli.

Still, critical spacing was found to be smaller for letters than for other symbols, with letter targets being identified more accurately than symbol targets at the lowest levels of inter-character spacing (manipulation of target-flankers spacing showed that symbols required a greater degree of separation [larger critical spacing] than letters in order to reach a criterion level of identification) (See experiment 5, Grainger, J., Tydgat, I., and Isselé, J. (2010), Crowding affects letters and symbols differently, J. Exp. Psychol. Hum. Percept. Perform. 36, 673-688). Most importantly, differential serial position crowding effects are of great importance given the fact that performance in the Two-Alternative Forced-Choice Procedure of isolated symbols and letters was very similar (Grainger, J., Tydgat, I., and Isselé, J. (2010), Crowding affects letters and symbols differently, J. Exp. Psychol. Hum. Percept. Perform. 36, 673-688).

Concerning the potential mechanism of crowding effects, Grainger et al. proposed bottom-up mechanisms whose operation can vary as a function of stimulus type via off-line as opposed to on-line influences. These off-line influences of stimulus type involved differences in perceptual learning driven by differential exposure to the different types of stimuli. Further, they proposed that when children learn to read, a specialized system develops in the visual cortex to optimize processing in the extremely crowded conditions that arise with printed words and numeric strings (e.g., in a two-stage retinotopic processing model: in the first-stage there is a detection of simple features in receptive fields of V1-0.1 ø and in a second-stage there is integration/interpretation in receptive fields of V4-0.5 ø [neurons in V4 are modulated by attention]) (See Levi, D. M., (2008), Crowding—An essential bottleneck for object recognition: A mini-review, Vision Research, 48, 635-654).

The central tenant here is that receptive field size of retinotopic letter and digit detectors has adapted to the need to optimize processing of strings of letters and digits and that the smaller the receptive field size of these detectors, the less interference there is from neighboring characters. One way to attain such processing optimization is being explained as a reduction in the size and shape of “integration fields.” The “integration field” is equivalent to a second-stage receptive field that combines the features by the earlier stage into an (object) alphanumeric character associated with location-specific letter detectors, “the alphabetic array”, that perform parallel letter identification compared with other visual objects that do not typically occur in such a cluttered environment (Dehaene, S., Cohen, L., Sigman, M., and Vinckier, F. (2005), The neural code for written words: a proposal, Trends Cogn. Sci. (Regul. Ed.) 9, 335-341; Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884; and Grainger, J., and van Heuven, W. J. B. (2003), Modeling letter position coding in printed word perception, in The Mental Lexicon, ed. P. Bonin (New York: Nova Science Publishers), 1-23).

Ktori, Grainger, Dufau provided further evidence on differential effects between letters and symbols stimuli (Maria Ktori, Jonathan Grainger & Stephan Dufau (2012), Letter string processing and visual short-term memory, The Quarterly Journal of Experimental Psychology, 65:3, 465-473). They study how expertise affects visual short-term memory (VSTM) item storage capacity and item encoding accuracy. VSTM is recognized as an important component of perceptual and cognitive processing in tasks that rest on visual input (Prime, D., & Jolicoeur, P. (2010), Mental rotation requires visual short-term memory: Evidence from human electric cortical activity, Journal of Cognitive Neuroscience, 22, 2437-2446). Specifically, Prime and Jolicoeur investigated whether the spatial layout of letters making up a string affects the accuracy with which a group of proficient adult readers performed a change-detection task (Luck, S. J. (2008), Visual short-term memory, In S. J. Luck & A. Hollingworth (Eds.), Visual memory (pp. 43-85). New York, N.Y.: Oxford University Press), item arrays that varied in terms of character type (letters or symbols), number of items (3, 5, and 7), and type of display (horizontal, vertical and circular) are used. Study results revealed an effect of stimulus familiarity significantly noticeable in more accurate change-detection responses for letters than for symbols. In line with the hypothesized experimental goals in the study, they found evidence that supports that highly familiar items, such as arrays of letters, are more accurately encoded in VSTM than unfamiliar items, such as arrays of symbols. More so, their study results provided additional evidence that expertise is a key factor influencing the accuracy with which representations are stored in VSTM. This was revealed by the selective advantage shown for letter over symbol stimuli when presented in horizontal compared to vertical or circular displays formats. The observed selective advantage of letters over symbols can be the result of years of reading that leads to expertise in processing horizontally aligned strings of letters so as to form word units in alphabetic languages such as English, French and Spanish.

In summary, the study findings support the argument that letter string processing is significantly influenced by the spatial layout of letters in strings in perfect agreement with other studies findings conducted by Grainger & van Heuven (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers and Tydgat, I., & Grainger, J. (2009), Serial position effects in the identification of letters, digits and symbols, Journal of Experimental Psychology: Human Perception and Performance, 35, 480-498).

Open Proto-Bigrams Embedded within Words (Subset Words) and as Standalone Connecting Word in-Between Words

A number of computational models have postulated open-bigrams as best means to substantiate a flexible orthographic encoding capable of explaining TL and RP priming effects. In the Grainger & van Heuven model the retinotopic alphabetic array is converted in parallel into an abstract open-bigram encoding that brings into play implicit relationships between letters (e.g., contiguous and non-contiguous) (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers). In the SERIOL model retinotopic visual stimuli presentation is mapped onto a temporal one where letter units recognize pairs of letter units (an open-bigram) that fire in a particular serial order; namely, space is mapped onto time to create an abstract invariant representation providing a location-invariant representation of letter order in a string (Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., and Cornelissen, P. (2005), Letter-position encoding and dyslexia, J. Res. Read. 28, 274-301). In these models, open-bigrams represent an abstract intermediary layer between letters and word units.

A key distinguishing virtue of this specific approach to letter position encoding rests on that flexible orthographic coding is achieved by coding for ordered combinations of contiguous and non-contiguous letters pairs, namely open-bigrams. For example, in the English language there are 676 pairs of letters combinations or open-bigrams (see Table 1 below). In addition to studies that have shown open-bigrams information processing differences between pair of letters entailing CC, VV, VC or CV, we introduce herein an additional open-bigrams novel property that should be interpreted as causing an automatic direct cascaded spread activation effect from orthography to semantics. Specifically, an open-bigram of the form VC or CV that is also a word carrying a semantic meaning such as for example: AM, AN, AS, AT, BE, BY, DO, GO, HE, IF, IN, IS, IT, ME, MY, NO, OF, ON, OR, SO, TO, UP, US, WE, is herein dubbed “open proto-bigram”. Still, these 24 open proto-bigrams that are also words represent 3.55% of all open-bigrams obtained from the English Language alphabet (see Table 1 below). Open proto-bigrams that are a subset word e.g., “BE” embedded in a word e.g., “BELOW” or are a subset word “HE” embedded in a superset word e.g., “SHE” or “THE” would not only indicate that the orthographic or phonological forms of the subset open proto-bigram word “HE” in the superset word “SHE” or “THE” or the subset open proto-bigram word “BE” in the word “BELOW” were activated in parallel, but also that these co-activated word forms triggered automatically and directly their corresponding semantic representations during the course of identifying the orthographic form of the word.

Based on the herein presented literature and novel teachings of the present subject matter, it is further assumed that this automatic bottom-up-top-down orthographic parallel-serial informational processing handshake, manifests in a direct cascade effect providing a number of advantages, thus facilitating the following perceptual-cognitive process: 1) fast lexical-sub-lexical recognition, 2) maximal chunking (data compression) of number of items in VSTM, 3) fast processing, 4) solid consolidation encoding in short-term memory (STM) and long-term memory (LTM), 5) fast semantic track for extraction/retrieval of word literal meaning, 6) less attentional cognitive taxing, 7) most effective activation of neighboring word forms, including multi-letter graphemes (e.g., th, ch) and morphemes (e.g., ing, er), 8) direct fast word recall that strongly inhibits competing or non-congruent distracting word forms; and 9) for a proficient reader, when open proto-bigrams are a standalone connecting a word unit in between words in a sentence, there is no need for (open proto-bigram) orthographic lexical pattern recognition and retrieval of their corresponding semantic literal information due to their super-efficient maximal chunking (data compression) and robust consolidation in STM-LTM. Namely, standalone open proto-bigrams connecting words in between words in sentences are automatically known implicitly. Thus, a proficient reader may also not consciously and explicitly pay attention to them and will therefore remain minimally aroused to their visual appearance.

TABLE 1
Open-Bigrams of the English Language

| | | | | | | | | | | | | | | | | | | | | | | | | | |
|---|---|---|---|---|---|---|---|---|---|---|---|---|---|---|---|---|---|---|---|---|---|---|---|---|---|
| aa | ab | ac | ad | ae | af | ag | ah | ai | aj | ak | al | am | an | ao | ap | aq | ar | as | at | au | av | aw | ax | ay | az |
| ba | bb | bc | bd | be | bf | bg | bh | bi | bj | bk | bl | bm | bn | bo | bp | bq | br | bs | bt | bu | bv | bw | bx | by | bz |
| ca | cb | cc | cd | ce | cf | cg | ch | ci | cj | ck | cl | cm | cn | co | cp | cq | cr | cs | ct | cu | cv | cw | cx | cy | cz |
| da | db | dc | dd | de | df | dg | dh | di | dj | dk | dl | dm | dn | do | dp | dq | dr | ds | dt | du | dv | dw | dx | dy | dz |
| ea | eb | ec | ed | ee | ef | eg | eh | ei | ej | ek | el | em | en | eo | ep | eq | er | es | et | eu | ev | ew | ex | ey | ez |
| fa | fb | fc | fd | fe | ff | fg | fh | fi | fj | fk | fl | fm | fn | fo | fp | fq | fr | fs | ft | fu | fv | fw | fx | fy | fz |
| ga | gb | gc | gd | ge | gf | gg | gh | gi | gj | gk | gl | gm | gn | go | gp | gq | gr | gs | gt | gu | gv | gw | gx | gy | gz |
| ha | hb | hc | hd | he | hf | hg | hh | hi | hj | hk | hl | hm | hn | ho | hp | hq | hr | hs | ht | hu | hv | hw | hx | hy | hz |
| ia | ib | ic | id | ie | if | ig | ih | ii | ij | ik | il | im | in | io | ip | iq | ir | is | it | iu | iv | iw | ix | iy | iz |
| ja | jb | jc | jd | je | jf | jg | jh | ji | jj | jk | jl | jm | jn | jo | jp | jq | jr | js | jt | ju | jv | jw | jx | jy | jz |
| ka | kb | kc | kd | ke | kf | kg | kh | ki | kj | kk | kl | km | kn | ko | kp | kq | kr | ks | kt | ku | kv | kw | kx | ky | kz |
| la | lb | lc | ld | le | lf | lg | lh | li | lj | lk | ll | lm | ln | lo | lp | lq | lr | ls | lt | lu | lv | lw | lx | ly | lz |
| ma | mb | mc | md | me | mf | mg | mh | mi | mj | mk | ml | mm | mn | mo | mp | mq | mr | ms | mt | mu | mv | mw | mx | my | mz |
| na | nb | nc | nd | ne | nf | ng | nh | ni | nj | nk | nl | nm | nn | no | np | nq | nr | ns | nt | nu | nv | nw | nx | ny | nz |
| oa | ob | oc | od | oe | of | og | oh | oi | oj | ok | ol | om | on | oo | op | oq | or | os | ot | ou | ov | ow | ox | oy | oz |
| pa | pb | pc | pd | pe | pf | pg | ph | pi | pj | pk | pl | pm | pn | po | pp | pq | pr | ps | pt | pu | pv | pw | px | py | pz |
| qa | qb | qc | qd | qe | qf | qg | qh | qi | qj | qk | ql | qm | qn | qo | qp | qq | qr | qs | qt | qu | qv | qw | qx | qy | qz |
| ra | rb | rc | rd | re | rf | rg | rh | ri | rj | rk | rl | rm | rn | ro | rp | rq | rr | rs | rt | ru | rv | rw | rx | ry | rz |
| sa | sb | sc | sd | se | sf | sg | sh | si | sj | sk | sl | sm | sn | so | sp | sq | sr | ss | st | su | sv | sw | sx | sy | sz |
| ta | tb | tc | td | te | tf | tg | th | ti | tj | tk | tl | tm | tn | to | tp | tq | tr | ts | tt | tu | tv | tw | tx | ty | tz |
| ua | ub | uc | ud | ue | uf | ug | uh | ui | uj | uk | ul | um | un | uo | up | uq | ur | us | ut | uu | uv | uw | ux | uy | uz |
| va | vb | vc | vd | ve | vf | vg | vh | vi | vj | vk | vl | vm | vn | vo | vp | vq | vr | vs | vt | vu | vv | vw | vx | vy | vz |
| wa | wb | wc | wd | we | wf | wg | wh | wi | wj | wk | wl | wm | wn | wo | wp | wq | wr | ws | wt | wu | wv | ww | wx | wy | wz |
| xa | xb | xc | xd | xe | xf | xg | xh | xi | xj | xk | xl | xm | xn | xo | xp | xq | xr | xs | xt | xu | xv | xw | xx | xy | xz |
| ya | yb | yc | yd | ye | yf | yg | yh | yi | yj | yk | yl | ym | yn | yo | yp | yq | yr | ys | yt | yu | yv | yw | yx | yy | yz |
| za | zb | zc | zd | ze | zf | zg | zh | zi | zj | zk | zl | zm | zn | zo | zp | zq | zr | zs | zt | zu | zv | zw | zx | zy | zz |

### Open Proto-Bigrams Words as Standalone Function Words in Between Words in Alphabetic Languages

Open-bigrams that are words (herein termed “open proto-bigrams), as for example: AM, AN, AS, AT, BE, BY, DO, GO, HE, IF, IN, IS, IT, ME, MY, NO, OF, ON, OR, SO, TO, UP, US, WE, belong to a linguistic class named ‘function words’. Function words either have reduced lexical or ambiguous meaning. They signal the structural grammatical relationship that words have to one another and are the glue that holds sentences together. Function words also specify the attitude or mood of the speaker. They are resistant to change and are always relatively few (in comparison to ‘content words’). Accordingly, open proto-bigrams (and other n-grams e.g. “THE”) words may belong to one or more of the following function words classes: articles, pronouns, adpositions, conjunctions, auxiliary verbs, interjections, particles, expletives and pro-sentences. Still, open proto-bigrams that are function words are traditionally categorized across alphabetic languages as belonging to a class named ‘common words’. In the English language, there are about 350 common words which stand for about 65-75% of the words used when speaking, reading and writing. These 350 common words satisfy the following criteria: 1) they are the most frequent/basic words of an alphabetic language; 2) they are the shortest words—up to 7 letters per word; and 3) they cannot be perceptually identified (access to their semantic meaning) by the way they sound; they must be recognized visually, and therefore are also named ‘sight words’.

Frequency Effects in Alphabetical Languages for: 1) Open Bigrams and 2) Open Proto-Bigrams Function Words as: a) Standalone Function Words in Between Words and b) as Subset Function Words Embedded within Words

Fifty to 75% of the words displayed on a page or articulated in a conversation are frequent repetitions of most common words. Just 100 different most common words in the English language (see Table 2 below) account for a remarkable 50% of any written text. Further, it is noteworthy that 22 of the above-mentioned open proto-bigrams function words are also most common words that appear within the 100 most common words, meaning that on average one in any two spoken or written words would be one of these 100 most common words. Similarly, the 350 most common words account for 65% to 75% of everything written or spoken, and 90% of any average written text or conversation will only need a vocabulary of common 7,000 words from the existing 1,000,000 words in the English language.

TABLE 2
Most Frequently Used Words Oxford Dictionary 11^{Th} Edition

| | |
|---|---|
| 1. | the |
| 2. | be |
| 3. | to |
| 4 | of |
| 5. | and |
| 6. | a |
| 7. | in |
| 8. | that |
| 9. | have |
| 10. | I |
| 11. | it |
| 12. | for |
| 13. | not |
| 14. | on |
| 15. | with |
| 16. | he |
| 17. | as |
| 18. | you |
| 19. | do |
| 20. | at |
| 21. | this |
| 22. | but |
| 23. | his |
| 24. | by |
| 25. | from |
| 26. | they |
| 27. | we |
| 28. | say |
| 29. | her |
| 30. | she |
| 31. | or |
| 32. | an |
| 33. | will |
| 34. | my |
| 35. | one |
| 36. | all |
| 37. | would |
| 38. | there |
| 39. | their |
| 40. | what |
| 41. | so |
| 42. | up |
| 43. | out |
| 44. | if |
| 45. | about |
| 46. | who |
| 47. | get |
| 48. | which |
| 49. | go |
| 50. | me |
| 51. | when |
| 52. | make |
| 53. | can |
| 54. | like |
| 55. | time |
| 56. | no |
| 57. | just |
| 58. | him |
| 59. | know |
| 60. | take |
| 61. | person |
| 62. | into |
| 63. | year |
| 64. | your |
| 65. | good |
| 66. | some |
| 67. | could |
| 68. | them |
| 69. | see |
| 70. | other |
| 71. | than |
| 72. | then |
| 73. | now |
| 74. | look |
| 75. | only |
| 76. | come |
| 77. | its |
| 78. | over |
| 79. | think |
| 80. | also |
| 81. | back |
| 82. | after |
| 83. | use |
| 84. | two |
| 85. | how |
| 86. | our |
| 87. | work |
| 88. | first |
| 89. | well |
| 90. | way |
| 91. | even |
| 92. | new |
| 93. | want |
| 94. | because |
| 95. | any |
| 96. | these |
| 97. | give |
| 98. | day |
| 99. | most |
| 100. | us |

Most Frequently Used Words Oxford Dictionary 11^{th} Edition

Still, it is noteworthy that a large number of these 350 most common words entail 1 or 2 open pro-bigrams function words as embedded subset words within the most common word unit (see Table 3 below).

TABLE 3
Common Service and Nouns Words List
By: Edward William Dolch—Problems in Reading 1948
Dolch Word List Sorted Alphabetically by Grade with Nouns

| Pre-primer | Primer | First | Second | Third | Nouns | Nouns |
|---|---|---|---|---|---|---|
| a | all | after | always | about | apple | home |
| and | am | again | around | better | baby | horse |
| away | are | an | because | bring | back | house |
| big | at | any | been | carry | ball | kitty |
| blue | ate | as | before | clean | bear | leg |
| can | be | ask | best | cut | bead | letter |
| come | black | by | both | done | bell | man |
| down | brown | could | buy | draw | bird | men |
| find | but | every | call | drink | birthday | milk |
| for | came | fly | cold | eight | boat | money |
| funny | did | from | does | fall | box | morning |
| go | do | give | don't | far | boy | mother |
| help | eat | going | fast | full | bread | name |
| here | four | had | first | got | brother | nest |
| I | get | has | five | grow | cake | night |
| in | good | her | found | hold | car | paper |
| is | have | him | gave | hot | cat | party |
| it | he | his | goes | hurt | chair | picture |
| jump | into | how | green | if | chicken | pig |
| little | like | just | its | keep | children | rabbit |
| look | must | know | made | kind | Christmas | rain |

The teachings of the present subject matter are in perfect agreement with the fact that the brain's anatomical architecture constrains its perceptual-cognitive functional abilities and that some of these abilities become non-stable, decaying or atrophying with age. Indeed, slow processing speed, limited memory storage capacity, lack of sensory-motor inhibition and short attentional span and/or inattention, to mention a few, impose degrees of constrains upon the ability to visually, phonologically and sensory-motor implicitly pick-up, explicitly learn and execute the orthographic code. However, there are a number of mechanisms at play that develop in order to impose a number of constrains to compensate for limited motor-perceptual-cognitive resources. As previously mentioned, written words are visual objects before attaining the status of linguistic objects as has been proposed by McCandliss, Cohen, & Dehaene (McCandliss, B., Cohen, L., & Dehaene, S. (2003), The visual word form area: Expertise for reading in the fusiform gyrus, Trends in Cognitive Sciences, 13, 293-299) and there is pre-emption of visual object processing mechanisms during the process of learning to read (See also Dehaene et al., Local Combination Detector (LCD) model, Dehaene, S., Cohen, L., Sigman, M., and Vinckier, F. (2005), The neural code for written words: a proposal, Trends Cogn. Sci. (Regul. Ed.) 9, 335-341). In line with the latter, Grainger and van Heuven's alphabetic array is one such mechanism, described as a specialized system developed specifically for the processing of strings of alphanumeric stimuli (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers).

Another such mechanism at work is the high lexical-phonological information redundancies conveyed in speech and also found in the lexical components of an alphabetic language orthographic code. For example, relationships among letter combinations within a string and in between strings reflect strong letter combinations redundancies. Thus, the component units of the orthographic code implement frequent repetitions of some open bigrams in general and of all open proto-bigrams (that are words) in particular. In general, lexical and phonological redundancies in speech production and lexical redundancies in writing as reflected in frequent repetitions of some open bigrams and all open proto-bigrams within a string (a word) and among strings (words) in sentences reduces content errors in sender production of written-spoken messages making the spoken phonological-lexical message or orthographic code message resistant to noise or irrelevant contextual production substitutions, thereby increasing the interpretational semantic probability to comprehending the received message in its optimal context by the receiver.

Despite the above-mentioned brain anatomical constrains on function and related limited motor-perceptual-cognitive resources and how these constrains impact the handling of orthographic information, the co-occurrence of some open-bigrams and all open proto-bigrams in alphabetic languages renders alongside other developed compensatory specialized mechanisms at work (e.g. alphabetic array) an offset strategy that implements age-related, fast, coarse-lexical pattern recognition, maximal chunking (data compression) and optimal manipulation of alphanumeric-items in working memory-short-term memory (WM-STM), direct and fast access from lexical to semantics, robust semantic word encoding in STM-LTM and fast (non-aware) semantic word retrieval from LTM. On the other hand, the low co-occurrence of some open-bigrams in a word represent rare (low probability) letter combination events, and therefore are more informative concerning the specific word identity than frequent (predictable) occurring open-bigrams letter combination events in a word (Shannon, C. E. (1948), A mathematical theory of communication, Bell Syst. Tech. J. 27, 379-423). In brief, the low co-occurrence of some open-bigrams conveys most information that determines word identity (diagnostic feature).

Grainger and Ziegler explained that both types of constraints are driven by the frequency with which different combinations of letters occur in printed words. On one hand, frequency of occurrence determines the probability with which a given combination of letters belongs to the word being read. Letter combinations that are encountered less often in other words are more diagnostic (an informational feature that renders ‘word identity’) than the identity of the word being processed. In the extreme, a combination of letters that only occurs in a single word in the language, and is therefore a rarely occurring combination of letters event when considering the language as a whole, is highly informative with respect to word identity. On the other hand, the co-occurrence (high frequency of occurrence) enables the formation of higher-order representations (maximal chunking) in order to diminish the amount of information that is processed via data compression. Letter combinations (e.g., open-bigrams and trigrams) that often occur together can be usefully grouped to form higher-level orthographic representations such as multi-letter graphemes (th, ch) and morphemes (ing, er), thus providing a link with pre-existing phonological and morphological representations during reading acquisition (Grainger, J., & Ziegler, J. C. (2011), A dual-route approach to orthographic processing, Frontiers in Psychology, 2(54), 1-13).

The teachings of the present invention claim that open proto-bigram words are a special class/kind of coarse-grained orthographic code that computes (at the same time/in parallel) occurrences of contiguous and non-contiguous letters combinations (conditional probabilities of one or more subsets of open proto-bigram word(s)) within words and in between words (standalone open proto-bigram word) in order to rapidly hone in on a unique informational word identity alongside the corresponding semantic related representations, namely the fast lexical track to semantics (and correlated mental sensory-motor representation-simulation that grounds the specific semantic (word) meaning to the appropriate action).

### Aging and Language

Early research on cognitive aging has pointed out that language processing was spared in old age, in contradistinction to the decline in “fluid” (e.g. reasoning) intellectual abilities, such as remembering new information and in (sensory-motor) retrieving orthographic-phonologic knowledge (Botwinick, J. (1984), Aging and Behavior. New York: Springer). Still, research in this field strongly supports a general asymmetry in the effects of aging on language perception-comprehension versus production (input versus output processes). Older adults exhibit clear deficits in retrieval of phonological and lexical information from speech alongside retrieval of orthographic information from written language, with no corresponding deficits in language perception and comprehension, independent of sensory and new learning deficits. The input side of language includes visual perception of the letters and corresponding speech sounds that make up words and retrieval of semantic and syntactic information about words and sentences. These input-side language processes are commonly referred to as “language comprehension,” and they remain remarkably stable in old age, independent of age-linked declines in sensory abilities (Madden, D. J. (1988), Adult age differences in the effects of sentence context and stimulus degradation during visual word recognition, Psychology and Aging, 3, 167-172) and memory for new information (Light, L., & Burke, D. (1988), Patterns of language and memory in old age, In L. Light, & D. Burke, (Eds.), Language, memory and aging (pp. 244-271). New York: Cambridge University Press; Kemper, S. (1992b), Language and aging, In F. I. M. Craik & T. A. Salthouse (Eds.) The handbook of aging and cognition (pp. 213-270). Hillsdale, N.J.: Lawrence Erlbaum Associates; and Tun, P. A., & Wingfield, A. (1993), Is speech special? Perception and recall of spoken language in complex environments, In J. Cerella, W. Hoyer, J. Rybash, & M. L. Commons (Eds.) Adult information processing: Limits on loss (pp. 425-457) San Diego: Academic Press).

Tasks highlighting language comprehension processes, such as general knowledge and vocabulary scores in tests such as the Wechsler Adult Intelligence Scale, remain stable or improve with aging and provided much of the data for earlier conclusions about age constancy in language perception-comprehension processes. (Botwinick, J. (1984), Aging and Behavior, New York: Springer; Kramer, N. A., & Jarvik, L. F. (1979), Assessment of intellectual changes in the elderly, In A. Raskin & L. F. Jarvik (Eds.), Psychiatric symptoms and cognitive loss in the elderly (pp. 221-271). Washington, DC: Hemisphere Publishing; and Verhaeghen, P. (2003), Aging and vocabulary scores: A meta-analysis, Psychology and Aging, 18, 332-339). The output side of language involves retrieval of lexical and phonological information during everyday language production and retrieval of orthographic information such as unit components of words, during every day sensory-motor writing and typing activities. These output-side language processes, commonly termed “language production,” do exhibit age-related dramatic performance declines.

Aging has little effect on the representation of semantic knowledge as revealed, for example, by word associations (Burke, D., & Peters, L. (1986), Word associations in old age: Evidence for consistency in semantic encoding during adulthood, Psychology and Aging, 4, 283-292), script generation (Light, L. L., & Anderson, P. A. (1983), Memory for scripts in young and older adults, Memory and Cognition, 11, 435-444), and the structure of taxonomic categories (Howard, D. V. (1980), Category norms: A comparison of the Battig and Montague (1960) norms with the responses of adults between the ages of 20 and 80, Journal of Gerontology, 35, 225-231; and Mueller, J. H., Kausler, D. H., Faherty, A., & Oliveri, M. (1980), Reaction time as a function of age, anxiety, and typicality, Bulletin of the Psychonomic Society, 16, 473-476). Because comprehension involves mapping language onto existing knowledge structures, age constancy in the nature of these structures is important for maintaining language comprehension in old age. There is no age decrement in semantic processes in comprehension for both off-line and online measures of word comprehension in sentences (Speranza, F., Daneman, M., & Schneider, B. A. (2000) How aging affects reading of words in noisy backgrounds, Psychology and Aging, 15, 253-258). For example, the comprehension of isolated words in the semantic priming paradigm, particularly, the reduction in the time required to identify a target word (TEACHER) when it follows a semantically related word, (STUDENT) rather than a semantically unrelated word (GARDEN); here, perception of STUDENT primes semantically related information, automatically speeding recognition of TEACHER; and such semantic priming effects are at least as large in older adults as they are in young adults (Balota, D. A, Black, S., & Cheney, M. (1992), Automatic and attentional priming in young and older adults: Reevaluation of the two process model, Journal of Experimental Psychology: Human Perception and Performance, 18, 489-502; Burke, D., White, H., & Diaz, D. (1987), Semantic priming in young and older adults: Evidence for age-constancy in automatic and attentional processes, Journal of Experimental Psychology: Human Perception and Performance, 13, 79-88; Myerson, J. Ferraro, F. R., Hale, S., & Lima, S. D. (1992), General slowing in semantic priming and word recognition, Psychology and Aging, 7, 257-270; and Laver, G. D., & Burke, D. M. (1993), Why do semantic priming effects increase in old age? A meta-analysis, Psychology and Aging, 8, 34-43). Similarly, sentence context also primes comprehension of word meanings to an equivalent extent for young and older adults (Burke, D. M., & Yee, P. L. (1984), Semantic priming during sentence processing by young and older adults, Developmental Psychology, 20, 903-910; and Stine, E. A. L., & Wingfield, A. (1994), Older adults can inhibit high probability competitors in speech recognition, Aging and Cognition, 1, 152-157).

By contrast to the age constancy in comprehending semantic word meaning, extensive experimental research shows age-related declines in retrieving a name (less accurate and slower) corresponding to definitions, pictures or actions (Au, R., Joung, P., Nicholas, M., Obler, L. K., Kass, R. & Albert, M. L. (1995), Naming ability across the adult life span, Aging and Cognition, 2, 300-311; Bowles, N. L., & Poon, L. W. (1985), Aging and retrieval of words in semantic memory, Journal of Gerontology, 40, 71-77; Nicholas, M., Obler, L., Albert, M., & Goodglass, H. (1985), Lexical retrieval in healthy aging, Cortex, 21, 595-606; and Goulet, P., Ska, B., & Kahn, H. J. (1994), Is there a decline in picture naming with advancing age?, Journal of Speech and Hearing Research, 37, 629-644) and in the production of a target word given its definition and initial letter, or given its initial letter and general semantic category (McCrae, R. R., Arenberg, D., & Costa, P. T. (1987), Declines in divergent thinking with age: Cross-sectional, longitudinal, and cross-sequential analyses, Psychology and Aging, 2, 130-137).

Older adults rated word finding failures and tip of the tongue experiences (TOTs) as cognitive problems that are both most severe and most affected by aging (Rabbitt, P., Maylor, E., McInnes, L., Bent, N., & Moore, B. (1995), What goods can self-assessment questionnaires deliver for cognitive gerontology?, Applied Cognitive Psychology, 9, S127-S152; Ryan, E. B., See, S. K., Meneer, W. B., & Trovato, D. (1994), Age-based perceptions of conversational skills among younger and older adults, In M. L. Hummert, J. M. Wiemann, & J. N. Nussbaum (Eds.) Interpersonal communication in older adulthood (pp. 15-39). Thousand Oaks, Calif.: Sage Publications; and Sunderland, A., Watts, K., Baddeley, A. D., & Harris, J. E. (1986), Subjective memory assessment and test performance in the elderly, Journal of Gerontology, 41, 376-384). Older adults rated retrieval failures for proper names as especially common (Cohen, G., & Faulkner, D. (1984), Memory in old age: “good in parts” New Scientist, 11, 49-51; Martin, M. (1986); Ageing and patterns of change in everyday memory and cognition, Human Learning, 5, 63-74; and Ryan, E. B. (1992), Beliefs about memory changes across the adult life span, Journal of Gerontology: Psychological Sciences, 47, P41-P46) and the most annoying, embarrassing and irritating of their memory problems (Lovelace, E. A., & Twohig, P. T. (1990), Healthy older adults' perceptions of their memory functioning and use of mnemonics, Bulletin of the Psychonomic Society, 28, 115-118). They also produce more ambiguous references and pronouns in their speech, apparently because of an inability to retrieve the appropriate nouns (Cooper, P. V. (1990), Discourse production and normal aging: Performance on oral picture description tasks, Journal of Gerontology: Psychological Sciences, 45, P210-214; and Heller, R. B., & Dobbs, A. R. (1993), Age differences in word finding in discourse and nondiscourse situations, Psychology and Aging, 8, 443-450). Speech disfluencies, such as filled pauses and hesitations, increase with age and may likewise reflect word retrieval difficulties (Cooper, P. V. (1990), Discourse production and normal aging: Performance on oral picture description tasks, Journal of Gerontology: Psychological Sciences, 45, P210-214; and Kemper, S. (1992a), Adults' sentence fragments: Who, what, when, where, and why, Communication Research, 19, 444-458).

Further, TOT states increase with aging, accounting for one of the most dramatic instances of word finding difficulty in which a person is unable to produce a word although absolutely certain that they know it. Both naturally occurring TOTs (Burke, D. M., MacKay, D. G., Worthley, J. S., & Wade, E. (1991), On the tip of the tongue: What causes word finding failures in young and older adults, Journal of Memory and Language, 30, 542-579) and experimentally induced TOTs increase with aging (Burke, D. M., MacKay, D. G., Worthley, J. S., & Wade, E. (1991), On the tip of the tongue: What causes word finding failures in young and older adults, Journal of Memory and Language, 30, 542-579; Brown, A. S., & Nix, L. A. (1996), Age-related changes in the tip-of-the-tongue experience, American Journal of Psychology, 109, 79-91; James, L. E., & Burke, D. M. (2000), Phonological priming effects on word retrieval and tip-of-the-tongue experiences in young and older adults, Journal of Experimental Psychology: Learning. Memory, and Cognition, 26, 1378-1391; Maylor, E. A. (1990b), Recognizing and naming faces: Aging, memory retrieval and the tip of the tongue state, Journal of Gerontology: Psychological Sciences, 45, P215-P225; and Rastle, K. G., & Burke, D. M. (1996), Priming the tip of the tongue: Effects of prior processing on word retrieval in young and older adults, Journal of Memory and Language, 35, 586-605).

Still, word retrieval failures in young and especially older adults appear to reflect declines in access to phonological representations. Evidence for age-linked declines in language production has come almost exclusively from studies of word retrieval. MacKay and Abrams reported that older adults made certain types of spelling errors more frequently than young adults in written production, a sub-lexical retrieval deficit involving orthographic units (MacKay, D. G., Abrams, L., & Pedroza, M. J. (1999), Aging on the input versus output side: Theoretical implications of age-linked asymmetries between detecting versus retrieving orthographic information, Psychology and Aging, 14, 3-17). This decline occurred despite age equivalence in the ability to detect spelling errors and despite the higher vocabulary and education levels of older adults. The phonological/orthographic knowledge retrieval problem in old age is not due to deficits in formulating the idea to be expressed, but rather it appears to reflect an inability to map a well-defined idea or lexical concept onto its phonological and orthographic unit forms. Thus, unlike semantic comprehension of word meaning, which seems to be well-preserved in old age, sensory-motor retrieval of phonological and orthographic representations declines with aging.

### Language Production Deficits in Normal Aging and Open-Bigrams and Open Proto-Bigrams Priming

The teachings of the present invention are in agreement with some of the mechanisms and predictions of the transmission deficit hypothesis (TDH) computational model (Burke, D. M., Mackay, D. G., & James L. E. (2000), Theoretical approaches to language and aging, In T. J. Perfect & E. A. Maylor (Eds.), Models of cognitive aging (pp. 204-237). Oxford, England: Oxford University Press; and MacKay, D. G., & Burke, D. M. (1990), Cognition and aging: A theory of new learning and the use of old connections, In T. M. Hess (Ed.), Aging and cognition: Knowledge organization and utilization (pp. 213-263). Amsterdam: North Holland). Briefly, under the TDH, verbal information is represented in a network of interconnected units or nodes organized into a semantic system representing lexical and propositional meaning and a phonological system representing sounds. In addition to these nodes, there is a system of orthographic nodes with direct links to lexical nodes and also lateral links to corresponding phonological nodes (necessary for the production of novel words and pseudowords). In the TDH, language word comprehension (input) versus word production (output) differences arise from an asymmetrical structure of top-down versus bottom-up priming connections to the respective nodes.

In general, the present invention stipulates that normal aging weakens the priming effects of open-bigrams in words, particularly open proto-bigrams inside words and in between words in a sentence or fluent speech. This weakening priming effect of open proto-bigrams negatively impacts the direct lexical to semantics access route for automatically knowing the most common words in a language, and in particular, causes slow, non-accurate (spelling mistakes) recognition and retrieval of the orthographic code via writing and typing as well as slow, non-accurate (errors) or TOT of phonological and lexical information concerning particular types of naming word retrievals from speech. It is worth noticing that with aging, this priming weakening effect of open-bigrams and open proto-bigrams greatly diminishes the benefits of possessing a language with a high lexical-phonological information and lexical orthographic code representation redundancy. Therefore, it is to be expected that older individuals will increase content production errors in written-spoken messages, making phonological and lexical information via speech naming retrieval, and/or lexical orthographic production via writing, less resistant to noise. In other words, the early language advantage resting upon a flexible orthographic code and a flexible lexical-phonological informational encoding of speech becomes a disadvantage with aging since the orthographic or lexical-phonological code will become too flexible and prompt too many production errors.

The teachings of the present invention point out that language production deficits, particularly negatively affecting open-bigrams and open proto-bigrams when aging normally, promote an inefficient and noisy sensory-motor grounding of cognitive (top-down) fluent reasoning/intellectual abilities reflected in slow, non-accurate or wrong substitutions of ‘naming meaning’ in specific domains (e.g., names of people, places, dates, definitions, etc.) The teachings of the present invention further hypothesize that in a mild to severe progression Alzheimer's or dementia individual, language production deficits worsen and expand to also embrace wrong or non-sensory-motor grounding of cognitive (top-down) fluent reasoning/intellectual abilities thus causing a partial or complete informational disconnect/paralysis between object naming retrieval and the respective action-use domain of the retrieved object.

### A Novel Neuro-Performance Non-Pharmacological Alphabetic Language Based Technology

Without limiting the scope of the present invention, the teachings of the present invention disclose a non-pharmacological technology aiming to promote novel exercising of alphanumeric symbolic information. The present invention aims for a subject to problem solve and perform a broad spectrum of relationships among alphanumeric characters. For that purpose, direct and inverse alphabetical strings are herein presented comprising a constrained serial positioning order among the letter characters as well as randomized alphabetical strings comprising a non-constrained alphabetical serial positioning order among the letter characters. The herein presented novel exercises involve visual and/or auditory searching, identifying/recognizing, sensory-motor selecting and organizing of one or more open-bigrams and/or open proto-bigrams in order to promote fluid reasoning ability in a subject manifested in an effortless, fast and efficient problem solving of particular letter characters relationships in direct-inverse alphabetical and/or randomized alphabetical sequences. Still, the herein non-pharmacological technology, consist of novel exercising of open-bigrams and open proto-bigrams to promote: a) a strong grounding of lexical-phonological cognitive information in spoken language and of lexical orthographic unit components in writing language, b) a language neuro-prophylactic shielding against language production processing deficits in normal aging population, c) a language neuro-prophylactic shielding against language production processing deficits in MCI people, and d) a language neuro-prophylactic shielding against language production processing deficits capable of slowing down (or reversing) early mild neural degeneration cognitive adversities in Alzheimer's and dementia individuals.

Orthographic Sequential Encoded Regulated by Inputs to Oscillations within Letter Units (‘SERIOL’) Processing Model:

According to the SERIOL processing model, orthographic processing occurs at two levels-the neuronal level, and the abstract level. At the neuronal level, orthographic processing occurs progressively beginning from retinal coding (e.g., string position of letters within a string), followed by feature coding (e.g., lines, angles, curves), and finally letter coding (coding for letter nodes according to temporal neuronal firing.) At the abstract level, the coding hierarchy is (open) bigram coding (i.e., sequential ordered pairs of letters-correlated to neuronal firings according to letter nodes) followed by word coding (coding by: context units—words represented by visual factors—serial proximity of constituent letters). ((Whitney, C. (2001a), How the brain encodes the order of letters in a printed word: The SERIOL model and selective literature review, Psychonomic Bulletin and Review, 8, 221-243).

Some Statistical Aspects of Sequential Order of Letters and Letter Strings:

In the English language, in a college graduate vocabulary of about 20,000 letter strings (words), there are about only 50-60 words which obey a direct A-Z or indirect Z-A sequential incomplete alphabetical different letters serial order (e.g., direct A-Z “below” and inverse Z-A “the”). More so, about 40% of everything said, read or written in the English language consists of frequent repetitions of open proto-bigrams (e.g., is, no, if, or etc.) words in between words in written sentences or uttered words in between uttered words in a conversation. In the English language, letter trigrams frequent repetitions (e.g. “the”, ‘can’, ‘his’, ‘her’, ‘its’, etc.) constitute more than 10% of everything said, read or written.

### Methods

The definition given to the terms below is in the context of their meaning when used in the body of this application and in its claims.

The below definitions, even if explicitly referring to letters sequences, should be considered to extend into a more general form of these definitions to include numerical and alphanumerical sequences, based on predefined complete numerical and alphanumerical set arrays and a formulated meaning for pairs of non-equal and non-consecutive numbers in the predefined set array, as well as for pairs of alphanumeric characters of the predefined set array.

A “series” is defined as an orderly sequence of terms

“Serial terms” are defined as the individual components of a series.

A “serial order” is defined as a sequence of terms characterized by: (a) the relative ordinal spatial position of each term and the relative ordinal spatial positions of those terms following and/or preceding it; (b) its sequential structure: an “indefinite serial order,” is defined as a serial order where no first neither last term are predefined; an “open serial order.” is defined as a serial order where only the first term is predefined; a “closed serial order,” is defined as a serial order where only the first and last terms are predefined; and (c) its number of terms, as only predefined in ‘a closed serial order’.

“Terms” are represented by one or more symbols or letters, or numbers or alphanumeric symbols.

“Arrays” are defined as the indefinite serial order of terms. By default, the total number and kind of terms are undefined.

“Terms arrays” are defined as open serial orders of terms. By default, the total number and kind of terms are undefined.

“Set arrays” are defined as closed serial orders of terms, wherein each term is intrinsically a different member of the set and where the kinds of terms, if not specified in advance, are undefined. If, by default, the total number of terms is not predefined by the method(s) herein, the total number of terms is undefined.

“Letter set arrays” are defined as closed serial orders of letters, wherein same letters may be repeated.

An “alphabetic set array” is a closed serial order of letters, wherein all the letters are predefined to be different (not repeated). Still, each letter member of an alphabetic set array has a predefined different ordinal position in the alphabetic set array. An alphabetic set array is herein considered to be a Complete Non-Randomized alphabetical letters sequence. Letter symbol members are herein only graphically represented with capital letters. For single letter symbol members, the following complete 3 direct and 3 inverse alphabetic set arrays are herein defined:

Direct alphabetic set array: A, B, C, D, E, F, G, H, I, J, K, L, M, N, O, P, Q, R, S, T, U, V, W, X, Y, Z.

Inverse alphabetic set array: Z, Y, X, W, V, U, T, S, R, Q, P, O, N, M, L, K, J, I, H, G, F, E, D, C, B, A.

Direct type alphabetic set array: A, Z, B, Y, C, X, D, W, E, V, F, U, G, T, H, S, I, R, J, Q, K, P, L, O, M, N.

Inverse type alphabetic set array: Z, A, Y, B, X, C, W, D, V, E, U, F, T, G, S, H, R, I, Q, J, P, K, O, L, N, M.

Central type alphabetic set array: A, N, B, O, C, P, D, Q, E, R, F, S, G, T, H, U, I, V, J, W, K, X, L, Y, M, Z.

Inverse central type alphabetic set array: N, A, O, B, P, C, Q, D, R, E, S, F, T, G, U, H, V, I, W, J, X, K, Y, L, Z, M.

An “open bigram,” if not specified otherwise, is herein defined as a closed serial order formed by any two contiguous or non-contiguous letters of the above alphabetic set arrays. Under the provisions set forth above, an “open bigram” may also refer to pairs of numerical or alpha-numerical symbols.

For Alphabetic Set Arrays where the Members are Defined as Open Bigrams, the Following 3 Direct and 3 Inverse Alphabetic Open Bigrams Set Arrays are Herein Defined

Direct alphabetic open bigram set array: AB, CD, EF, GH, IJ, KL, MN, OP, QR, ST, UV, WX, YZ.

Inverse alphabetic open bigram set array: ZY, XW, VU, TS, RQ, PO, NM, LK, JI, HG, FE, DC, BA.

Direct alphabetic type open bigram set array: AZ, BY, CX, DW, EV, FU, GT, HS, IR, JQ, KP, LO, MN.

Inverse alphabetic type open bigram set array: ZA, YB, XC, WD, VE, UF, TG, SH, RI, QJ, PK, OL, NM.

Central alphabetic type open bigram set array: AN, BO, CP, DQ, ER, FS, GT, HU, IV, JW, KX, LY, MZ.

Inverse alphabetic central type open bigram set array: NA, OB, PC, QD, RE, SF, TG, UH, VI, WJ, XK, YL, ZM.

An “open bigram term” is a lexical orthographic unit characterized by a pair of letters (n-gram) depicting a minimal sequential order consisting of two letters. The open bigram class to which an open bigram term belongs may or may not convey an automatic direct access to semantic meaning in an alphabetic language to a reader.

An “open bigram term sequence” is a letters symbol sequence, where two letter symbols are presented as letter pairs representing a term in the sequence, instead of an individual letter symbol representing a term in the sequence.

There are 4 classes of Open Bigram terms, there being a total of 676 different open bigram terms in the English alphabetical language

Class I—Within the context of the present subject matter, Class I always refers to “open proto-bigram terms”. Specifically, there are 24 open proto-bigram terms in the English alphabetical language.

Class II—Within the context of the present subject matter, Class II consists of open bigram terms entailed in alphabetic open bigram set arrays (6 of these alphabetic open bigram set arrays are herein defined for the English alphabetical language). Specifically, Class II comprises a total of 78 different open bigram terms wherein 2 open bigram terms are also open bigram terms members of Class I.

Class III—Within the context of the present subject matter, Class III entails the vast majority of open bigram terms in the English alphabetical language except for all open bigram terms members of Classes I, II, and IV. Specifically, Class III comprises a total of 550 open bigram terms.

Class IV—Within the context of the present subject matter, Class IV consists of open bigram terms entailing repeated single letters symbols. For the English alphabetical language, Class IV comprises a total of 26 open bigram terms.

An alphabetic “open proto-bigram term” (see Class I above) is defined as a lexical orthographic unit characterized by a pair of letters (n-gram) depicting the smallest sequential order of contiguous and non-contiguous different letters that convey an automatic direct access to semantic meaning in an alphabetical language (e.g., English alphabetical language: an, to, so etc.).

An “open proto-bigram sequence type” is herein defined as a complete alphabetic open proto-bigram sequence characterized by the pairs of letters comprising each open proto-bigram term in a way that the serial distribution of such open proto-bigram terms establishes a sequence of open proto-bigram terms type that follows a direct or an inverse alphabetic set array order. In summary, there are two complete alphabetic open proto-bigram sequence types.

Types of Open Proto-Bigram Sequences:

Direct type open proto-bigram sequence: AM, AN, AS, AT, BE, BY, DO, GO, IN, IS, IT, MY, NO, OR

Inverse type open proto-bigram sequence: WE, US, UP, TO, SO, ON, OF, ME, IF, HE. “Complete alphabetic open proto-bigram sequence groups” within the context of the present subject matter, Class I open-proto bigram terms, are further grouped in three sequence groups:

Open Proto-Bigram Sequence Groups:

Left Group: AM, BE, HE, IF, ME

Central Group: AN, AS, AT, BY, DO, GO, IN, IS, IT, MY, OF, WE

Right Group: NO, ON, OR, SO, TO, UP, US

The term “collective critical space” is defined as the alphabetic space in between two non-contiguous ordinal positions of a direct or inverse alphabetic set array. A “collective critical space” further corresponds to any two non-contiguous letters which form an open proto-bigram term. The postulation of a “collective critical space” is herein contingent to any pair of non-contiguous letter symbols in a direct or inverse alphabetic set array, where their orthographic form directly and automatically conveys a semantic meaning to the subject.

The term “virtual sequential state” is herein defined as an implicit incomplete alphabetic sequence made-up of the letters corresponding to the ordinal positions entailed in a “collective critical space”. There is at least one implicit incomplete alphabetic sequence entailed per each open proto-bigram term. These implicit incomplete alphabetic sequences are herein conceptualized to exist in a virtual perceptual-cognitive mental state of the subject. Every time that this virtual perceptual-cognitive mental state is grounded by means of a programmed goal oriented sensory-motor activity in the subject, his/her reasoning and mental cognitive ability is enhanced.

From the above definitions, it follows that a letters sequence, which at least entails two non-contiguous letters forming an open proto-bigram term, will possess a “collective critical spatial perceptual related attribute” as a direct consequence of the implicit perceptual condition of the at least one incomplete alphabetic sequence arising from the “virtual sequential state” in correspondence with the open proto-bigram term This virtual/abstract serial state becomes concrete every time a subject is required to reason and perform goal oriented sensory motor action to problem solve a particular kind of serial order involving relationships among alphabetic symbols in a sequence of symbols. One way of promoting this novel reasoning ability is achieved through a predefined goal oriented sensory motor activity of the subject by performing a data “compression” of a selected letters sequence or by performing a data “expansion” of a selected letters sequence in accordance with the definitions of the terms given below.

Moreover, as already indicated above for a general form of these definitions, for a predefined Complete Numerical Set Array and a predefined Complete Alphanumeric Set Array, the “collective critical space”, “virtual sequential state” and “collective critical spatial perceptual related attribute” for alphabetic series can also be extended to include numerical and alphanumerical series.

An “ordinal position” is defined as the relative position of a term in a series, in relation to the first term of this series, which will have an ordinal position defined by the first integer number (#1), and each of the following terms in the sequence with the following integer numbers (#2, #3, #4, . . . ) Therefore, the 26 different letter terms of the English alphabet will have 26 different ordinal positions which, in the case of the direct alphabetic set array (see above), ordinal position #1 will correspond to the letter “A”, and ordinal position #26 will correspond to the letter “Z”.

An “alphabetic letter sequence,” unless otherwise specified, is herein one or more complete alphabetic letter sequences from the group comprising: Direct alphabetic set array, Inverse alphabetic set array, Direct open bigram set array, Inverse open bigram set array, Direct open proto-bigram sequence, and Inverse open proto-bigram sequence.

The term “incomplete” serial order refers herein only in relation to a serial order which has been previously defined as “complete.”

As used herein, the term “relative incompleteness” is used in relation to any previously selected serial order which, for the sake of the intended task herein required performing by a subject, the said selected serial order could be considered to be complete.

As used herein, the term “absolute incompleteness” is used only in relation to alphabetic set arrays, because they are defined as complete closed serial orders of terms (see above). For example, in relation to an alphabetic set array, incompleteness is absolute, involving at the same time: number of missing letters, type of missing letters and ordinal positions of missing letters.

A “non-alphabetic letter sequence” is defined as any letter series that does not follow the sequence and/or ordinal positions of letters in any of the alphabetic set arrays.

A “symbol” is defined as a mental abstract graphical sign/representation, which includes letters and numbers.

A “letter term” is defined as a mental abstract graphical sign/representation, which is generally, characterized by not representing a concrete: thing/item/form/shape in the physical world. Different languages may use the same graphical sign/representation depicting a particular letter term, which it is also phonologically uttered with the same sound (like “s”).

A “letter symbol” is defined as a graphical sign/representation depicting in a language a letter term with a specific phonological uttered sound. In the same language, different graphical sign/representation depicting a particular letter term, are phonologically uttered with the same sound(s) (like “a” and “A”).

An “attribute” of a term (alphanumeric symbol, letter, or number) is defined as a spatial distinctive related perceptual feature and/or time distinctive related perceptual feature. An attribute of a term can also be understood as a related on-line perceptual representation carried through a mental simulation that effects the off-line conception of what has been perceived (Louise Connell, Dermot Lynott. Principles of Representation: Why You Can't Represent the Same Concept Twice. Topics in Cognitive Science (2014) 1-17)

A “spatial related perceptual attribute” is defined as a characteristically spatial related perceptual feature of a term, which can be discriminated by sensorial perception. There are two kinds of spatial related perceptual attributes.

An “individual spatial related attribute” is defined as a spatial related perceptual attribute that pertains to a particular term. Individual spatial related perceptual attributes include, e.g., symbol case; symbol size; symbol font; symbol boldness; symbol tilted angle in relation to a horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

A “collective spatial related attribute” is defined as a spatial related perceptual attribute that pertains to the relative location of a particular term in relation to the other terms in a letter set array, an alphabetic set array, or an alphabetic letter symbol sequence. Collective spatial related attributes (e.g. in a set array) include a symbol ordinal position, the physical space occupied by a symbol font, the distance between the physical spaces occupied by the fonts of two consecutive symbols/terms when represented in orthographical form, and left or right relative edge position of a term/symbol font in a set array. Even if triggering a sensorial perceptual relation with the reasoning subject, a “collective spatial related perceptual attribute” is not related to the semantic meaning of the one or more letter symbols possessing this spatial perceptual related attribute. In contrast, the “collective critical space” is contingent on the generation of a semantic meaning in a subject by the pair of non-contiguous letter symbols implicitly entailing this collective critical space.

A “time related perceptual attribute” is defined as a characteristically temporal related perceptual feature of a term (symbol, letter or number), which can be discriminated by sensorial perception such as: a) any color of the RGB full color range of the symbols term; b) frequency range for the intermittent display of a symbol, of a letter or of a number, from a very low frequency rate, up till a high frequency (flickering) rate. Frequency is quantified as: 1/t, where t is in the order of seconds of time; c) particular sound frequencies by which a letter or a number is recognized by the auditory perception of a subject; and d) any herein particular constant motion represented by a constant velocity/constant speed (V) at which symbols, letters, and/or numbers move across the visual or auditory field of a subject. In the case of Doppler auditory field effect, where sounds representing the names of alphanumeric symbols, letters, and/or numbers are approximating or moving away in relation to a predefined point in the perceptual space of a subject, constant motion is herein represented by the speed of sound. By default, this constant motion of symbols, letters, and/or numbers is herein considered to take place along a horizontal axis, in a spatial direction to be predefined. If the visual perception of constant motion is implemented on a computer screen, the value of V to be assigned is given in pixels per second at a predefined screen resolution.

It has been empirically observed that when the first and last letter symbols of a word are maintained, the reader's semantic meaning of the word may not be altered or lost by removing one or more letters in between them. This orthographic transformation is named data “compression”. Consistent with this empirical observation, the notion of data “compression” is herein extended into the following definitions:

If a “symbols sequence is subject to compression” which is characterized by the removal of one or more contiguous symbols located in between two predefined symbols in the sequence of symbols, the two predefined symbols may, at the end of the compression process, become contiguous symbols in the symbols sequence, or remain non-contiguous if the omission or removal of symbols is done on non-contiguous symbols located between the two predefined symbols in the sequence.

Due to the intrinsic semantic meaning carried by an open proto-bigram term, when the two predefined symbols in a sequence of symbols are the two letters symbols forming an open proto-bigram term, the compression of a letter sequence is considered to take place at two sequential levels, “local” and “non-local”, and the non-local sequential level comprises an “extraordinary sequential compression case.”

A “local open proto-bigram term compression” is characterized by the omission or removal of one or two contiguous letters in a sequence of letters lying in between the two letters that form/assemble an open proto-bigram term, by which the two letters of the open proto-bigram term become contiguous letters in the letters sequence.

A “non-local open proto-bigram compression” is characterized by the omission or removal of more than two contiguous letters in a sequence of letters, lying in between two letters at any ordinal serial position in the sequence that form an open proto-bigram term, by which the two letters of the open proto-bigram term become contiguous letters in the letters sequence.

An “extraordinary non-local open proto-bigram compression” is a particular case of a non-local open proto-bigram term compression, which occurs in a letters sequence comprising N letters when the first and last letters in the letters sequence are the two selected letters forming/assembling an open proto-bigram term, and the N−2 letters lying in between are omitted or removed, by which the remaining two letters forming/assembling the open proto-bigram term become contiguous letters.

An “alphabetic expansion” of an open proto-bigram term is defined as the orthographic separation of its two (alphabetical non-contiguous letters) letters by the serial sensory motor insertion of the corresponding incomplete alphabetic sequence directly related to its collective critical space according to predefined timings. This sensory motor ‘alphabetic expansion’ will explicitly make the particular related virtual sequential state entailed in the collective critical space of this open proto-bigram term concrete.

“Orthographic letters contiguity” is defined as the contiguity of letters symbols in a written form by which words are represented in most written alphabetical languages.

For “alphabetic contiguity,” a visual recognition facilitation effect occurs for a pair of letters forming any open bigram term, even when 1 or 2 letters in orthographic contiguity lying in between these two (now) edge letters form the open bigram term. It has been empirically confirmed that up to 2 letters located contiguously in between the open bigram term do not interfere with the visual identity and resulting perceptual recognition process of the pair of letters making-up the open bigram term. In other words, the visual perceptual identity of an open bigram term (letter pair) remains intact even in the case of up two letters held in between these two edge letters forming the open bigram term.

However, in the particular case where open bigram terms orthographically directly convey/communicate a semantic meaning in a language (e.g., open proto-bigrams), it is herein considered that the visual perceptual identity of open proto-bigram terms remains intact even when more than 2 letters are held in between the now edge letters forming the open proto-bigram term. This particular visual perceptual recognition effect is considered as an expression of: 1) a Local Alphabetic Contiguity effect—empirically manifested when up to two letters are held in between (LAC) for open bigrams and open proto-bigrams terms and 2) a Non-Local Alphabetic Contiguity (NLAC) effect—empirically manifested when more than two letters are held in between, an effect which only take place in open proto-bigrams terms.

Both LAC and NLAC are part of a herein novel methodology aiming to advance a flexible orthographic decoding and processing view concerning sensory motor grounding of perceptual-cognitive alphabetical, numerical, and alphanumeric information/knowledge. LAC correlates to the already known priming transposition of letters phenomena, and NLAC is a new proposition concerning the visual perceptual recognition property particularly possessed only by open proto-bigrams terms which is enhanced by the performance of the herein proposed methods. For the 24 open proto-bigram terms found in the English language alphabet, 7 open proto-bigram terms are of a default LAC consisting of 0 to 2 in between ordinal positions of letters in the alphabetic direct-inverse set array because of their unique respective intrinsic serial order position in the alphabet. The remaining 17 open proto-bigrams terms are of a default NLAC consisting of an average of more than 10 letters held in between ordinal positions in the alphabetic direct-inverse set array.

The present subject matter considers the phenomena of ‘alphabetic contiguity’ being a particular top-down cognitive-perceptual mechanism that effortlessly and autonomously causes arousal inhibition in the visual perception process for detecting, processing, and encoding the N letters held in between the 2 edge letters forming an open proto-bigram term, thus resulting in maximal data compression of the letters sequence. As a consequence of the alphabetic contiguity orthographic phenomena, the space held in between any 2 non-contiguous letters forming an open proto-bigram term in the alphabet is of a critical perceptual related nature, herein designated as a ‘Collective Critical Space Perceptual Related Attribute’ (CCSPRA) of the open proto-bigram term, wherein the letters sequence which is attentionally ignored-inhibited, should be conceptualized as if existing in a virtual mental kind of state. This virtual mental kind of state will remain effective even if the 2 letters making-up the open proto-bigram term will be in orthographic contiguity (maximal serial data compression).

When the 2 letters forming an open proto-bigram term hold in between a number of N letters and when the serial ordinal position of these two letters are the serial position of the edge letters of a letters sequence (meaning that there are no additional letters on either side of these two edge letters), the alphabetic contiguity property will only pertain to these 2 edge letters forming the open proto-bigram term. In brief, this particular case discloses the strongest manifestation of the alphabetic contiguity property, where one of the letters making up an open proto-bigram term is the head and the other letter is the tail of a letters sequence. This particular case is herein designated as Extraordinary NLAC.

An “arrangement of terms” (symbols, letters and/or numbers) is defined as one of two classes of term arrangements, i.e., an arrangement of terms along a line, or an arrangement of terms in a matrix form. In an “arrangement along a line,” terms will be arranged along a horizontal line by default. If for example, the arrangement of terms is meant to be along a vertical or diagonal or curvilinear line, it will be indicated. In an “arrangement in a matrix form,” terms are arranged along a number of parallel horizontal lines (like letters arrangement in a text book format), displayed in a two dimensional format.

The terms “generation of terms,” “number of terms generated” (symbols, letters and/or numbers) is defined as terms generally generated by two kinds of term generation methods—one method wherein the number of terms is generated in a predefined quantity; and another method wherein the number of terms is generated by a quasi-random method.

It is important to point out/consider that, in the above method of promoting reasoning abilities and in the following exercises and examples implementing the method, the subject is performing the discrimination of open bigrams in an array/series of open bigram sequences without invoking explicit conscious awareness concerning underlying implicit governing rules or abstract concepts/interrelationships, characterized by relations or correlations or cross-correlations among the searched, discriminated and sensory motor manipulated open bigram terms by the subject. In other words, the subject is performing the search and discrimination without overtly thinking or strategizing about the necessary actions to effectively accomplish the sensory motor manipulation of the open bigram terms.

As mentioned in connection with the general form of the above definitions, the herein presented suite of exercises can make use of not only letters but also numbers and alphanumeric symbols relationships. These relationships include correlations and cross-correlations among open bigram terms such that the mental ability of the exercising subject is able to promote novel reasoning strategies that improve fluid intelligence abilities. The improved fluid intelligence abilities will be manifested in at least effective and rapid mental simulation, novel problem solving, drawing inductive-deductive inferences, pattern and irregularities recognition, identifying relations, correlations and cross-correlations among sequential orders of symbols comprehending implications, extrapolating, transforming information and abstract concept thinking.

As mentioned earlier, it is also important to consider that the methods described herein are not limited to only alphabetic symbols. It is also contemplated that the methods of the present subject can involve numeric serial orders and/or alpha-numeric serial orders to be used within the exercises. In other words, while the specific examples set forth employ serial orders of letter symbols and alphabetic open-bigram terms, it is contemplated that serial orders comprising numbers and/or alpha-numeric symbols can be used.

A library of open-bigram sequences comprises those obtained with letter symbols from alphabetic set arrays, which may include open-bigram sequences derived from other set arrays (of numerical or alphanumerical symbols). Alphabetic set arrays are characterized by comprising a predefined number of different letter terms, each letter term having a predefined unique ordinal position in the closed set array, and none of said different letter terms are repeated within this predefined unique serial order of letter terms. A non-limiting example of a unique letter set array is the English alphabet, in which there are 13 predefined different open-bigram terms where each open-bigram term has a predefined consecutive ordinal position of a unique closed serial order among 13 different members of an open-bigram set array only comprising 13 members.

In one aspect of the present subject matter, a predefined library of complete alphabetic open-bigrams sequences is herein considered. The English alphabet is herein considered as a direct alphabetic set array, from which only one unique serial order of open-bigram terms is obtained. There are at least five other different unique alphabetic set arrays herein considered. As mentioned above, the English alphabet is a particular alphabetic set array herein denominated as a direct alphabetic set array. There are other five different alphabetic set arrays contemplated from which another five unique alphabetic open-bigram set arrays are obtained, denominated herein as: inverse alphabetic open-bigram set array, direct type of alphabetic open-bigram set array, inverse type of alphabetic open-bigram set array, central type of alphabetic open-bigram set array, and inverse central type alphabetic open-bigram set array. It is understood that the above predefined library of open-bigram terms sequences may contain fewer open-bigram terms sequences than those listed above or that it may comprise more different open-bigram sequences.

In an aspect of the present methods, the at least one unique serial order comprises a sequence of open-bigram terms. In this aspect of the present subject matter, the predefined library of open-bigram sequences may comprise the following sequential orders of open-bigrams terms, where each open-bigram term is a different member of a set array having a predefined unique ordinal position within the set: direct open-bigram set array, inverse open-bigram set array, direct type open-bigram set array, inverse type open-bigram set array, central type open-bigram set array, and inverse central type open-bigram set array. It is understood that the above predefined library of open-bigram sequences may contain additional or fewer open-bigram sequences than those listed above.

In each of the non-limiting Examples below, the subject is presented with various exercises and prompted to make selections based upon the particular features of the exercises. It is contemplated that, within the non-limiting Examples, the choice method presented to the subject could be any one of three particular non-limiting choice methods: multiple choice, force choice, and/or go-no-go choice.

When the subject is provided with multiple choices when performing the exercise, the subject is presented multiple choices as to what the possible answer is. The subject must discern the correct answer/selection and select the correct answer from the given multiple choices.

When the force choice method is employed within the exercises, the subject is presented with two alternatives for the correct answer and, as is implicit in the name, the subject is forced to make that choice. In other words, the subject is forced to select the correct answer from the two possible answers presented to the subject.

Likewise, a choice method presented to the subject is a go-no-go choice method. In this method, the subject is prompted to answer every time the subject is exposed to the possible correct answer. In a non-limiting example, the subject may be requested to click or not on a particular button each time a certain open-bigram term is shown to the subject. Alternatively, the subject may be requested to click on one of two different buttons each time another certain open-bigram term is displayed. Thus, the subject clicks on one of the two buttons when his/her reasoning indicates that the correct open-bigram term appears and does not click on the other button if his/her reasoning indicates that the correct open-bigram term is not there.

In another aspect of the each of the non-limiting examples described herein, the change in the spatial and/or time perceptual related attributes of the open-bigrams is done according to predefined correlations between these attributes and the ordinal position of the open-bigram terms in the provided sequence. As a non-limiting example, for the particular case of a complete direct alphabetic set array of the English language falling inside the perceptual visual field of the subject, the first ordinal position (occupied by the letter “A”), will generally appear towards the left side of his/her fields of vision, whereas the last ordinal position (occupied by the letter “Z”) will appear towards his/her right visual field of vision. Further, if the ordinal position of the open-bigram term for which an attribute will be changed falls in the left field of vision, the change in attribute may be different than if the ordinal position of the open-bigram term for which the attribute will be changed falls in the right field of vision.

In this non-limiting example, if the attribute to be changed is the color of the open-bigram term, and if the ordinal position of the open-bigram term for which the attribute will be changed falls in the left field of vision, then the color will be changed to a first different color, while if the ordinal position of the open-bigram term falls in the right field of vision, then the color will be changed to a second color different from the first color. Likewise, if the attribute to be changed is the size of the open-bigram term being displayed, then those open-bigram terms with an ordinal position falling in the left field of vision will be changed to a first different size, while the open-bigram terms with an ordinal position falling in the right field of vision will be changed to a second different size that is also different than the first different size.

The present subject matter is further described in the following non-limiting examples.

### Example 1

### Reorganizing Ordinal Positions of Different Open-Bigram Terms in a Randomized Open-Bigrams Sequence in Order to Obtain a Predefined Non-Random Complete Alphabetical Serial Order of Different Open-Bigram Terms

In the present exercises of Example 1, the subject is required to gradually change the serial order position of a number of different open-bigram terms in a provided randomized serial order of different open-bigram terms. To that effect, the subject is required to serially sensorially discriminate, sensory motor select, and gradually reorganize the serial order positions of at least three different open-bigram terms in a randomized sequence of different open-bigram terms within a predetermined time frame. The gradual ordinal repositioning of the serially sensorially discriminated and sensory motor selected different open-bigram terms into the correct serial order places in order to obtain a complete alphabetical serial order of different open-bigram terms represents the main operational goal of the present Example. Still, the present exercises require a gradual serial order sensory motor repositioning of different open-bigram terms appearing in a randomized sequence. In a particular embodiment of the present Examples, the subject's goal is to attain a complete non-randomized direct alphabetical (A-Z) or complete non-randomized inverse alphabetical (Z-A) open-bigrams sequence.

Example 1 entails three consecutive block exercises comprising 2 trial exercises to be performed in each block exercise. In one embodiment for each of the two trial exercises of each block exercise, a serial order comprising 13 different open-bigram terms, where each open-bigram term is formed by 2 consecutive letter symbols of an alphabetic set array (comprising the 26 letter symbols of the English alphabet), is randomized into an open-bigrams sequence. In an aspect of this Example, these 13 different open-bigram terms can be generated, out of an alphabetical serial order, via a quasi-random algorithm by using computer software.

In the first block exercise, the subject is prompted to successfully serially sensorially discriminate, sensory motor select, and reorganize a number of different open-bigram terms in a presented quasi-randomized sequence of different open-bigram terms to obtain a complete non-randomized direct alphabetical (A-Z) or a complete non-randomized inverse alphabetical (Z-A) open-bigrams sequence. A complete serial order of different open-bigram terms possessing a non-randomized direct alphabetical (A-Z) or a complete non-randomized inverse alphabetical (Z-A) sequential order is presented to the subject in the form of a ruler with the randomized sequence of different open-bigram terms. This particular complete direct or inverse alphabetical different open-bigrams sequence aids the subject to effectively serially visually search and rapidly sensorially recognize misplaced different open-bigram terms in the provided randomized sequence of different open-bigram terms., This allows the subject to rapidly sensory motor select and reorganize the misplaced different open-bigram terms in the randomized sequence into their correct ordinal positions to form a complete direct or inverse alphabetical open-bigrams sequence.

However, in a non-limiting variation of this example, in the second and third block exercises, a number of strategies are implemented that, in some degree, will momentarily hold the subject back from attaining the goal of the present Example. For example, a randomized sequence of different open-bigram terms entailing the 26 letter symbols of the English alphabet may be provided in a ruler displayed together with the randomized sequence of different open-bigram terms which the subject is required to serially sensory motor reorganize. Since the ordinal positions of the different open-bigrams terms also in both sequences have been randomized in this particular strategy, it should not be expected that the randomized different open-bigrams sequence displayed in the ruler will be of much help to the subject. Additional strategies that employ different constraints to make the implementation of the present Example more challenging to the subject are described below.

In the present Example, the subject is required to visually search and sensorially identify in a serial manner one or more different open-bigram terms that are serially misplaced in the provided randomized sequence of different open-bigram terms, correctly sensory motor select the misplaced open-bigram terms, and sensory motor reorganize the randomized sequence of different open-bigram terms into a completed non-random serial order of different open-bigram terms as fast as possible. In one aspect of the present Example, the completed non-random serial order of different open-bigram terms corresponds to a direct or an inverse alphabetical serial order of different open-bigram terms.

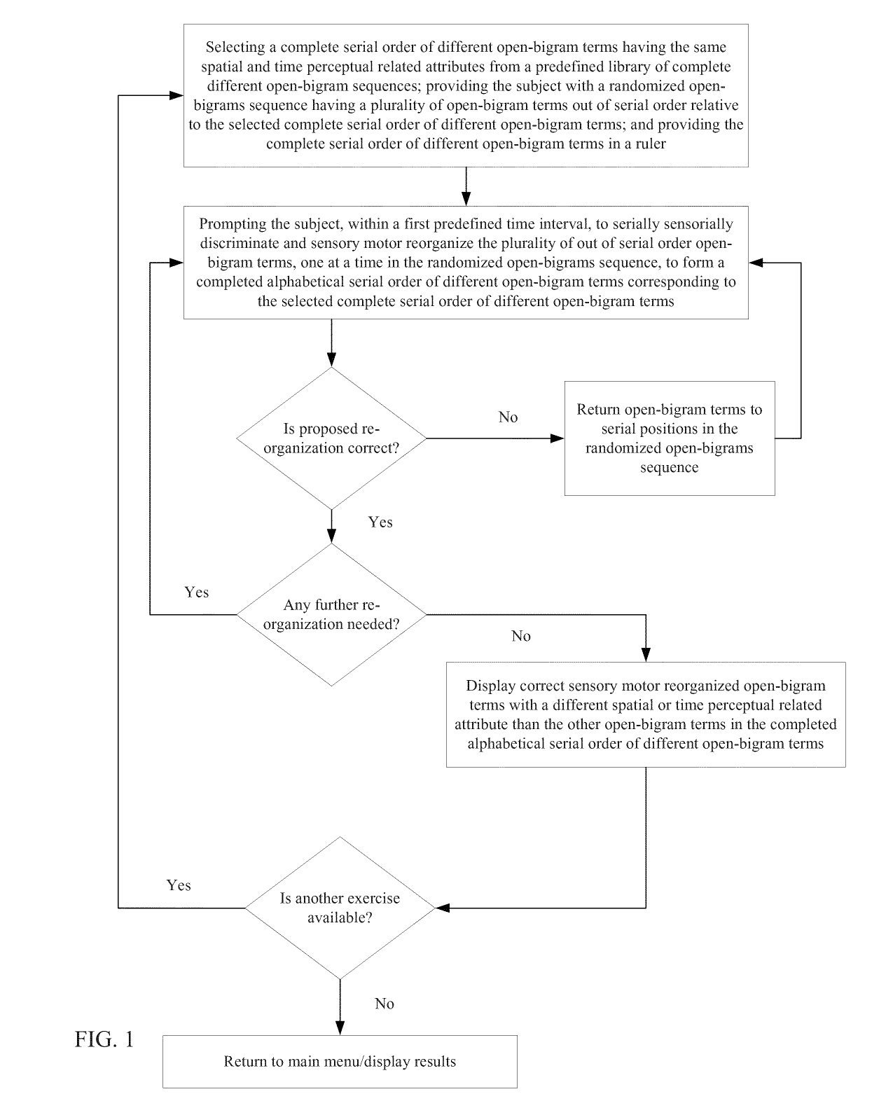

FIG. 1 is a flow chart setting forth the method that the present exercises use in promoting fluid intelligence abilities in a subject through reasoning strategies directed towards problem solving by the serial sensorial discrimination, sensory motor selection, and gradual reorganization of different open-bigram terms into a completed non-randomized open-bigrams sequence that entails a complete direct or inverse alphabetical serial order of different open-bigram terms. As can be seen in FIG. 1, the method of promoting fluid intelligence abilities in the subject comprises selecting a serial order of different open-bigram terms having the same spatial and time perceptual related attributes from a predefined library of complete alphabetic non-randomized open-bigram terms sequences. The subject is provided with a randomized sequence of different open-bigram terms from the selected complete non-randomized different open-bigrams sequence. A plurality of different open-bigram terms are in wrong ordinal positions in the provided randomized sequence of different open-bigram terms. The selected complete non-randomized different open-bigrams sequence is also provided graphically as a ruler to the subject. The subject is then prompted, within a first predefined time interval, to serially sensorially discriminate, sensory motor select, and gradually reorganize the plurality of different open-bigram terms which are out of serial order, one at a time, in the provided randomized sequence of different open-bigram terms. The result is a completed non-random alphabetical serial order of different open-bigram terms which directly matches (corresponds to) the selected complete non-randomized alphabetical serial order of different open-bigram terms.

If the proposed serial sensorial discrimination, sensory motor selection, and reorganization of a different open-bigram term is incorrect, then the open-bigram term is returned to its initial position in the randomized sequence of different open-bigram terms prior to the proposed sensory motor selection and reorganization made by the subject, and the subject is returned to the step of being prompted to serially sensorially discriminate, sensory motor select, and reorganize the provided randomized sequence of different open-bigram terms. If the proposed serial sensorial discrimination, sensory motor selection, and reorganization of a different open-bigram term is correct, but further serial sensorial discrimination, sensory motor selection, and reorganization of the provided randomized sequence of different open-bigram terms is needed to form the completed non-randomized serial order of different open-bigram terms, then the subject is again returned to the step of being prompted to serially sensorially discriminate, sensory motor select, and reorganize the provided randomized sequence of different open-bigram terms. If the proposed serial sensorial discrimination, sensory motor selection, and reorganization of a different open-bigram term is correct and the completed non-randomized serial order of different open-bigram terms is attained, then the correct sensory motor reorganized different open-bigram terms are displayed with at least one different spatial and/or time perceptual related attribute than the other open-bigram terms in the completed non-randomized serial order of different open-bigram terms.

The above steps in the method are repeated for a predetermined number of iterations separated by one or more predefined time intervals, and upon completion of the predetermined number of iterations, the subject is provided with the results of each iteration. The predetermined number of iterations can be any number needed to establish a satisfactory reasoning performance ability concerning the particular task at hand is being promoted within the subject. Non-limiting examples of number of iterations include 1, 2, 3, 4, 5, 6, and 7. However, any number of iterations can be performed, like 1 to 23.

In another aspect of Example 1, the method of promoting fluid intelligence reasoning ability in a subject is implemented through a computer program product. In particular, the subject matter in Example 1 includes a computer program product for promoting fluid intelligence reasoning ability in a subject, stored on a non-transitory computer readable medium which when executed causes a computer system to perform the method. The method executed by the computer program on the non-transitory computer readable medium comprises selecting a complete serial order of different open-bigram terms having the same spatial and time perceptual related attributes from a predefined library of complete alphabetic non-random different open-bigrams sequences. The subject is provided with a randomized sequence of different open-bigram terms from the selected complete non-random serial order of different open-bigram terms wherein a plurality of different open-bigram terms are out of serial order in comparison to the selected complete non-randomized serial order of different open-bigram terms. The selected complete alphabetical non-randomized serial order of different open-bigram terms is also graphically provided to the subject as a ruler. The subject is then prompted, within a first predefined time interval, to serially sensorially discriminate, sensory motor select, and reorganize the out of serial order open-bigram terms, one at a time, in the provided randomized serial order of different open-bigram terms, thereby forming a completed non-randomized alphabetical direct or inverse serial order of different open-bigram terms corresponding to the selected complete non-randomized serial order of different open-bigram terms.

If the proposed serial sensorial discrimination, sensory motor selection, and reorganization of a different open-bigram term is incorrect, then the open-bigram terms is automatically returned to its initial position in the provided randomized sequence of different open-bigram terms, and the subject is returned to the step of being prompted to serially sensorially discriminate, sensory motor select, and reorganize the provided randomized sequence of different open-bigram terms. If the proposed serial sensorial discrimination, sensory motor selection, and reorganization of a different open-bigram term is correct, but further serial sensorial discrimination, sensory motor selection, and reorganization is needed to form the completed non-randomized serial order of different open-bigram terms, then the subject is again returned to the step of being prompted to serially sensorially discriminate, sensory motor select, and reorganize the provided randomized sequence of different open-bigram terms. If the proposed serial sensorial discrimination, sensory motor selection, and reorganization of a different open-bigram term is correct and the completed non-randomized serial order of different open-bigram terms is formed, then each correctly sensory motor reorganized different open-bigram term is displayed with at least one different spatial and/or time perceptual related attribute than the other open-bigram terms in the completed non-randomized serial order of different open-bigram terms. The above steps in the method are repeated for a predetermined number of iterations separated by one or more predefined time intervals, and upon completion of the predetermined number of iterations, the subject is provided with the results of each iteration.

In a further aspect of Example 1, the method of promoting fluid intelligence reasoning ability in a subject is implemented through a system. The system for promoting fluid intelligence reasoning ability in a subject comprises: a computer system comprising a processor, memory, and a graphical user interface (GUI), the processor containing instructions for: selecting a serial order of different open-bigram terms having the same spatial and time perceptual related attributes from a predefined library of complete alphabetic non-randomized different open-bigrams sequences, and providing the subject on the GUI with a randomized sequence of different open-bigram terms from the selected complete non-randomized serial order of different open-bigram terms, wherein a plurality of different open-bigram terms are in the wrong ordinal positions as compared to the selected complete non-randomized serial order of different open-bigram terms, and wherein the selected complete non-randomized serial order of different open-bigram terms is provided as a ruler to the subject; prompting the subject on the GUI, within a first predefined time interval, to serially sensorially discriminate, sensory motor select, and reorganize the open-bigram terms which are in wrong ordinal positions, one at a time, to form a completed non-randomized serial order of different open-bigram terms which corresponds to the selected complete non-randomized serial order of different open-bigram terms; if the proposed serial sensorial discrimination, sensory motor selection, and reorganization of a different open-bigram term is incorrect, then returning the open-bigram term to its initial ordinal position in the provided randomized sequence of different open-bigram terms, and returning to the step of prompting the subject to serially sensorially discriminate, sensory motor select, and reorganize the open-bigram terms in the wrong ordinal positions; if the proposed serial sensorial discrimination, sensory motor selection, and reorganization of a different open-bigram term is correct, but further serial sensorial discrimination, sensory motor selection, and reorganization of the provided randomized sequence of different open-bigram terms is needed to form the completed non-randomized serial order of different open-bigram terms, then returning to the step of prompting the subject to serially sensorially discriminate, sensory motor select, and reorganize the open-bigram terms which are in the wrong ordinal positions; if the proposed serial sensorial discrimination, sensory motor selection, and reorganization of a different open-bigram term is correct and the completed non-randomized serial order of different open-bigram terms is successfully formed, then displaying each of the correctly sensory motor reorganized different open-bigram terms with at least one different spatial and/or time perceptual related attribute than the other open-bigram terms in the completed non-randomized serial order of different open-bigram terms; repeating the above steps for a predetermined number of iterations separated by one or more predefined time intervals; and upon completion of the predetermined number of iterations, providing the subject with the results of each iteration on the GUI.

In an aspect of the present exercises, the subject is prompted to serially sensorially discriminate, sensory motor select, and reorganize the provided randomized sequence of different open-bigram terms into a complete alphabetic non-randomized serial order of different open-bigram terms. For example, if the provided randomized sequence of different open-bigram terms is obtained from a complete non-randomized direct alphabetic set array, the subject is prompted to serially sensorially discriminate, sensory motor select, and reorganize the different open-bigram terms starting with the first open-bigram term, AB, of the direct alphabetical serial order of different open-bigram terms. Likewise, for a complete non-randomized inverse alphabetic set array, the subject is prompted to start the serial sensorial discrimination, sensory motor selection, and reorganization from the open-bigram term ZY.

Within the method being implemented in the exercises of Example 1, the subject is required to serially sensorially discriminate, sensory motor select, and reorganize a plurality of different open-bigram terms in the provided randomized sequence of different open-bigram terms to form a completed non-randomized serial order of different open-bigram terms. The completed non-randomized serial order of different open-bigram terms that is formed can directly match (correspond to) a direct or inverse alphabetical serial order of different open-bigram terms. In particular, when the provided randomized sequence of different open-bigram terms is obtained from a non-randomized direct alphabetical serial order of different open-bigram terms, 3-7 different open-bigram terms may need to be sensory motor selected and reorganized in the provided randomized sequence of different open-bigram terms. Examples of non-randomized direct alphabetical serial orders of different open-bigram terms include, without limitation, direct open-bigram set array, direct type open-bigram set array, and central type open-bigram set array.

Furthermore, when the provided randomized sequence of different open-bigram terms is obtained from an inverse alphabetical serial order of different open-bigram terms, 3-5 different open-bigram terms may need to be sensory motor selected and reorganized in the provided randomized sequence of different open-bigram terms. Examples of non-randomized inverse alphabetical serial orders of different open-bigram terms include, without limitation, inverse open-bigram set array, inverse type open-bigram set array, and inverse central type open-bigram set array.

In the exercises of Example 1, the subject has a given time to perform the serial sensorial discrimination, sensory motor selection, and reorganization of the different open-bigram terms to complete a non-randomized direct or inverse alphabetical serial order of different open-bigram terms. The given time period is dependent on the type of randomized sequence of different open-bigram terms provided to the subject, as well as the number of different open-bigram terms requiring sensory motor selection and reorganization. In general, when the subject is provided with a randomized sequence of different open-bigram terms from a direct or inverse alphabetic set array, the subject is given an operational time consisting of 15-45 seconds per open-bigram term needing sensory motor selection and reorganization. For example, if the subject is provided with a randomized sequence of different open-bigram terms from a selected non-randomized direct alphabetic set array, and five different open-bigram terms, which are each allotted an operational time of 30 seconds, are required to be serially sensorially discriminated, sensory motor selected, and reorganized, then the subject is given an operational time of 150 seconds to complete the exercise (5 different open-bigram terms×30 seconds per different open-bigram term). In another example, if the subject is provided with a randomized sequence of different open-bigram terms from a non-randomized inverse alphabetic set array, and three different open-bigram terms, which are each allotted an operational time of 40 seconds, are required to be serially sensorially discriminated, sensory motor selected, and reorganized, then the subject has an operational time of 120 seconds to complete the exercise (3 different open-bigram terms×40 seconds per individual different open-bigram term).

In an aspect of the exercises of Example 1, the randomized sequence of different open-bigram terms is provided to the subject such that it is, at all times, perceptually visible to the subject. In an alternative embodiment, a single different open-bigram term within the provided randomized sequence of different open-bigram terms is momentarily blocked from the sight of the subject during a given exercise. The time that the single different open-bigram term is momentarily blocked from the sight of the subject is not limited to any particular length of time. In one non-limiting example, the single different open-bigram term is randomly blocked from the sight of the subject for 1-3 seconds. It is understood that the random blocking of different open-bigram terms within the provided randomized sequence of different open-bigram terms is not intended to be performed sequentially for all of the different open-bigram terms. Instead, the random blocking function is set to skip a number of different open-bigram terms at a time when engaged.

In a further alternative embodiment of this aspect of the exercises, the entire randomized sequence of different open-bigram terms shown in the ruler is caused to flicker so as to intermittently disappear from the sight of the subject. In this embodiment, the disappearance and reappearance of the randomized sequence of different open-bigram terms in the ruler is done via a duty cycle in which the randomized sequence of different open-bigram terms is displayed to the subject for a period of time and then disappears for another period of time. In a particular non-limiting example, the period of time when the randomized sequence of different open-bigram terms is displayed to the subject is longer than the period of time when it disappears. Accordingly, the implemented duty-cycle may include a period of 15-30 seconds where the randomized sequence of different open-bigram terms is shown in the ruler, and a period of 5-10 seconds when the randomized sequence is removed from the subject's sight and not shown in the ruler. It is understood that other duty-cycles times can be selected and implemented for the execution of Example 1.

As discussed above, upon the sensory motor formation of the completed non-randomized serial order of different open-bigram terms, the correct sensory motor selected and reorganized different open-bigram terms are displayed with a different spatial and/or time perceptual related attribute than the remaining different open-bigram terms in the completed non-randomized serial order of different open-bigram terms. The changed spatial and/or time perceptual related attribute of the correct sensory motor selected and reorganized different open-bigram terms is selected from the group of spatial and time perceptual related attributes or combinations thereof. In a particular aspect, the changed spatial and/or time perceptual related attributes are selected from the group including: open-bigram term font size, open-bigram term font style, open-bigram term font spacing, open-bigram term font case, open-bigram term font boldness, open-bigram term font angle of rotation, open-bigram term font mirroring, or combinations thereof.

Other spatial perceptual related attributes of an open-bigram term that could be used to emphasize a change of the correct sensory motor selected and reorganized different open-bigram terms may be selected from the group including: open-bigram term font vertical line of symmetry, open-bigram term font horizontal line of symmetry, open-bigram term font vertical and horizontal lines of symmetry, open-bigram term font infinite lines of symmetry, and open-bigram term font with no line of symmetry. In a particular aspect, the changed time perceptual related attributes of the different open-bigram terms may be selected from the group consisting of open-bigram term font color, open-bigram term font blinking and open-bigram term sound, or combinations thereof. Furthermore, each correctly sensory motor selected and reorganized different open-bigram term may be displayed with a time perceptual related attribute font flickering behavior to further highlight differences in the spatial and time perceptual related attributes of the different open-bigram terms

It is also understood that the correct sensory motor selected and reorganized different open-bigram terms could have different spatial and/or time perceptual related attributes among themselves. In other words, one sensory motor selected and reorganized open-bigram term could be highlighted by a different open-bigram term font color, while another sensory motor selected and reorganized open-bigram term could be highlighted by a different open-bigram term font size. Alternatively, one sensory motor selected and reorganized different open-bigram term could have a changed spatial perceptual related attribute, while another sensory motor selected and reorganized different open-bigram term could have a changed time perceptual related attribute.

As previously indicated above with respect to the general methods for implementing the present subject matter, the exercises in Example 1 are useful in promoting fluid intelligence abilities in the subject by grounding root core fluid cognitive abilities through selective goal oriented motor activity that occurs when the subject performs the given exercise. That is, the serial sensorial discrimination, sensory motor selection, and reorganization of the different open-bigram terms by the subject engages goal oriented motor activity within the subject's body. The goal oriented motor activity engaged within the subject body may be any goal oriented motor activity involved in the group including: sensorial perception of the provided randomized sequence of different open-bigram terms, body movements to execute the serial sensorial search, discrimination, sensory motor selection, and reorganization of the different open-bigram terms when either all of the displayed different open-bigram terms are visible or not all of the different open-bigram terms are visible, body movements to attentionally ignore perceptual random blocking of different open-bigram terms, and combinations thereof. While any body movements can be considered goal oriented motor activity within the subject, the present subject matter is concerned with body movements selected from the group consisting of goal oriented body movements of the subject's eyes, head, neck, arms, hands, fingers and combinations thereof.

Requesting the subject to engage in specific degrees of goal oriented sensory motor activity in the exercises of Example 1 requires him/her to bodily-ground cognitive fluid intelligence abilities such as inductive reasoning as discussed above. The exercises of Example 1 cause the subject to revisit an early developmental realm where he/she implicitly performed fluid cognitive abilities specifically when problem solving the serial search and sensorial pattern recognition of non-concrete different open-bigrams terms meshing with their salient spatial-time perceptual related attributes. The established relationships between these non-concrete different open-bigram terms and their (salient) spatial and/or time related perceptual attributes heavily promote symbolic, numeric, and alphanumeric knowhow in a subject. Accordingly, the exercises of Example 1 strengthen fluid intelligence abilities by particularly promoting inductive-deductive reasoning strategies in a subject that result in the attainment of novel and more efficient ways to problem solve the sequential orders of single letter symbols, open-bigram term symbols, numbers and alphanumeric symbols in the mentioned exercises.

It is important that the exercises of Example 1 accomplish promoting novel symbolic relationships between different open-bigram term symbols, numbers, and alphanumeric symbols and their spatial and time perceptual related attributes by enabling problem solving strategies that downplay or mitigate the subject's need to recall/retrieve information from long term memory and use verbal semantic or episodic information as part of his/her novel reasoning strategy. The exercises of Example 1 are mainly, in general, about promoting fluid intelligence abilities and, in particular, about promoting novel inductive-deductive reasoning strategies in a subject. Still, the exercises of Example 1 are not primarily designed to engage the subject's sensorial-perceptual sensory motor performances with sequences of different open-bigram terms and their spatial and/or time perceptual related attributes in order to stimulate the more cognoscenti formal operational stage where crystalized intelligence abilities are also promoted in the specific trained domain; crystallized intelligence abilities are brought into play by cognitive establishment of a multi-dimensional mesh of relationships between concrete items/things themselves, concrete items/things with their spatial and/or time perceptual related attributes and by substitution of concrete items/things with non-concrete terms/symbols. Crystalized intelligence narrow abilities are mainly promoted by sequential, descriptive, and associative forms of explicit learning, which is a kind of learning deeply rooted in declarative semantic knowledge. As such, the specific group of complete non-randomized serial orders of different open-bigram terms in the library (e.g., pairs of consecutive letters, numbers, alphanumeric symbols) and the extent of the quasi-randomization of selected different open-bigrams sequences in the library (e.g., pairs of consecutive letters, numbers, alphanumeric symbols) are herein selected and presented together to the subject in ways to principally downplay or mitigate the subject's need for developing problem solving strategies and/or drawing abstract relationships necessitating verbal knowledge and/or recall-retrieval of information from declarative-semantic and/or episodic kinds of memories.

The randomized different open-bigrams sequence provided to the subject can be derived from one of a plurality of non-randomized sequences in a predefined library. While the randomized different open-bigrams sequences provided to the subject are deemed “random,” the herein randomized sequences nevertheless adhere to a number of rules/constraints and thus cannot be considered as truly randomized. The random nature of the provided randomized different open-bigram sequences means that the different open-bigram terms used in the various exercises are associated with a particular kind of serial order of different open-bigram terms in which each different open-bigram term is not only different, but it also has a unique intrinsic ordinal position within the serial order of different open-bigram terms. In other words, there is no repetition of the open-bigram terms within the serial order of different open-bigram terms, and each open-bigram term occupies a unique intrinsic position within the serial order.

A non-limiting example of a unique non-randomized serial order of different open-bigram terms is formed from the English alphabet, wherein there are 13 different pairs of consecutive letter symbols occupying 13 unique intrinsic ordinal positions in the alphabetical sequence. Within the present subject matter, the at least one unique serial order of different open-bigram terms comprises a set array with a predefined number of open-bigram terms, where each open-bigram term has a predefined unique intrinsic ordinal position and none of the open-bigram terms are repeated or are located at a different ordinal position.

In the exercises of present Example 1, the library of non-randomized sequences comprises different open-bigram sequences. A different open-bigrams sequence is a kind of sequence where each open-bigram term is made-up of a pair of letter symbols, as opposed to a sequence of terms made-up of a single letter symbol. In this aspect, the predefined library of non-randomized sequences comprises the following sequential orders of different open-bigrams terms: direct open-bigram set array, inverse open-bigram set array, direct type open-bigram set array, inverse type open-bigram set array, central type open-bigram set array, and inverse central type open-bigram set array. However, it is understood that the library of non-randomized sequences may contain additional or fewer open-bigram set arrays than those listed above.

Furthermore, it is also important to consider that the exercises of Example 1 are not limited to serial orders of alphabetic different open-bigram terms. It is also contemplated that the exercises are also useful when numeric and/or alphanumeric serial orders are used. In other words, while the specific examples set forth employ alphabetic serial orders of different open-bigram terms, under the provisions indicated in the method, serial orders of different open-bigram terms could also be obtained from pairs of numbers and/or alphanumeric symbols.

In an aspect of the present subject matter, the exercises of Example 1 include providing a graphical representation of a complete non-randomized different open-bigram set array in a ruler shown to the subject when providing the subject with a randomized different open-bigrams sequence (derived from the complete non-randomized alphabetic open-bigram set array). The visual presence of the ruler helps the subject to serially sensorially discriminate, sensory motor select, and reorganize the out of serial order open-bigram terms, one at a time, within the provided randomized different open-bigrams sequence, to sensory motor form a completed non-randomized serial order of different open-bigram terms. In essence, the presence of the ruler accelerates the subject's visual serial search and spatial sensorial recognition of the open-bigram terms' unique ordinal positions in the different open-bigram set array. In the present exercises, the ruler comprises one of a plurality of non-randomized sequences from the above disclosed library comprising: direct alphabetic set array; inverse alphabetic set array; direct type of alphabetic set array; inverse type of alphabetic set array; central type of alphabetic set array; inverse central type alphabetic set array; direct open-bigram set array; inverse open-bigram set array; direct type open-bigram set array; inverse type open-bigram set array; central type open-bigram set array; and inverse central type open-bigram set array.

The subject is given a first predefined time period within which the subject must validly perform the exercises. If the subject does not perform the exercise within the first predefined time interval, also referred to as “a valid performance time period”, then after a delay, which could be about 4 seconds, the next in-line different open-bigrams sequence for the trial exercise to be performed by the subject is displayed. As a non-limiting example the first predefined time interval or valid performance time period is defined to be 10-20 seconds, in particular 15-20 seconds, and further specifically 17 seconds, as the maximal allowed time period for the relocation of one different open-bigram term to its correct ordinal position.

In the present Example, there are one or more predefined time intervals between block exercises. Let Δ1 herein represent a time interval between performances of the block exercises of the present task, where Δ1 is herein defined to be of 8 seconds. However, other time intervals are also contemplated, including without limitation, 5-15 seconds and the integral times there between.

The methods implemented by the exercises of Example 1 also contemplate those situations in which the subject fails to perform the given example. The following failing to perform criteria is applicable to any trial exercise in any block exercise of the present Example in which the subject fails to perform. Specifically, for the present exercises, there are two kinds of “failure to perform” criteria. The first kind of “failure to perform” criteria occurs in the event the subject fails to perform by not sensory motor selecting any open-bigram term in an attempt to sensory motor reorganize the provided randomized different open-bigrams sequence within a valid performance time period. In such a case, the subject will automatically be presented with 3 new trial exercises in which the subject must gradually serially sensorially discriminate, sensory motor select, and reorganize a new provided randomized different open-bigrams sequence. The valid performance time period can be any set period of time, for instance 30 seconds.

If the subject fails to perform in this manner for any of the 3 new trial exercises consecutively within the first or second block exercise, then the subject ends that particular exercise and moves on to the next in-line exercise within the next in-line block exercise (e.g., from block exercise 1 to block exercise 2 or from block exercise 2 to block exercise 3). Specifically, if the subject fails to perform for any of the 3 new trial exercises consecutively within the third block exercise, then the subject is automatically stopped within the exercises of Example 1 and returned to the main menu of Examples implementing the present methods.

The second “failure to perform” criteria is in the event the subject fails to perform by sensory motor selecting a wrong open-bigram answer. When the subject sensory motor selects and reorganizes a wrong different open-bigram term, the incorrect sensory motor selection and reorganization is ignored and the wrong open-bigram term is returned to its initial position in the randomized open-bigrams sequence. In other words, the open-bigram term that the subject attempted to relocate is put back in the serial position that it occupied before the subject attempted to sensory motor move it. If the subject answers wrongly for three consecutive attempts, then the subject is transitioned on to the next in-line trial exercise within the next block exercise, unless the subject is performing the third block exercise, in which case the subject is automatically stopped within the exercises of Example 1 and returned to the main menu of Examples implementing the present methods.

The total duration to complete the exercises of Example 1, as well as the time it took to implement each one of the individual trial exercises, is recorded in order to help generate an individual and age-gender related performance score. Performance records of all of the wrong answers for all serial orders required to be performed are also generated and displayed. In general, the subject will perform this task about 6 times during his/her language based brain neuroperformance-fitness training program.

In another aspect, implementing an ordinal sensory motor repositioning of different open-bigram terms in a randomized sequence which is not truly random into their respective alphabetical positions can be carried out by the method of executing a sensory motor reposition affecting the ordinal positions of at least two different open-bigram terms simultaneously. In a non-limiting embodiment, the serial sensorial discrimination, sensory motor selection, and reorganization of the different open-bigram terms is done by sensory motor reallocating pairs of different open-bigram terms at once, meaning that correctly serially sensorially discriminating, sensory motor selecting, and reorganizing one of a pair of different open-bigram terms into its unique ordinal position in the alphabetical sequence also causes the other open-bigram term to be correctly sensory motor reallocated into its unique ordinal position in the alphabetical sequence.

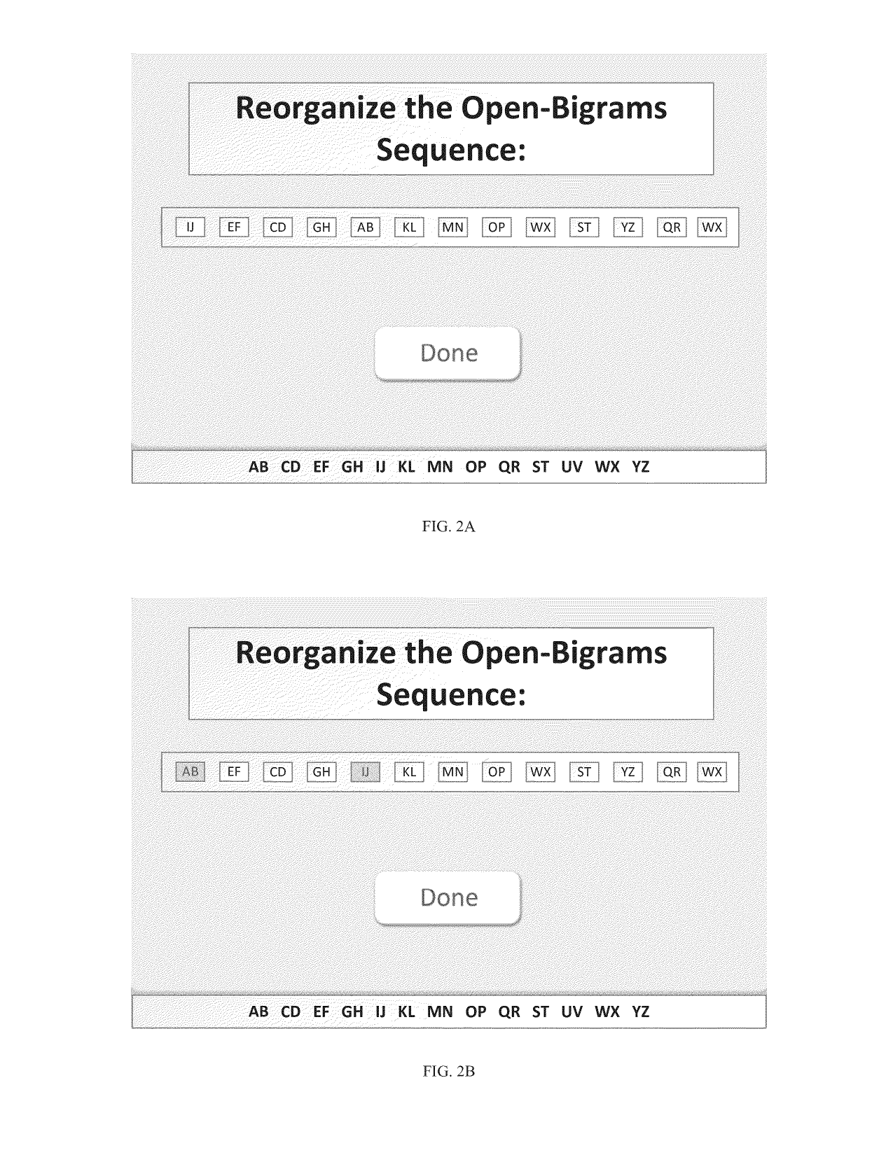

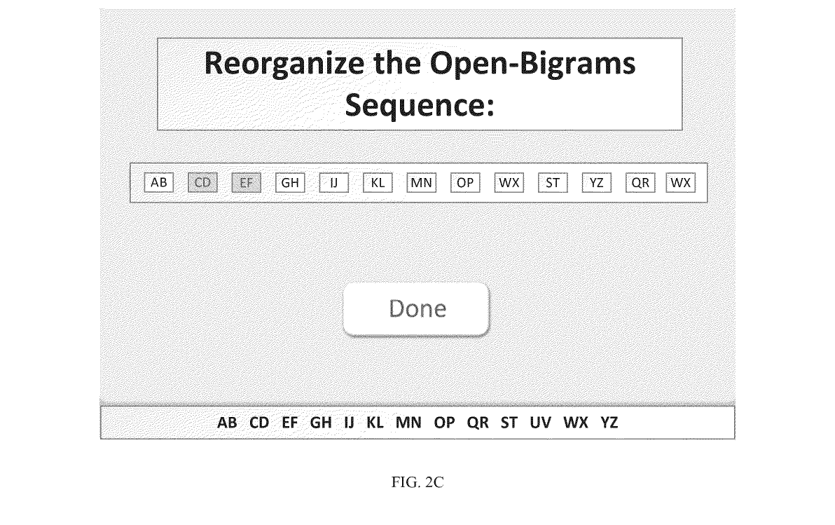

FIGS. 2A-2C depict this aspect of the present subject matter. In FIG. 2A, the subject is prompted to serially sensorially discriminate, sensory motor select, and reorganize a randomized open-bigrams sequence. In FIG. 2B, the subject has correctly serially sensorially discriminated, sensory motor selected, and reorganized the pair of different open-bigram terms AB and IJ by sensory motor swapping them into their respective unique alphabetical ordinal positions in the randomized open-bigrams sequence. The correct sensory motor reorganization of open-bigram terms AB and IJ in the randomized different open-bigrams sequence is highlighted by AB and IJ changing their time perceptual related attribute font color. In FIG. 2C, open-bigram terms CD and EF have been correctly serially sensorially discriminated, sensory motor selected, and reorganized by sensory motor swapping them into their respective unique alphabetical ordinal positions. Again, the fact that the sensory motor reorganization of CD and EF is correct is highlighted by CD and EF changing their time perceptual related attribute font color. The subject continues to perform the sensory motor reorganization until the completed non-randomized direct alphabetical serial order of different open-bigram terms is formed.

A complete non-randomized direct alphabetical serial order of different open-bigram terms can be seen in the ruler at the bottom of each of FIGS. 2A-2C. Although FIGS. 2A-2C specifically depict a randomized open-bigrams sequence derived from a complete non-randomized direct alphabetical serial order of different open-bigram terms, randomized open-bigram sequences derived from other unique complete non-randomized serial orders of different open-bigram terms may be used as discussed above.

### Example 2

### Serial Sensorial Discrimination, Sensory Motor Selection, Removal, Reorganization, and Insertion of Same and Different Open-Bigram Terms from a Randomized Open-Bigrams Sequence to Obtain a Non-Randomized Complete Direct or Inverse Alphabetical Serial Order of Different Open-Bigrams Terms

The present exercises of non-limiting Example 2 require the subject to sequentially perform a number of basic operations concerning open-bigram sequences. To that end, the present non-limiting exercises challenge the subject to quickly reason which few sequential steps are needed in order to successfully attain a complete non-randomized different open-bigrams sequence.

In a non-limiting embodiment, the subject is prompted to attain a complete non-randomized direct alphabetical (A-Z) or a complete non-randomized inverse alphabetical (Z-A) different open-bigram set array. Specifically, in a sequential performance manner, the subject is required to serially sensorially discriminate, sensory motor select, remove, reorganize, and insert a number of open-bigram terms in a provided randomized or quasi-randomized open-bigrams sequence derived from a non-randomized complete serial order of different open-bigrams terms. To that effect, the provided randomized or quasi-randomized open-bigrams sequence entails: 1) a number of serially repeated open-bigram terms, 2) a number of serially misplaced open-bigram terms and, 3) a number of missing open-bigram terms. In short, the main goal of the present non-limiting Example 2 is for the subject to accurately and quickly perform a sequential step by step serial sensorial discrimination, sensory motor selection, removal, reorganization, and insertion of a number of open-bigram terms in a provided randomized or quasi-randomized open-bigrams sequence in order to successfully attain a complete non-randomized direct alphabetical (A-Z) different open-bigram set array or a complete non-randomized inverse alphabetical (Z-A) different open-bigram set array at the end of the task.

In the present non-limiting Example 2, the subject is required to perform 3 block exercises, each comprising 2 trial exercises, in a sequential manner. Accordingly, for each trial exercise a randomized or quasi-randomized open-bigrams sequence is generated from a previously selected complete non-randomized sequence of different open-bigram terms. In a non-limiting embodiment, each complete non-randomized sequence of different open-bigrams terms has 13 open-bigram terms (of the English language alphabet) with unique ordinal positions, displayed in uppercase font as a default condition. Overall, a total of six complete non-randomized different open-bigrams sequences can be practiced in this non-limiting Example. In an embodiment, the randomized or quasi-randomized open-bigram sequences are derived from complete non-randomized direct or inverse alphabetic different open-bigram set arrays.

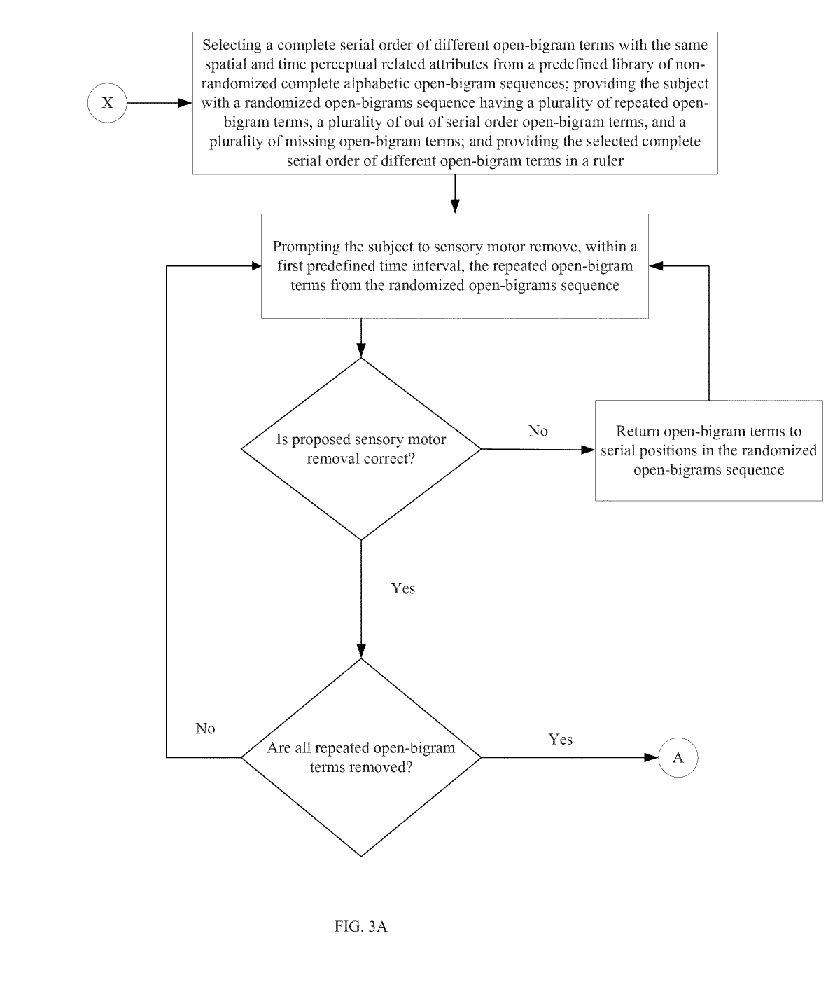

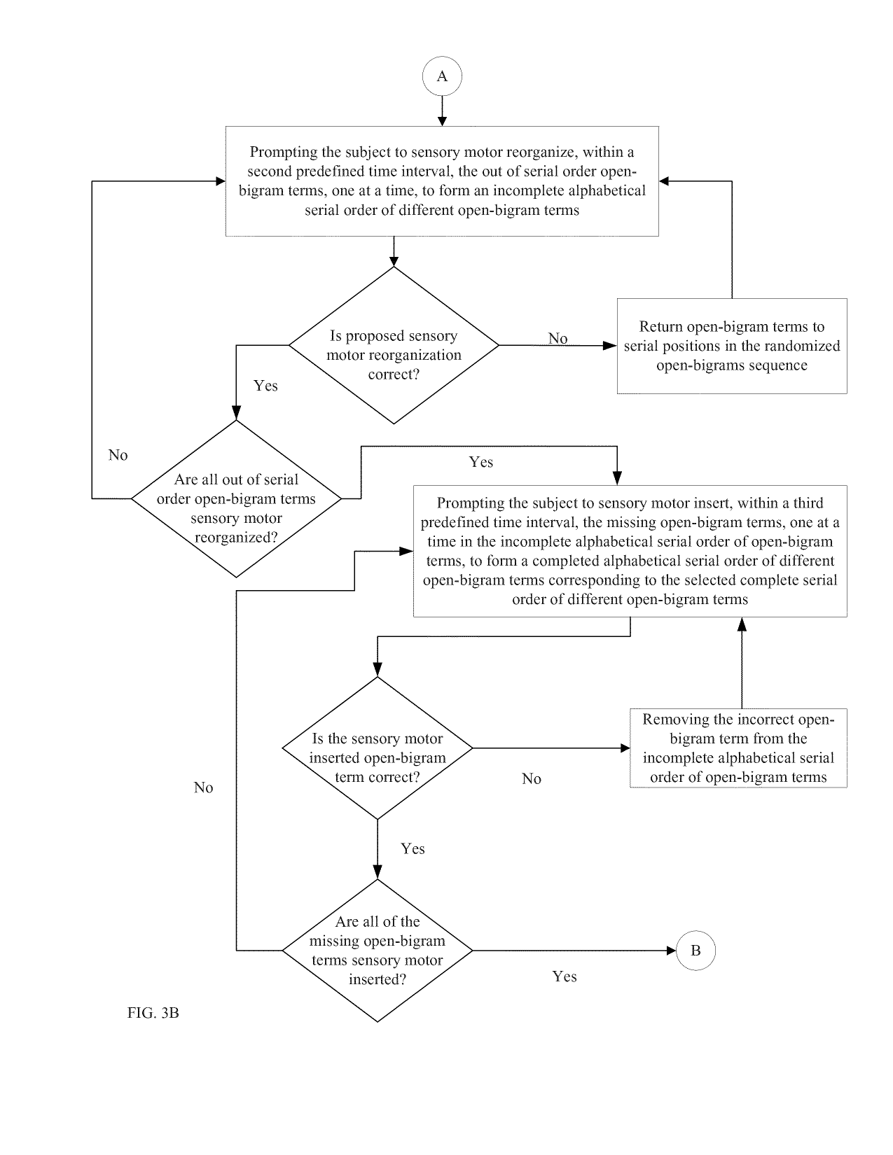

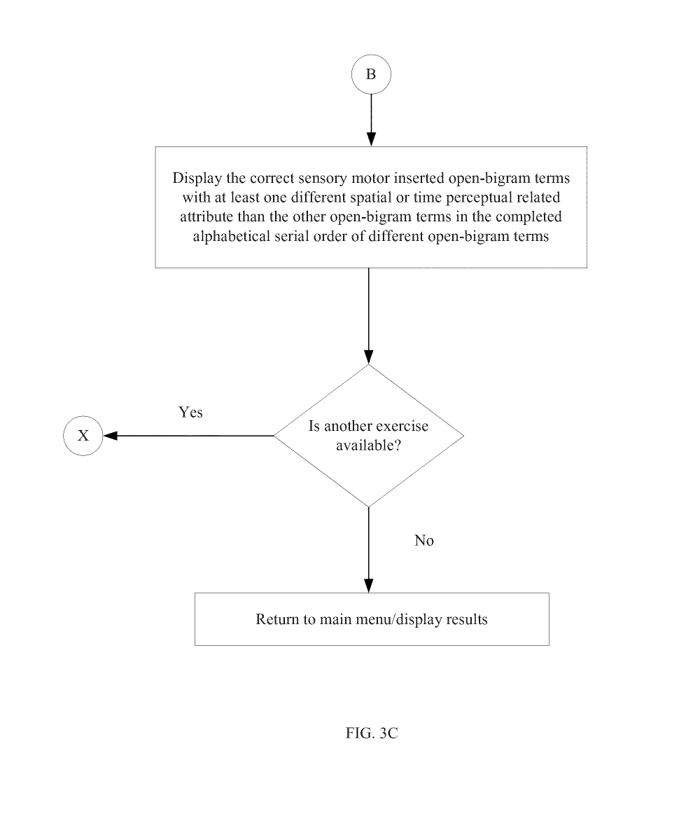

FIGS. 3A-3C comprise a flow chart setting forth the method that the present exercises use in promoting fluid intelligence abilities in a subject through novel reasoning strategies directed towards problem solving by the serial sensorial discrimination, sensory motor selection, removal, ordinal reorganization, and insertion of open-bigram terms in a provided randomized open-bigrams sequence to attain a complete non-randomized serial order of different open-bigram terms.

As can be seen in FIGS. 3A-3C, the method of promoting fluid intelligence abilities in the subject comprises (FIG. 3A) first selecting a complete non-randomized serial order of different open-bigram terms having the same spatial and time perceptual related attributes from a predefined library of complete alphabetic different open-bigrams sequences and then providing the subject with a randomized or quasi-randomized open-bigrams sequence derived therefrom. The randomized or quasi-randomized open-bigrams sequence has a plurality of open-bigram terms repeated a predefined number of times, a plurality of open-bigram terms out of serial order, and a plurality of missing open-bigram terms. The non-randomized complete serial order of different open-bigram terms is provided as a ruler to the subject. The subject is prompted to serially sensorially discriminate, sensory motor select, and remove, within a first predefined time interval, the repeated open-bigram terms. If the proposed serial sensorial discrimination, sensory motor selection, and removal of a repeated open-bigram term is incorrect, then the open-bigram term is returned to its initial position in the randomized open-bigrams sequence. The subject is then returned to the step of being prompted to serial sensorial discriminate, sensory motor select, and remove the repeated open-bigram terms. If the proposed serial sensorial discrimination, sensory motor selection, and removal of a repeated open-bigram term is correct, but more repeated open-bigram terms remain in the provided randomized open-bigrams sequence, then the subject is again returned to the step of being prompted to serial sensorial discriminate, sensory motor select, and remove the repeated open-bigram terms.

If no repeated open-bigram terms remain in the provided randomized open-bigrams sequence, the subject is prompted (FIG. 3B) to serially sensorially discriminate, sensory motor select, and ordinarily reorganize, within a second predefined time interval, the out of serial order open-bigram terms, one at a time. If the proposed sensory motor reorganization of an open-bigram term is incorrect, then the open-bigram term is returned to its initial serial order position in the randomized open-bigrams sequence and the subject is returned to the step of being prompted to sensory motor reorganize the out of serial order different open-bigram terms. If the proposed sensory motor reorganization of an open-bigram term is correct, but further sensory motor reorganization of the provided randomized different open-bigrams sequence is needed, then the subject is also returned to the step of being prompted to serially sensorially discriminate, sensory motor select, and reorganize the out of serial order different open-bigram terms.

If the sensory motor ordinal reorganization results in an incomplete non-randomized serial order of different open-bigram terms, the subject is prompted (FIG. 3B) to serially sensorially discriminate, sensory motor select, and insert, within a third predefined time interval, missing different open-bigram terms into the incomplete non-randomized serial order of different open-bigram terms to sensory motor form a complete non-randomized alphabetical serial order of different open-bigram terms. The completed non-randomized alphabetical serial order of different open-bigram terms will correspond to the selected non-randomized alphabetical serial order of different open-bigram terms. The subject is prompted to serially sensorially discriminate, sensory motor select, and gradually insert missing different open-bigram terms one at a time.

If the proposed sensory motor insertion of a missing different open-bigram term is incorrect, then the incorrect term is removed and the subject is returned to the step of being prompted to serially sensorially discriminate, sensory motor select, and insert missing open-bigram terms. If the proposed sensory motor insertion of a missing different open-bigram term is correct, but more open-bigram terms are still missing from the non-randomized incomplete open-bigrams sequence, then the subject is returned to the step of being prompted to serially sensorially discriminate, sensory motor select, and insert missing open-bigram terms. If the proposed sensory motor insertion of a different missing open-bigram term is correct and the completed non-randomized alphabetical serial order of different open-bigram terms is formed, then the correct sensory motor inserted open-bigram terns are displayed (FIG. 3C) with at least one different spatial and/or time perceptual related attribute than the other open-bigram terms in the completed non-randomized alphabetic different open-bigrams sequence.

The above steps in the method are repeated for a predetermined number of iterations separated by fourth predefined time intervals, and upon completion of the predetermined number of iterations, the subject is provided with the results of each iteration. The predetermined number of iterations can be any number needed to establish a satisfactory reasoning performance ability concerning the particular task at hand which is being promoted within the subject. Non-limiting examples of number of iterations include 1, 2, 3, 4, 5, 6, and 7. However, any number of iterations can be performed, such as 1 to 23.

In another non-limiting aspect of Example 2, the method of promoting fluid intelligence abilities in a subject is implemented through a computer program product. In particular, the subject matter in Example 2 includes a computer program product for promoting fluid intelligence abilities in a subject, stored on a non-transitory computer readable medium which when executed causes a computer system to perform the method. The method executed by the computer program on the non-transitory computer readable medium comprises selecting a serial order of different open-bigram terms with the same spatial and time perceptual related attributes from a predefined library of non-randomized complete alphabetic different open-bigram sequences, and providing the subject with a randomized open-bigrams sequence derived therefrom. The provided randomized open-bigrams sequence has a plurality of open-bigram terms repeated a predefined number of times, a plurality of open-bigram terms out of serial order, and a plurality of missing open-bigram terms. The selected non-randomized complete alphabetic serial order of different open-bigram terms is also provided as a ruler to the subject.

The subject is prompted to serially sensorially discriminate, sensory motor select, and remove, within a first predefined time interval, repeated open-bigram terms. If the proposed sensory motor removal of an open-bigram term is incorrect, then the open-bigram term is returned to its initial serial order position prior to the proposed sensory motor removal made by the subject. The subject is then returned to the step of being prompted to serially sensorially discriminate, sensory motor select, and remove the repeated open-bigram terms. If the proposed sensory motor removal of an open-bigram term is correct, but more repeated open-bigram terms remain in the randomized open-bigrams sequence, then the subject is again returned to the step of being prompted to serially sensorially discriminate, sensory motor select, and remove the repeated open-bigram terms.

If no repeated open-bigram terms remain in the provided randomized open-bigrams sequence, the subject is prompted to serially sensorially discriminate, sensory motor select, and ordinarily reorganize, within a second predefined time interval, the out of serial order different open-bigram terms, the sensory motor ordinal reorganizing accomplished one open-bigram term at a time. If the proposed sensory motor ordinal reorganization of an open-bigram term is incorrect, then the open-bigram term is returned to its initial serial order position prior to the proposed sensory motor ordinal reorganization made by the subject and the subject is returned to the step of being prompted to serially sensorially discriminate, sensory motor select, and ordinarily reorganize the out of serial order different open-bigram terms. If the proposed sensory motor ordinal reorganization of an open-bigram term is correct, but further sensory motor ordinal reorganization of the provided randomized different open-bigrams sequence is needed, then the subject is also returned to the step of being prompted to serially sensorially discriminate, sensory motor select, and ordinarily reorganize the out of serial order different open-bigram terms.

If the sensory motor ordinal reorganization of the open-bigram terms results in an incomplete non-randomized alphabetical serial order of different open-bigram terms, the subject is prompted to serially sensorially discriminate, sensory motor select, and insert, within a third predefined time interval, missing different open-bigram terms in order to sensory motor form a complete non-randomized alphabetic serial order of different open-bigram terms corresponding to the selected non-randomized complete alphabetic serial order of different open-bigram terms. To that end, the subject is prompted to sensory motor insert missing different open-bigram terms one at a time.

If the proposed sensory motor insertion of a missing different open-bigram term is incorrect, then the incorrect term is removed, and the subject is returned to the step of being prompted to serially sensorially discriminate, sensory motor select, and insert missing different open-bigram terms. If the proposed sensory motor insertion of a missing different open-bigram term is correct, but at least one open-bigram term is still missing from the incomplete non-randomized alphabetical serial order of open-bigrams sequence, then the subject is returned to the step of being prompted to serially sensorially discriminate, sensory motor select, and insert the missing different open-bigram terms.

If the proposed sensory motor insertion of the missing different open-bigram term is correct and the completed non-randomized alphabetic serial order of different open-bigram terms is formed, then the correct sensory motor inserted open-bigram terms are displayed with at least one different spatial and/or time perceptual related attribute than the other open-bigram terms in the completed non-randomized alphabetic serial order of different open-bigram terms. The above steps in the method are repeated for a predetermined number of iterations separated by fourth predefined time intervals, and upon completion of the predetermined number of iterations, the subject is provided with the results of each iteration.

In a further non-limiting aspect of Example 2, the method of promoting fluid intelligence abilities in a subject is implemented through a system. The system for promoting fluid intelligence in a subject comprises: a computer system comprising a processor, memory, and a graphical user interface (GUI), the processor containing instructions for: a) selecting a complete non-randomized alphabetic serial order of different open-bigram terms with the same spatial and time perceptual related attributes from a predefined library of non-randomized complete alphabetic different open-bigram sequences, and providing the subject on the GUI with a randomized open-bigrams sequence from the selected complete alphabetic non-randomized serial order of different open-bigram terms, the randomized open-bigrams sequence having a plurality of open-bigram terms repeated a predefined number of times, a plurality of open-bigram terms out of serial order, and a plurality of missing open-bigram terms.

The selected complete alphabetic non-randomized serial order of different open-bigram terms is also provided as a ruler to the subject; b) prompting the subject on the GUI to serially sensorially discriminate, sensory motor select, and remove, within a first predefined time interval, the repeated open-bigram terms within the randomized open-bigrams sequence; c) if the proposed sensory motor removal of a repeated open-bigram term is incorrect, then returning the open-bigram term to its initial serial order position in the provided randomized open-bigrams sequence and returning to step b); d) if the proposed sensory motor removal of the repeated open-bigram term is correct, but further repeated open-bigram terms still remain in the provided randomized open-bigrams sequence, then returning to step b); e) prompting the subject on the GUI to serially sensorially discriminate, sensory motor select, and ordinarily reorganize, within a second predefined time interval, the out of serial order different open-bigram terms, the sensory motor ordinal reorganizing accomplished one open-bigram term at a time; f) if the proposed sensory motor ordinal reorganization of an open-bigram term is incorrect, then returning the incorrect term to its initial serial order position prior to the proposed sensory motor ordinal reorganization made by the subject and returning to step e); g) if the proposed sensory motor ordinal reorganization of an open-bigram term is correct, but further sensory motor ordinal reorganization of the remaining randomized different open-bigrams sequence is needed, then returning to step e); h) prompting the subject on the GUI to serially sensorially discriminate, sensory motor select, and insert, within a third predefined time interval, missing different open-bigram terms into the obtained incomplete alphabetical serial order of different open-bigram terms in order to sensory motor form a complete non-randomized alphabetic serial order of different open-bigram terms corresponding to the selected complete non-randomized alphabetic serial order of different open-bigram terms, and prompting the subject to serially sensorially discriminate, sensory motor select, and insert missing different open-bigram terms one at a time; i) if the proposed sensory motor insertion of a missing different open-bigram term is incorrect, then removing the incorrect term from the incomplete alphabetical serial order of different open-bigram terms and returning to step h); j) if the proposed sensory motor insertion of a missing different open-bigram term is correct, but at least one open-bigram term is still missing from the obtained incomplete alphabetical serial order of different open-bigram terms, then returning to step h); k) if the proposed sensory motor insertion of the missing different open-bigram terms is correct and the completed non-randomized alphabetic serial order of different open-bigrams is formed, then displaying the correct sensory motor inserted different open-bigram terms with at least one different spatial and/or time perceptual related attribute than the other open-bigram terms in the completed non-randomized alphabetic serial order of different open-bigram terms on the GUI; 1) repeating the above steps for a predetermined number of iterations separated by a fourth predefined time interval; and m) upon completion of the predetermined number of iterations, providing the subject with the results of each iteration on the GUI.

In a non-limiting aspect of the present exercises of Example 2, the subject is prompted to sequentially complete the above described three steps employing the complete non-randomized alphabetic serial order of different open-bigram terms graphically provided to him/her in a ruler. As previously discussed, the complete non-randomized alphabetic serial order may be a non-randomized direct or inverse alphabetic open-bigram set array. For example, if the subject is required to perform a randomized open-bigrams sequence derived from a complete non-randomized direct alphabetic open-bigram set array, then the subject is prompted in a first step to serially sensorially discriminate, sensory motor select, and remove repeated open-bigram terms such that at the end of the exercise, a direct alphabetic serial order of open-bigram terms is maintained. Particularly, the subject is prompted to serially sensorially discriminate, sensory motor select, and remove repeated open-bigram terms beginning with the open-bigram term occupying the first serial order position of the direct alphabetical open-bigrams sequence. For example, if the provided randomized open-bigrams sequence has 2 repeated (AB) open-bigram terms, 3 repeated (CD) open-bigram terms, and 4 repeated (EF) open-bigram terms, the subject would be prompted to serially sensorially discriminate, sensory motor select, and remove the excess repeated (AB) open-bigram term first followed by the excess repeated (CD) open-bigram terms, and finally the excess repeated (EF) open-bigram terms. Likewise, the sensory motor ordinal reorganization of the different open-bigram terms will be performed in direct or inverse alphabetical order, as will be the required performance of the serial sensorial discrimination, sensory motor selection, and insertion of the missing different open-bigram terms.

The first step of the present non-limiting method requires the subject to quickly visually serially search, sensorial identify, sensory motor select, and remove repeated open-bigram terms from the provided randomized open-bigrams sequence. As is indicated above, the provided randomized open-bigrams sequence is derived from a complete non-randomized direct or inverse alphabetic open-bigram set array. In a particular non-limiting aspect, the number of repeated open-bigram terms and the number of times each of those open-bigram terms are repeated, depend on whether the provided randomized open-bigrams sequence is derived from a complete non-randomized direct alphabetic or from a complete non-randomized inverse alphabetic open-bigram set array.

When the randomized open-bigrams sequence is derived from a complete non-randomized direct alphabetic open-bigram set array, the number of repeated open-bigram terms in the provided randomized open-bigrams sequence is of 2-5. Further, these different open-bigram terms are repeated within the provided randomized open-bigrams sequence 2-4 times each. Examples of complete non-randomized direct alphabetical serial orders of different open-bigram terms include, without limitation, non-randomized direct alphabetic open-bigram set array and non-randomized direct type of alphabetic open-bigram set array. The randomized open-bigrams sequence can also be derived from a non-randomized central type of alphabetic open-bigram set array that requires the subject to perform open-bigram terms in a similar serial order as is required for a randomized open-bigrams sequence derived from a non-randomized direct alphabetic open-bigram set array.

Likewise, in a further non-limiting aspect, the provided randomized open-bigrams sequence can be derived from a non-randomized inverse alphabetic open-bigram set array. In this case, 2-4 open-bigram terms are allowed repeated within the provided randomized open-bigrams sequence. Also, the repeated different open-bigram terms are repeated within the provided randomized open-bigrams sequence 1-3 times each. Examples of non-randomized inverse alphabetical serial orders of different open-bigram terms include, without limitation, non-randomized inverse alphabetic open-bigram set array and non-randomized inverse type of alphabetic open-bigram set array. The provided randomized open-bigrams sequence can be derived from the non-randomized inverse central type of alphabetic open-bigram set array, which will require the subject to perform open-bigram terms in a similar serial order manner as is required for a non-randomized inverse alphabetic open-bigram set array.

In the second step of the non-limiting exercises of Example 2, the subject is required to serially sensorially discriminate, sensory motor select, and ordinarily reorganize a plurality of different open-bigram terms in order to sensory motor insert, in a third step, the required different open-bigram terms into their proper alphabetical serial order, to gradually sensory motor form a complete non-randomized direct or inverse alphabetical serial order of different open-bigram terms. In a particular non-limiting aspect, when the obtained incomplete serial order of different open-bigram terms is derived from a complete non-randomized direct alphabetical serial order of different open-bigram terms, 2-5 open-bigram terms are needed to complete the direct alphabetical serial order. Likewise, when the obtained incomplete serial order of different open-bigram terms is derived from a complete non-randomized inverse alphabetical serial order of different open-bigram terms, 2-4 open-bigram terms are needed to complete the inverse alphabetical serial order.

As mentioned earlier, the subject is provided with a second predefined time interval to perform the sensory motor ordinal reorganization of the different open-bigram terms in a randomized incomplete serial order of different open-bigram terms in order to obtain an incomplete non-randomized direct or inverse alphabetical serial order of different open-bigram terms. The given sensory motor ordinal reorganization time period is dependent on the type of randomized open-bigrams sequence provided to the subject as well as the number of different open-bigram terms needing sensory motor ordinal reorganization therein. In general, when the subject is provided with a randomized open-bigrams sequence that becomes an incomplete direct alphabetical sequence after sensory motor reorganization, the subject is given 15-45 seconds per term to be reorganized. For example, if the subject is provided with a randomized open-bigrams sequence which, after sensory motor reorganization, becomes an incomplete direct alphabetical sequence, if there are five different open-bigram terms required to be sensory motor ordinal reorganized, and the subject is given 30 seconds per term, then the subject will have 150 seconds to complete the sensory motor ordinal reorganization (5 open-bigram terms×30 seconds per term).

Likewise, when the subject is provided with a randomized open-bigrams sequence that after sensory motor reorganization becomes an incomplete inverse alphabetical sequence, the subject is given 15-45 seconds per open-bigram term needing ordinal reorganization. In one example, for a randomized open-bigrams sequence, which after sensory motor reorganization becomes an incomplete inverse alphabetical sequence, having three different open-bigram terms to be sensory motor reorganized, the subject is given 40 seconds to reorganize each open-bigram term. Accordingly, the subject will have 120 seconds to sensory motor reorganize the different open-bigram terms (3 open-bigram terms×40 seconds per term) and complete this particular step of the exercise.

In the third step of the non-limiting exercises of Example 2, the subject is required to serially sensorially discriminate, sensory motor select, and insert a number of missing different open-bigram terms into the obtained non-randomized incomplete alphabetical serial order of different open-bigram terms in order to sensory motor form a complete non-randomized direct or inverse alphabetical serial order of different open-bigrams terms. When the subject is provided with a randomized open-bigrams sequence that after sensory motor reorganization becomes an incomplete direct alphabetical sequence in nature, 2-5 open-bigram terms can be missing. In some embodiments, the number of missing different open-bigram terms is 3-5 terms.

Likewise, when the subject is provided with a randomized open-bigrams sequence that after sensory motor reorganization becomes an incomplete inverse alphabetical sequence, 2-5 different open-bigram terms can be missing. In some embodiments, the number of missing different open-bigram terms is 3 or 4 terms.

In order to successfully complete the incomplete non-randomized alphabetical serial order of different open-bigram terms after the sensory motor removal and reorganization of open-bigram terms, the subject is required to visually search, sensory motor click-select and drag (when using a computer) one open-bigram term at a time with the hand-held mouse device from the complete non-randomized direct or inverse alphabetical serial order of different open-bigram terms shown in a ruler, and sensory motor insert the selected open-bigram term, as fast as possible, in its correct serial order position in the incomplete non-randomized alphabetical serial order of different open-bigram terms.

In the third step, the subject is required to serially sensorially discriminate, and sensory motor select a number of different open-bigram terms and subsequently sensory motor insert them in what is now an incomplete non-randomized alphabetical serial order of different open-bigram terms in order to attain a completed direct or inverse alphabetic serial order of different open-bigram terms. In some embodiments, if the sensory motor insertions of open-bigram terms in their corresponding ordinal positions in the completed alphabetical different open-bigrams sequence are correct, the correctly inserted terms immediately change their default spatial perceptual related attribute font size and their default spatial perceptual related attributes to become spatial perceptual related attribute font bold. In other words, the correct sensory motor inserted open-bigram terms immediately have two of their default spatial perceptual related attributes changed.

In another non-limiting embodiment, when the subject is performing the above described third step in block exercises #2 and #3 only, the subject is required to serially sensorially discriminate, and sensory motor select a number of different open-bigram terms and subsequently sensory motor insert them in an obtained incomplete non-randomized alphabetical serial order of different open-bigram terms to attain a completed non-randomized direct or inverse alphabetical serial order of different open-bigrams terms. Further, in these cases, the correct sensory motor inserted open-bigram terms will change their time perceptual related attribute of font color. Accordingly, all of the correctly inserted open-bigram terms become time perceptual related attribute font color active in the completed non-randomized direct or inverse alphabetical serial order of different open-bigram terms.

As a non-limiting example, the change in the time perceptual related attribute of font color for the correct sensory motor inserted open-bigram terms occurs in the following manner 1) for a complete non-randomized direct alphabetical serial order of different open-bigram terms, the serial order positions occupied by open-bigram terms AB to MN will become time perceptual related attribute font color active according to the established spatial correlation of these open-bigram terms' unique ordinal positioning in the direct alphabetical open-bigrams sequence with the spatial-perceptual Left Visual Field (LVF) of the subject; and 2) for a complete non-randomized direct alphabetical serial order of different open-bigram terms, the serial order positions occupied by open-bigram terms OP to YZ will become time perceptual related attribute font color active according to the herein established spatial correlation of these different open-bigram terms' unique ordinal positioning in the direct alphabetical open-bigrams sequence with the spatial-perceptual Right Visual Field (RVF) of the subject. Further, all of the correctly inserted open-bigram terms in the obtained incomplete non-randomized direct alphabetical sequence for the AB-MN group will have a first time perceptual related attribute font color change, and all of the correctly inserted open-bigram terms for the OP-YZ group, will have a second time perceptual related attribute font color change.

Likewise, in a further non-limiting embodiment, all of the open-bigram terms correctly inserted by the subject become time perceptual related attribute font color active relative to the completed non-randomized inverse alphabetical serial order of different open-bigram terms in the following manner 1) the ordinal positions occupied by open-bigram terms ZY to PO will become time perceptual related attribute font color active according to the established spatial correlation of these open-bigram terms' unique ordinal positioning in the inverse alphabetical open-bigrams sequence with the spatial-perceptual Left Visual Field (LVF) of the subject; and 2) the ordinal positions occupied by open-bigram terms NM to BA will become time perceptual related attribute font color active according to the established spatial correlation of these different open-bigram terms' unique ordinal positioning in the inverse alphabetical different open-bigrams sequence with the spatial-perceptual Right Visual Field (RVF) of the subject. Further, all of the correctly inserted open-bigram terms in the obtained incomplete non-randomized inverse alphabetical serial order of different open-bigram terms for the ZY-PO group will have a first time perceptual related attribute font color change, and all of the correctly inserted open-bigram terms for the NM-BA group will have a second time perceptual related attribute font color change.

It is also contemplated that the correct sensory motor inserted different open-bigram terms, in addition to changing their time perceptual related attribute font color, change another time perceptual related attribute by becoming font flashing active. In other words, the correct sensory motor inserted open-bigram terms will also change the frequency time period of their visual perceptual appearance by font flashing in order to further highlight their correct ordinal positions in the completed non-randomized alphabetical direct or inverse different open-bigrams sequence.

As discussed above, upon the correct sensory motor formation of the completed non-randomized direct or inverse alphabetical serial order of different open-bigram terms, the correct sensory motor inserted open-bigram terms are displayed with a different spatial and/or time perceptual related attribute than the spatial and time perceptual related attributes of the remaining open-bigram terms in the completed non-randomized serial order of different open-bigram terms. The above non-limiting embodiments briefly discuss different open-bigram term font size and font color as spatial and time perceptual related attributes, respectively, that can change. In general, the changed perceptual related attribute of correctly sensory motor reorganized different open-bigram terms is selected from the group of spatial and/or time perceptual related attributes or combinations thereof.

In a particular aspect, the changed perceptual related attributes of the open bigrams terms are selected from the group including: open-bigram term font size, open-bigram term font style, open-bigram term font spacing, open-bigram term font case, open-bigram term font boldness, open-bigram font rotation angle, open-bigram term font mirroring, or combinations thereof. These perceptual related attributes are considered spatial perceptual related attributes of the open-bigram terms. Other spatial perceptual related attributes of the open-bigram terms that could be used include, without limitation, open-bigram term font vertical line of symmetry, open-bigram term font horizontal line of symmetry, open-bigram term font vertical and horizontal lines of symmetry, open-bigram term font infinite lines of symmetry, and open-bigram term font with no line of symmetry. In another aspect, the changed perceptual related attributes of the open-bigram terms are selected from the group including font color, font flickering, and sound. These perceptual related attributes are considered time perceptual related attributes of the open-bigram term. Furthermore, each correctly sensory motor reorganized different open-bigram term may be displayed with a time perceptual related attribute font flickering behavior to further highlight the correct serial order sensory motor ordinal reorganization.

In a particular aspect of the present Example 2, the change in spatial and/or time perceptual related attributes is done according to predefined correlations between space and time perceptual related attributes with the ordinal position of the different open-bigram terms in the selected complete non-randomized serial order of different open-bigram terms. For the case of a subject's visual perception of a complete direct alphabetic open-bigram set array of the English alphabetical language, the first ordinal position (occupied by “AB”) will generally appear toward the left side of his/her field of vision, whereas the last ordinal position (occupied by “YZ”) will appear towards his/her right field of vision.

In one non-limiting example for an alphabetic direct or inverse set array, if the ordinal position of the open-bigram term for which a perceptual related attribute will be changed falls in the left field of vision, the change in the perceptual related attribute may be different than if the ordinal position of the open-bigram term falls in the right field of vision. Accordingly, if the perceptual related attribute to be changed is the time perceptual related attribute font color, and the ordinal position of the open-bigram term falls in the left field of vision, then the font color will be changed to a first different font color, whereas if the ordinal position of the open-bigram terms falls in the right field of vision, then the font color will be changed to a second font color different from the first font color. Similarly, if the perceptual related attribute to be changed is the spatial perceptual related attribute font size, then those open-bigram terms having an ordinal position falling in the left field of vision will be changed to a first different font size, while the different open-bigram terms having an ordinal position falling in the right field of vision will be changed to a second different font size that is also different than the first different font size.

It is also understood that the correctly sensory motor inserted open-bigram terms may have different spatial and/or time perceptual related attributes among themselves. In other words, one correctly sensory motor reorganized open-bigram term could be highlighted by having a different time perceptual related attribute font color, while another correctly reorganized open-bigram term could be highlighted by having a different spatial perceptual related attribute font term size. Alternatively, one correctly sensory motor reorganized open-bigram term could have a changed spatial perceptual related attribute, while another correctly reorganized open-bigram term could be changed by means of a time perceptual related attribute.

As with the exercises in Example 1, the exercises in Example 2 are useful in promoting fluid intelligence abilities in the subject by grounding its root-core fluid intelligence abilities in selective goal oriented motor activity that takes place when the subject performs a given exercise. That is, the serial visual search, sensorial identification, sensory motor selection, removal, reorganization, and insertion of open-bigram terms by the subject engages goal oriented motor activity within the subject's body. The goal oriented motor activity engaged within the subject may be any goal oriented motor activity involved in the group including: sensorial perception of the complete non-randomized serial order of different open-bigram terms shown in the ruler and in the given randomized open-bigrams sequence, goal oriented body movements to execute sensory motor selecting the next repeated open-bigram term to be removed, sensory motor ordinal reorganizing the open-bigram terms in the randomized open-bigrams sequence, sensory motor insertion of open-bigram terms to obtain a complete non-randomized serial order of different open-bigram terms, and combinations thereof. While any body movements can be considered goal oriented motor activity within the subject, body movements may be selected from the group consisting of goal oriented body movements of the subject's eyes, head, neck, arms, hands, fingers and combinations thereof.

Requesting the subject to engage in various degrees of goal oriented motor activity in the exercises of Example 2, require him/her to bodily-ground cognitive fluid intelligence abilities, in general and in particular, problem solving concerning particular sequential orders of open-bigram terms through inductive reasoning, as discussed above. The exercises of Example 2 cause the subject to revisit an early developmental realm where he/she implicitly performed fluid cognitive abilities specifically when problem solving the serial search and sensorial pattern recognition of non-concrete terms/symbols/numbers/alphanumeric symbols meshing with their salient spatial-time perceptual related attributes. An inductive-deductive reasoning problem solving that successfully established sequential relationships between non-concrete terms/symbols and their (salient) spatial and/or time perceptual related attributes, heavily promotes symbolic, numeric and alphanumeric knowhow in a subject. Accordingly, the exercises of Example 2 strengthen fluid intelligence abilities by promoting novel inductive-deductive reasoning strategies in a subject that result in the attainment of more efficient ways to solve the mentioned exercises. It is important that the exercises of Example 2 accomplish the promotion of symbolic relationships between open-bigram terms/symbols/numbers/alphanumeric symbols and their spatial and time perceptual related attributes by succeeding in downplaying or mitigating the subject's need to recall/retrieve from long term memory and use verbal semantic or episodic information as part of his/her novel reasoning strategy, as much as possible.

The exercises of Example 2 are mainly in general, about promoting fluid intelligence abilities, and in particular, about promoting novel inductive-deductive reasoning strategies in a subject. The exercises of Example 2 are not intended to raise the subject's sensorial-perceptual goal oriented body motor performances (with different open-bigram terms and their spatial and/or time perceptual related attributes) to the more cognoscenti formal learning operational stage where crystalized intelligence abilities are also promoted as a direct consequence of engaging in mental problem solving in the specific trained domain; crystallized intelligence abilities are brought into play by cognitive establishment of a multi-dimensional mesh of relationships between concrete items/things themselves, concrete items/things with their spatial and/or time related attributes, and by substitution of concrete items/things with non-concrete terms/symbols. Still, crystalized intelligence narrow abilities are mainly promoted by sequential, descriptive and associative forms of explicit learning, which is a kind of learning deeply rooted in declarative semantic knowledge. As such, specific non-randomized sequences of terms/symbols (e.g., letter, number, alphanumeric), randomized sequences of terms/symbols (e.g., letter, number, alphanumeric), randomized incomplete sequences, and non-randomized complete direct or inverse alphabetic (unique) serial orders of different open-bigram terms are herein selected and displayed together in an exercise, to principally downplay or mitigate the subject's need for developing problem solving strategies and/or drawing abstract mental relationships (e.g., associations, relations, correlations) necessitating and heavily supported by verbal knowledge and/or overtaxing recall-retrieval of information from declarative-semantic and/or episodic kinds of memories.

The randomized open-bigram sequences provided to the subject are derived from a selected complete non-randomized direct or inverse alphabetic open-bigram set array selected from a plurality of complete open-bigrams sequences in a library of complete open-bigrams sequences. While the randomized open-bigram terms in the open-bigram sequences provided to the subject are deemed as “randomized,” they adhere to a number of rules and constraints and thus cannot be considered as truly randomized. In this context, the quasi-randomization of the provided randomized open-bigram sequences means that the sequences of open-bigram terms used in the various exercises are directly generated from a herein non-randomized serial order of different open-bigram terms where each different open-bigram term is not only intrinsically different but also occupies a specific unique ordinal position within the non-randomized open-bigrams sequence. Thus, there is no repeating of open-bigram terms in the non-randomized serial order of open-bigram terms.

A specific example of this unique kind of non-randomized serial order of different open-bigram terms is the English alphabet, in which there are 13 intrinsically different open-bigram terms occupying 13 intrinsically unique different and consecutive ordinal positions. In particular, within the present subject matter, the at least one unique serial order of different open-bigram terms comprises an open-bigram set array with a predefined number of unique intrinsically different open-bigram terms, where each open-bigram term has a predefined unique ordinal position and none of the open-bigram terms are repeated or are located at a different ordinal non-intrinsic (non-alphabetical) position.

In an aspect of the exercises presented in Example 2, the library of complete different open-bigram sequences includes the following non-randomized open-bigram sequences as defined above: direct alphabetic open-bigram set array; inverse alphabetic open-bigram set array; direct type of alphabetic open-bigram set array; inverse type of alphabetic open-bigram set array; central type of alphabetic open-bigram set array; and, inverse central type alphabetic open-bigram set array. It is understood that the library of complete open-bigram sequences may contain additional or fewer set arrays of different open-bigram sequences than those listed above.

Furthermore, it is also important to consider that the exercises of Example 2 are not limited to serial orders of alphabetic open-bigram sequences. It is also contemplated that the exercises are also useful when numeric and/or alphanumeric serial orders of open-bigram terms are used. In other words, while the specific examples set forth employ serial orders of letter symbol open-bigram sequences, it is contemplated that in accordance with the provisions set forth in the method, serial orders comprising numbers and/or alphanumeric open-bigram sequences can also be used.

In an aspect of the present subject matter, the exercises of Example 2 include providing a complete non-randomized open-bigram set array in a ruler shown to the subject in addition to providing the subject with the randomized open-bigrams sequence. The visual presence of the ruler helps the subject to perform the exercise by promoting accurate and fast visual spatial recognition of the provided open-bigram set array. Thus, the ruler assists the subject to perform a step by step serial sensorial discrimination, sensory motor selection, removal, reorganization, and insertion of a number of different open-bigram terms in the provided randomized open-bigrams sequence to successfully attain, for example, a non-randomized complete direct alphabetic (A-Z) or a non-randomized complete inverse alphabetic (Z-A) open-bigram set array. In the present exercises, the ruler comprises one of a plurality of non-randomized open-bigram sequences from the library of complete open-bigrams sequences, namely direct alphabetic open-bigram set array, inverse alphabetic open-bigram set array, direct type of alphabetic open-bigram set array, inverse type of alphabetic open-bigram set array, central type of alphabetic open-bigram set array, and inverse central type alphabetic open-bigram set array.

The subject is given a predefined time period to validly perform the serial sensorial discrimination, sensory motor selection, and removal of the repeated open-bigram terms from the provided randomized open-bigrams sequence in the exercises. If, for whatever reason, the subject does not perform the sensory motor removal of a repeated open-bigram term within this predefined time interval, also referred to as “a valid performance time period,” then after a delay, which could be about 12 seconds, the next in-line randomized open-bigrams sequence type trial exercise for the subject to perform is displayed. In a non-limiting embodiment, this predefined time interval for a valid performance within the maximal time period for lack of response is defined to be 10-50 seconds, in particular 20-40 seconds, and further specifically 30 seconds.

The subject is also given another predefined time period to validly perform the serial sensorial discrimination, sensory motor selection, and ordinal reorganization of different open-bigram terms to obtain an incomplete non-randomized alphabetical serial order of different open-bigram terms in the exercises. If, for whatever reason, the subject does not perform the sensory motor reorganization of a different open-bigram term within this additional predefined time interval, also referred to as “a valid performance time period,” then after a delay, which could be about 12 seconds, the next in-line randomized open-bigrams sequence trial exercise for the subject to perform is displayed. In a non-limiting embodiment, the additional predefined time interval or valid performance time period is defined to be 10-50 seconds, in particular 20-40 seconds, and further specifically 30 seconds.

The subject is given yet another predefined time period to validly serially sensorially discriminate, sensory motor select, and insert the missing different open-bigram terms in the exercises. If, for whatever reason, the subject does not perform the correct sensory motor insertion of a missing different open-bigram term within this additional predefined time interval, also referred to as “a valid performance time period,” then after a delay, which could be about 12 seconds, the next in-line randomized open-bigrams sequence trial exercise for the subject to perform is displayed. In a non-limiting embodiment, this additional predefined time interval or valid performance time period is defined to be 10-50 seconds, in particular 20-40 seconds, and further specifically 30 seconds.

In the present Example 2, there is still another predefined time interval between block exercises. Let Δ1 herein represent a time interval between block exercises' performances of the present task, where Δ1 is herein defined to be of 8 seconds. However, other time intervals are also contemplated, including without limitation, 10-30 seconds and the integral times there between.

The methods implemented by the exercises of Example 2 also contemplate those situations in which the subject fails to perform the given example. The following failing to perform criteria is applicable to any trial exercise in any block exercise of the present example in which the subject fails to perform. Specifically, for the present exercises, there are two kinds of “failure to perform” criteria. The first kind of “failure to perform” criteria occurs in the event the subject fails to sensory motor perform any of the three steps (remove, reorganize and insert) by not performing that step within a valid performance time period. In such a case, the subject will automatically be prompted to start a new trial exercise in which the subject must start the complete exercise again from the first step (sensory motor remove), even if the subject had already completed the first step or the first and second steps (sensory motor remove and reorganize). The valid performance time period can be any set period of time as indicated above.

If the subject fails to sensory motor perform in this manner for up to 3 new trial exercises consecutively presented within the first or second block exercise, then the subject ends that particular trial exercise and moves on to the next in-line trial exercise within that block exercise or the subject ends that particular trial exercise and after Δ1 moves on to the next in-line trial exercise in the next in-line block exercise (e.g., from the first block exercise to the second block exercise or from the second block exercise to the third block exercise). If the subject fails to perform for up to 3 new trial exercises within the third block exercise, then the subject is automatically stopped within the exercises of Example 2 and returned to the main menu of Examples implementing the present methods.

The second “failure to perform” criteria is in the event the subject fails to sensory motor perform by selecting a wrong open-bigram term answer at any of the 3 steps (sensory motor removal, reorganization and insertion) in any trial exercise. In the case where the subject in step 1 tries to sensory motor remove a non-repeated open-bigram term within the provided randomized open-bigrams sequence, the incorrect sensory motor removal of the non-repeated open-bigram term is immediately undone and the subject is again prompted to sensory motor remove all of the repeated open-bigram terms. Likewise, if the subject in step 2 attempts to sensory motor reorganize a wrong open-bigram term within the randomized open-bigrams sequence, then at the incorrect sensory motor reorganized open-bigram term is ignored and the randomized open-bigrams sequence is returned to its initial status prior to the subject's incorrect sensory motor reorganization. In other words, the open-bigram term that the subject wrongly attempted to relocate is immediately put back in the serial order position it occupied before the subject attempted to sensory motor move it.

Further, if the subject in step 3 attempts to sensory motor insert a wrong different open-bigram term, the incorrect sensory motor insertion is reversed at once and the incomplete non-randomized serial order of different open-bigram terms is returned to its status prior to the subject's incorrect sensory motor insertion. If the subject sensory motor performs incorrectly for three consecutive attempts at any step of the three steps (sensory motor removal, reorganization and insertion) required herein to perform in any trial exercise in block exercises 1 or 2, then the subject is transitioned on to the next in-line trial exercise in the next in-line block exercise, unless the subject is performing the third block exercise, in which case the subject is automatically stopped within the exercises of Example 2 and returned to the main menu of Examples implementing the present methods.

The total duration to complete the exercises of Example 2, as well as the time it took to implement each one of the individual trial exercises, is recorded in order to help generate an individual or age-gender related performance score. Performance records of all wrong sensory motor performances concerning same open-bigram term removals, different open-bigram term ordinal reorganizations and insertions for all trial exercises in all block exercises are also generated and displayed. In general, the subject will perform this task about 6 times during his/her language based brain neuroperformance-fitness training program.

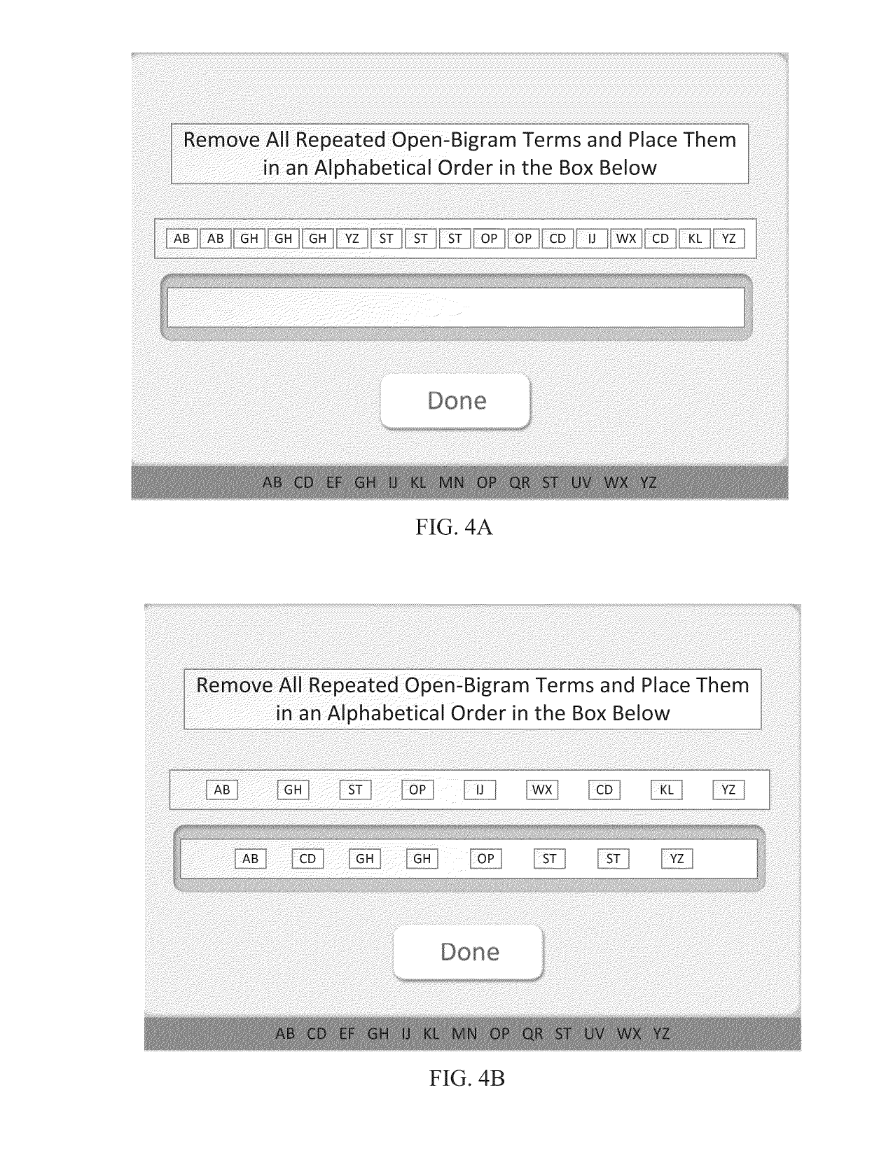

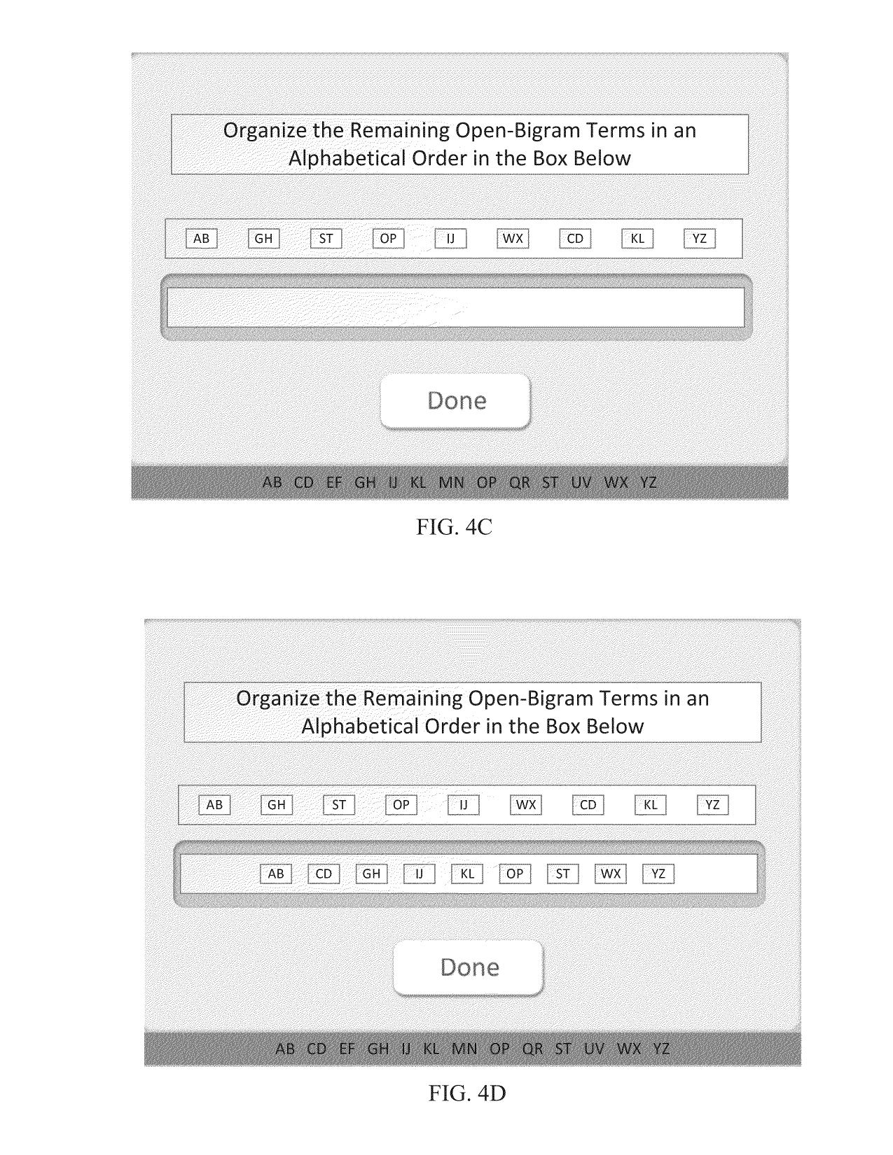

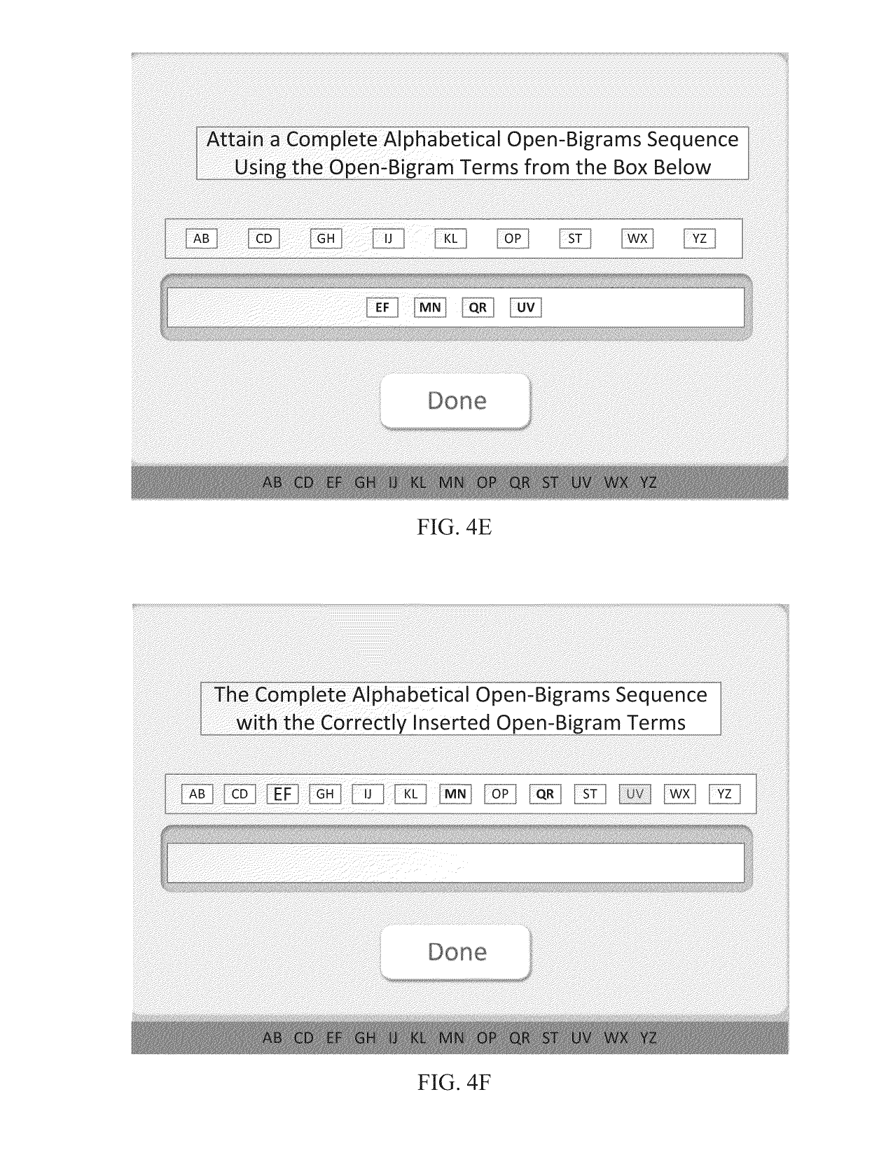

FIGS. 4A-4F depict a non-limiting example of the exercises of Example 2. In particular, FIG. 4A shows a randomized open-bigrams sequence with repeated open-bigram terms, different open-bigram terms out of serial order relative to a complete non-randomized direct alphabetic open-bigram set array, and missing different open-bigram terms. In FIG. 4A, the subject is prompted to perform the first step of the present exercise by sensory motor removing all of the repeated open-bigram terms from the randomized open-bigrams sequence and in a second step sensory motor reorganize the remaining different open-bigram terms in an incomplete non-randomized direct alphabetical serial order of different open-bigram terms in the given box. FIG. 4B shows the results of the subject successfully completing this first step.

FIG. 4C then shows all of the remaining different open-bigram terms in the provided randomized open-bigrams sequence and prompts the subject to sensory motor organize them into an incomplete non-randomized direct alphabetical serial order of different open-bigram terms in the given box. FIG. 4D shows the open-bigram terms in a non-randomized direct alphabetical serial order in the box; thus, the subject successfully attained an incomplete non-randomized alphabetical serial order of different open-bigram terms in the second step. The third step is depicted in FIG. 4E and FIG. 4F. In FIG. 4E, the subject is prompted to complete the incomplete direct alphabetical open-bigrams sequence by correctly sensory motor inserting the missing different open-bigram terms provided in the box. The final result is shown in FIG. 4F, where the correct sensory motor inserted open-bigram terms are shown with changed spatial and time perceptual related attributes, specifically with spatial perceptual related attributes larger open-bigram term font size and font boldness and with time perceptual related attribute open-bigram term font color.

It is understood that the exercise depicted in FIGS. 4A-4F is non-limiting and that other open-bigram sequences, including non-randomized direct alphabetical or inverse alphabetical different open-bigram sequences, may be provided to the subject, as well as numeric and/or alphanumeric open-bigram sequences, including non-randomized direct or inverse numeric and/or alphanumeric different open-bigram sequences.

The disclosed subject matter being thus described, it will be obvious that the same may be modified or varied in many ways. Such modifications and variations are not to be regarded as a departure from the spirit and scope of the disclosed subject matter and all such modifications and variations are intended to be included within the scope of the following claims.

1. A method of strengthening fluid intelligence abilities by prompting a subject to reason to conceptualize a governing serial order formed by letters of set arrays configured according to serial orders of different pairs of letters, known as open-bigrams, each letter pair formed from two different letters of an alphabet, the subject required to sensory motor discriminate the letter pairs and ordinal positions of the letter pairs in the governing serial order of a predefined alphabetic set array during an exercise, the method comprising:
a) selecting a serial order of different open-bigram terms of an alphabetic open-bigram set array, having the same spatial and time perceptual related attributes, from a predefined library of alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject with a randomized open-bigrams sequence obtained from the selected serial order of the alphabetic open-bigram set array, wherein a plurality of alphabetic open-bigram terms are out of serial order relative to the serial order of the selected alphabetic open-bigram set array; and providing the serial order of different open-bigram terms of the alphabetic set array to the subject as a ruler;
c) prompting the subject, within the exercise in a first predefined time interval, to sensorially discriminate and sensory motor reorganize the out of serial order alphabetic open-bigram terms, one at a time, in the randomized open-bigrams sequence to form a completed alphabetical serial order of different open-bigram terms following the same serial order as the selected alphabetic open-bigram set array;
d) if the sensory motor reorganization of an alphabetic open-bigram term is incorrect, then returning the open-bigram term to its previous position in the randomized open-bigrams sequence, and returning to step c);
e) if the sensory motor reorganization of an alphabetic open-bigram term is correct but further sensory motor reorganization of the randomized open-bigrams sequence is needed to form the completed alphabetical serial order of different open-bigram terms, then returning to step c);
f) if the sensory motor reorganization of all of the out of serial order alphabetic open-bigram terms is correct and the completed alphabetical serial order of different open-bigram terms is formed, then displaying the correctly reorganized open-bigram terms with at least one different spatial and/or time perceptual related attribute than the other open-bigram terms in the selected alphabetic set array;
g) repeating the above steps for a predetermined number of iterations separated by one or more predefined time intervals; and
h) upon completion of the predetermined number of iterations, providing the subject with the results of each iteration.

2. The method of claim 1, wherein the predefined library comprises alphabetic open-bigram set arrays, where each member of the set is a different alphabetic open-bigram, including: direct open-bigram set array, inverse open-bigram set array, direct type open-bigram set array, inverse type open-bigram set array, central type open-bigram set array, and inverse central type open-bigram set array, and
wherein the serial order of the letters of two or more consecutive member terms do not form a word.

3. The method of claim 2, wherein the serial order of different open-bigram terms of the alphabetic open-bigram set array is selected from the group consisting of: direct open-bigram set array, direct type open-bigram set array, and central type open-bigram set array, and the plurality of out of serial order alphabetic open-bigram terms has 3-7 open-bigram terms.

4. The method of claim 2, wherein the subject is provided with a given amount of time to perform the sensory motor reorganization of the out of serial order open-bigram terms, and the given amount of time is between 15 and 45 seconds for each out of serial order open-bigram term.

5. The method of claim 2, wherein the serial order of different open-bigram terms of the alphabetic open-bigram set array is selected from the group consisting of: inverse open-bigram set array, inverse type open-bigram set array, and inverse central type open-bigram set array, and the plurality of out of serial order alphabetic open-bigram terms has 3-5 open-bigram terms.

6. The method of claim 5, wherein the subject is provided with a given amount of time to perform the sensory motor reorganization of the out of serial order open-bigram terms, and the given amount of time is between 15 and 45 seconds for each out of serial order open-bigram term.

7. The method of claim 1, wherein the at least one different spatial and/or time perceptual related attribute of step f) is selected from one or more of open-bigram term font size, open-bigram term font style, open-bigram term font spacing, open-bigram term font case, open-bigram term font boldness, open-bigram font rotation angle, and open-bigram font mirroring.

8. The method of claim 1, wherein the at least one different spatial and/or time perceptual related attribute of step f) is selected according to a predefined relationship between spatial and/or time perceptual related attributes and the ordinal positions of the correctly reorganized open-bigram terms.

9. The method of claim 8, wherein the at least one different spatial and/or time perceptual related attribute of an alphabetic open-bigram term having an ordinal position falling in a left field of vision of the subject is different from the at least one different spatial and/or time perceptual related attribute of an alphabetic open-bigram term having an ordinal position falling in a right field of vision of the subject.

10. The method of claim 1, further comprising in step c) randomly blocking any alphabetic open-bigram term in the randomized open-bigrams sequence from the subject's view for a blocking time, as the subject is attempting to sensory motor reorganize the out of serial order open-bigram terms to form the completed alphabetical serial order of different open-bigram terms.

11. The method of claim 10, wherein the blocking occurs for a period of 1-3 seconds, and is done intermittently at a predefined duty cycle.

12. The method of claim 1, wherein the sensory motor reorganizing of the out of serial order open-bigram terms by the subject engages goal oriented motor activity within the subject's body, wherein the goal oriented motor activity is selected from a sensory motor group including: sensorial perception of the complete serial order of different open-bigram terms of the alphabetic open-bigram set array and the randomized open-bigrams sequence; goal oriented body movements to execute the sensorial discrimination and sensory motor reorganization of the out of serial order open-bigram terms; and combinations thereof.

13. The method of claim 12, wherein the goal oriented body movements are selected from the group consisting of goal oriented movements of a subject's eyes, head, neck, arms, hands, fingers and combinations thereof.

14. The method of claim 1, wherein the ruler is selected from the group including: direct alphabetic set array, inverse alphabetic set array, direct type of alphabetic set array, inverse type of alphabetic set array, central type of alphabetic set array, inverse central type alphabetic set array, direct open-bigram set array, inverse open-bigram set array, direct type open-bigram set array, inverse type open-bigram set array, central type open-bigram set array, and inverse central type open-bigram set array.

15. The method of claim 1, wherein the predetermined number of iterations ranges from 1-23 iterations.

16. The method of claim 1, wherein the sensory motor reorganization of the out of serial order open-bigram terms is done by the subject by implementing a predefined selection choice method selected from the group including: multiple-choice selection method, force choice selection method and go-no go selection method.

17. The method of claim 1, wherein the first predefined time interval is any time interval between 10 and 20 seconds and the one or more predefined time intervals of step g) are any time interval between 5 and 15 seconds.

18. A computer program product for strengthening fluid intelligence abilities by prompting a subject to reason to conceptualize a governing serial order formed by letters of set arrays configured according to serial orders of different pairs of letters, known as open-bigrams, each letter pair formed from two different letters of an alphabet, the subject required to sensory motor discriminate the letter pairs and ordinal positions of the letter pairs in the governing serial order of a predefined alphabetic set array during an exercise, the computer program product stored on a non-transitory computer-readable medium which when executed causes a computer system to perform a method, comprising:
a) selecting a serial order of different open-bigram terms of an alphabetic open-bigram set array, having the same spatial and time perceptual related attributes, from a predefined library of alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject with a randomized open-bigrams sequence obtained from the selected serial order of the alphabetic open-bigram set array, wherein a plurality of alphabetic open-bigram terms are out of serial order relative to the serial order of the selected alphabetic open-bigram set array; and providing the serial order of different open-bigram terms of the alphabetic set array to the subject as a ruler;
c) prompting the subject, within the exercise in a first predefined time interval, to sensorially discriminate and sensory motor reorganize the out of serial order alphabetic open-bigram terms, one at a time, in the randomized open-bigrams sequence to form a completed alphabetical serial order of different open-bigram terms following the same serial order as the selected alphabetic open-bigram set array;
d) if the sensory motor reorganization of an alphabetic open-bigram term is incorrect, then returning the open-bigram term to its previous position in the randomized open-bigrams sequence, and returning to step c);
e) if the sensory motor reorganization of an alphabetic open-bigram term is correct but further sensory motor reorganization of the randomized open-bigrams sequence terms is needed to form the completed alphabetical serial order of different open-bigram terms, then returning to step c);
f) if the sensory motor reorganization of all of the out of serial order alphabetic open-bigram terms is correct and the completed alphabetical serial order of different open-bigram terms is formed, then displaying the correctly reorganized open-bigram terms with at least one different spatial and/or time perceptual related attribute than the other open-bigram terms in the selected alphabetic set array;
g) repeating the above steps for a predetermined number of iterations separated by one or more predefined time intervals; and
h) upon completion of the predetermined number of iterations, providing the subject with the results of each iteration.

19. A system for strengthening fluid intelligence abilities by prompting a subject to reason to conceptualize a governing serial order formed by the letters of set arrays configured according to serial orders of different pairs of letters, known as open-bigrams, each letter pair formed from two different letters of an alphabet, the subject required to sensory motor discriminate the letter pairs and ordinal positions of the letter pairs in the governing serial order of a predefined alphabetic set array during an exercise, the system comprising:
a computer system comprising a processor, memory, and a graphical user interface (GUI), the processor containing instructions for:
a) selecting a serial order of different open-bigram terms of an alphabetic open-bigram set array, having the same spatial and time perceptual related attributes, from a predefined library of alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject on the GUI with a randomized open-bigrams sequence obtained from the selected serial order of the alphabetic open-bigram set array, wherein a plurality of alphabetic open-bigram terms are out of serial order relative to the serial order of the selected alphabetic open-bigram set array; and providing the serial order of different open-bigram terms of the alphabetic set array to the subject as a ruler on the GUI;
c) prompting the subject on the GUI, within the exercise in a first predefined time interval, to sensorially discriminate and sensory motor reorganize the out of serial order open-bigram terms, one at a time, in the randomized open-bigrams sequence to form a completed alphabetical serial order of different open-bigram terms following the same serial order as the selected alphabetic open-bigram set array;
d) if the sensory motor reorganization of an alphabetic open-bigram term is incorrect, then returning the open-bigram term to its previous position in the randomized open-bigrams sequence, and returning to step c);
e) if the sensory motor reorganization of an alphabetic open-bigram term is correct but further sensory motor reorganization of the randomized open-bigrams sequence is needed to form the completed alphabetical serial order of different open-bigram terms, then returning to step c);
f) if the sensory motor reorganization of all of the out of serial order alphabetic open-bigram terms is correct and the completed alphabetical serial order of different open-bigram terms is formed, then displaying the correctly reorganized open-bigram terms on the GUI with at least one different spatial and/or time perceptual related attribute than the other open-bigram terms in the selected alphabetic set array;
g) repeating the above steps for a predetermined number of iterations separated by one or more predefined time intervals; and
h) upon completion of the predetermined number of iterations, providing the subject with the results of each iteration on the GUI.

20. A method of strengthening fluid intelligence abilities by prompting a subject to reason to conceptualize a governing serial order formed by the letters of set arrays configured according to serial orders of different pairs of letters, known as open-bigrams, each letter pair formed from two different letters of an alphabet, the subject required to sensory motor discriminate the letter pairs and ordinal positions of the letter pairs in the governing serial order of a predefined alphabetic set array during an exercise, the method comprising:
a) selecting a serial order of an alphabetic set array of different open-bigram terms with the same spatial and time perceptual related attributes from a predefined library of alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject with a randomized open-bigram terms sequence obtained from the selected serial order of different open-bigram terms, the randomized open-bigram terms sequence having a plurality of repeated open-bigram terms, a plurality of out of serial order open-bigram terms relative to the serial order of the alphabetic set array, and a plurality of missing open-bigram terms; and providing the selected serial order of the alphabetic set array to the subject as a ruler;
c) prompting the subject to sensorially discriminate and sensory motor remove, within a first predefined time interval, the plurality of repeated open-bigram terms from the randomized open-bigram terms sequence;
d) if the sensory motor removal of an open-bigram term is incorrect, then returning the open-bigram term to its previous position in the randomized open-bigram terms sequence and returning to step c);
e) if the sensory motor removal of an open-bigram term is correct but at least one repeated open-bigram term remains in the randomized open-bigram terms sequence, then returning to step c);
f) prompting the subject to sensorially discriminate and sensory motor reorganize, within a second predefined time interval, the out of serial order open-bigram terms, one at a time, in the randomized open-bigram terms sequence to form an incomplete alphabetical serial order of open-bigram terms;
g) if the sensory motor reorganization of an open-bigram term is incorrect, then returning the open-bigram term to its previous position in the randomized open-bigram terms sequence and returning to step f);
h) if the sensory motor reorganization of an open-bigram term is correct but further sensory motor reorganization of the randomized open-bigram terms sequence is needed, then returning to step;
j) prompting the subject to sensorially discriminate and sensory motor insert, within a third predefined time interval, the plurality of missing open-bigram terms, one at a time, in the incomplete alphabetical serial order of open-bigram terms, to form a completed alphabetical serial order of different open-bigram terms following the same serial order as the selected alphabetic set array of different open-bigram terms;
j) if the sensory motor insertion of an open-bigram term is incorrect, then removing the open-bigram term from the incomplete alphabetical serial order of open-bigram terms, and returning to step i);
k) if the sensory motor insertion of an open-bigram term is correct but at least one missing open-bigram term has not been inserted in the incomplete alphabetical serial order of open-bigram terms, then returning to step i);
l) if the sensory motor insertion of all of the missing open-bigram terms is correct and the completed alphabetical serial order of different open-bigram terms is formed, then displaying the correctly inserted open-bigram terms with at least one different spatial and/or time perceptual related attribute than the other open-bigram terms in the completed alphabetical serial order of different open-bigram terms;
m) repeating the above steps for a predetermined number of iterations separated by one or more predefined time intervals; and
n) upon completion of the predetermined number of iterations, providing the subject with the results of each iteration.

21. The method of claim 20, wherein the predefined library comprises alphabetic open-bigram set arrays of different member terms including: direct open-bigram set array, inverse open-bigram set array, direct type of open-bigram set array, inverse type of open-bigram set array, central type of open-bigram set array, and inverse central type open-bigram set array, and
wherein the serial order of the letters of two or more consecutive member terms do not form a word.

22. The method of claim 21, wherein the serial order of the alphabetic set array of different open-bigram terms is selected from the group consisting of direct open-bigram set array, direct type of open-bigram set array, and central type of open-bigram set array, and the plurality of repeated open-bigram terms has 2-5 open-bigram terms.

23. The method of claim 22, wherein the repeated open-bigram terms are each repeated 2-4 times.

24. The method of claim 22, wherein the plurality of out of serial order open-bigram terms comprises 3-5 different open-bigram terms.

25. The method of claim 24, wherein the second predefined time interval to perform the sensory motor reorganization of the plurality of out of serial order open-bigram terms is between 15 and 45 seconds for each out of serial order open-bigram term.

26. The method of claim 20, wherein the plurality of missing open-bigram terms of step i) to be sensory motor inserted are obtained from the ruler.

27. The method of claim 22, wherein the plurality of missing open-bigram terms comprises 2-7 different open-bigram terms.

28. The method of claim 27, wherein the plurality of missing open-bigram terms is between 3 and 5 different open-bigram terms.

29. The method of claim 21, wherein the serial order of the alphabetic set array of different open-bigram terms is selected from the group including inverse open-bigram set array, inverse type of open-bigram set array, and inverse central type of open-bigram set array, and the plurality of repeated open-bigram terms has 2-4 open-bigram terms.

30. The method of claim 29, wherein the repeated open-bigram terms are each repeated 1-3 times.

31. The method of claim 29, wherein the plurality of out of serial order open-bigram terms comprises 3-5 different open-bigram terms.

32. The method of claim 20, wherein the first predefined time interval is between 15 and 45 seconds, and the third predefined time interval is between 15 and 45 seconds.

33. The method of claim 29, wherein the plurality of missing open-bigram terms comprises 2-5 different open-bigram terms.

34. The method of claim 33, wherein the plurality of missing open-bigram terms has 3 or 4 different open-bigram terms.

35. The method of claim 20, wherein the at least one different spatial and/or time perceptual related attribute of step l) is selected from one or more of open-bigram term font size, open-bigram term font style, open-bigram term font spacing, open-bigram term font case, open-bigram term font boldness, open-bigram font rotation angle, and open-bigram font mirroring.

36. The method of claim 20, wherein the at least one different spatial and/or time perceptual related attribute of step l) is selected according to a predefined relationship between spatial and/or time perceptual related attributes and the ordinal positions of the different open-bigram terms in the alphabetic set array.

37. The method of claim 36, wherein the at least one different spatial and/or time perceptual related attribute of a correctly inserted open-bigram term having an ordinal position falling in a left field of vision of the subject is different from the at least one different spatial and/or time perceptual related attribute of a correctly inserted open-bigram term having an ordinal position falling in a right field of vision of the subject.

38. The method of claim 20, further comprising in step f) randomly blocking any alphabetic open-bigram term in the randomized open-bigram terms sequence from the subject's view for a blocking time, as the subject is attempting to sensory motor reorganize the out of serial order open-bigram terms to form an incomplete alphabetical serial order of different open-bigram terms.

39. The method of claim 38, wherein the blocking time occurs for a period of 1-3 seconds, and the random blocking is done intermittently at a predefined duty cycle.

40. The method of claim 20, wherein the sensory motor removal, sensory motor reorganization, and the sensory motor insertion of alphabetic open-bigram terms by the subject each engage goal oriented motor activity within the subject's body, wherein the goal oriented motor activity is selected from a sensory motor group including: sensorial perception of the serial order of the alphabetic set array of different open-bigram terms and the randomized open-bigram terms sequence; sensorial perception of an obtained incomplete alphabetical serial order of different open-bigram terms; goal oriented body movements to execute the sensory motor removal, reorganization, and insertion of alphabetic open-bigram terms; and combinations thereof.

41. The method of claim 40, wherein the goal oriented body movements are selected from the group consisting of goal oriented movements of the subject's eyes, head, neck, arms, hands, fingers and combinations thereof.

42. The method of claim 20, wherein the ruler in step b) is selected from the group including: direct open-bigram set array, inverse open-bigram set array, direct type of open-bigram set array, inverse type of open-bigram set array, central type of open-bigram set array, and inverse central type open-bigram set array.

43. The method of claim 20, wherein the predetermined number of iterations ranges from 1-23 iterations.

44. The method of claim 20, wherein the sensory motor removal, reorganization, and insertion of alphabetic open-bigram terms is done by the subject by implementing a predefined selection choice method selected from the group including multiple-choice selection method, force choice selection method and go-no go selection method.

45. The method of claim 20, wherein the third predefined time interval is any time interval between 10 and 50 seconds and the one or more predefined time intervals of step m) are any time interval between 10 and 30 seconds.

46. A computer program product for strengthening fluid intelligence abilities by prompting a subject to reason to conceptualize a governing serial order formed by the letters of set arrays configured according to serial orders of different pairs of letters, known as open-bigrams, each letter pair formed from two different letters of an alphabet, the subject required to sensory motor discriminate the letter pairs and ordinal positions of the letter pairs in the governing serial order of a predefined alphabetic set array during an exercise, the computer program product stored on a non-transitory computer-readable medium which when executed causes a computer system to perform a method, comprising:
a) selecting a serial order of an alphabetic set array of different open-bigram terms with the same spatial and time perceptual related attributes from a predefined library of alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject with a randomized open-bigram terms sequence obtained from the selected serial order of different open-bigram terms, the randomized open-bigram terms sequence having a plurality of repeated open-bigram terms, a plurality of out of serial order open-bigram terms relative to the serial order of the alphabetic set array, and a plurality of missing open-bigram terms; and providing the selected serial order of the alphabetic set array to the subject as a ruler;
c) prompting the subject to sensorially discriminate and sensory motor remove, within a first predefined time interval, the plurality of repeated open-bigram terms from the randomized open-bigram terms sequence;
d) if the sensory motor removal of an open-bigram term is incorrect, then returning the open-bigram term to its previous position in the randomized open-bigram terms sequence and returning to step c);
e) if the sensory motor removal of an open-bigram term is correct but at least one repeated open-bigram term remains in the randomized open-bigram terms sequence, then returning to step c);
f) prompting the subject to sensorially discriminate and sensory motor reorganize, within a second predefined time interval, the out of serial order open-bigram terms, one at a time, in the randomized open-bigram terms sequence to form an incomplete alphabetical serial order of open-bigram terms;
g) if the sensory motor reorganization of an open-bigram term is incorrect, then returning the open-bigram term to its previous position in the randomized open-bigram terms sequence and returning to step f);
h) if the sensory motor reorganization of an open-bigram term is correct but further sensory motor reorganization of the randomized open-bigram terms sequence is needed, then returning to step f);
i) prompting the subject to sensorially discriminate and sensory motor insert, within a third predefined time interval, the plurality of missing open-bigram terms, one at a time, in the incomplete alphabetical serial order of open-bigram terms, to form a completed alphabetical serial order of different open-bigram terms following the same serial order as the selected alphabetic set array of different open-bigram terms;
j) if the sensory motor insertion of an open-bigram term is incorrect, then removing the open-bigram term from the incomplete alphabetical serial order of open-bigram terms and returning to step i);
k) if the sensory motor insertion of an open-bigram term is correct but at least one missing open-bigram term has not been inserted in the incomplete alphabetical serial order of open-bigram terms, then returning to step i);
l) if the sensory motor insertion of all of the missing open-bigram terms is correct and the completed alphabetical serial order of different open-bigram terms is formed, then displaying the correctly inserted open-bigram terms with at least one different spatial and/or time perceptual related attribute than the other open-bigram terms in the completed alphabetical serial order of different open-bigram terms;
m) repeating the above steps for a predetermined number of iterations separated by one or more predefined time intervals; and
n) upon completion of the predetermined number of iterations, providing the subject with the results of each iteration.

47. A system for strengthening fluid intelligence abilities by prompting a subject to reason to conceptualize a governing serial order formed by the letters of set arrays configured according to serial orders of different pairs of letters, known as open-bigrams, each letter pair formed from two different letters of an alphabet, the subject required to sensory motor discriminate the letter pairs and ordinal positions of the letter pairs in the governing serial order of a predefined alphabetic set array during an exercise, the system comprising:
a computer system comprising a processor, memory, and a graphical user interface (GUI), the processor containing instructions for:
a) selecting a serial order of an alphabetic set array of different open-bigram terms with the same spatial and time perceptual related attributes from a predefined library of complete alphabetic open-bigram set arrays, wherein the serial order of letters of two or more consecutive terms in a direct or inverse serial order do not form a word, and wherein the exercise does not require the subject to retrieve semantic knowledge from long term memory;
b) providing the subject on the GUI with a randomized open-bigram terms sequence obtained from the selected serial order of different open-bigram terms, the randomized open-bigram terms sequence having a plurality of repeated open-bigram terms, a plurality of out of serial order open-bigram terms relative to the serial order of the alphabetic set array, and a plurality of missing open-bigram terms; and providing the selected serial order of the alphabetic set array to the subject as a ruler on the GUI;
c) prompting the subject on the GUI to serially sensorially discriminate and sensory motor remove, within a first predefined time interval, the plurality of repeated open-bigram terms from the randomized open-bigram terms sequence;
d) if the sensory motor removal of an open-bigram term is incorrect, then returning the open-bigram term to its previous position in the randomized open-bigram terms sequence and returning to step c);
e) if the sensory motor removal of an open-bigram term is correct but at least one repeated open-bigram term remains in the randomized open-bigram terms sequence, then returning to step c);
f) prompting the subject on the GUI to sensorially discriminate and sensory motor reorganize, within a second predefined time interval, the out of serial order open-bigram terms, one at a time, in the randomized open-bigram terms sequence to form an incomplete alphabetical serial order of open-bigram terms;
g) if the sensory motor reorganization of an open-bigram term is incorrect, then returning the open-bigram term to its previous position in the randomized open-bigram terms sequence and returning to step f);
h) if the sensory motor reorganization of an open-bigram term is correct but further sensory motor reorganization of the randomized open-bigram terms sequence is needed, then returning to step f);
i) prompting the subject on the GUI to sensorially discriminate and sensory motor insert, within a third predefined time interval, the plurality of missing open-bigram terms, one at a time, in the incomplete alphabetical serial order of open-bigram terms, to form a completed alphabetical serial order of different open-bigram terms following the same serial order as the selected alphabetic set array of different open-bigram terms;
j) if the sensory motor insertion of an open-bigram term is incorrect, then removing the open-bigram term from the incomplete alphabetical serial order of open-bigrams terms and returning to step i);
k) if the sensory motor insertion of an open-bigram term is correct but at least one missing open-bigram term has not been inserted in the incomplete alphabetical serial order of open-bigram terms, then returning to step i);
l) if the sensory motor insertion of all of the missing open-bigram terms is correct and the completed alphabetical serial order of different open-bigram terms is formed, then displaying the correctly inserted open-bigram terms on the GUI with at least one different spatial and/or time perceptual related attribute than the other open-bigram terms in the completed alphabetical serial order of different open-bigram terms;
m) repeating the above steps for a predetermined number of iterations separated by one or more predefined time intervals; and
n) upon completion of the predetermined number of iterations, providing the subject with the results of each iteration on the GUI.
